(19) United States
(12) Patent Application Publication
(10) Pub. No.: US 2006/0281695 A1
(43) Pub. Date: Dec. 14, 2006

(54) Control of parasites in animals by N-[(phenyloxy)phenyl]-1,1,1-trifluoromethanesulfonamide and N-[(phenylsulfanyl)phenyl]-1,1,1-trifluoromethanesulfonamide derivatives

(75) Inventors: Adam Gerhard Meyer, Richmond (AU); Kevin Norman Winzenberg, Camberwell (AU); David G. Sawutz, Maplewood, NJ (US); Andrew Geoffrey Riches, Richmond (AU)

Correspondence Address: SCHERING-PLOUGH CORPORATION;PATENT DEPARTMENT (K-6-1, 1990), 2000 GALLOPING HILL ROAD, KENILWORTH, NJ, 07033-0530, US

(73) Assignee: Schering-Plough Animal Health Corporation

(21) Appl. No.: 11/448,421

(22) Filed: Jun. 7, 2006

Related U.S. Application Data
(60) Provisional application No. 60/688,898, filed on Jun. 9, 2005.

(51) Int. Cl. A01N 37/36; A01N 43/52; A01N 43/04; A01N 41/06; A01N 37/34; A01N 43/54

(52) U.S. Cl. 514/28; 514/522; 514/602; 514/394; 514/166; 514/256

(57) ABSTRACT

Methods for treating an animal for endo and/or ecto parasite infestation and/or for protecting an animal from endo and/or ecto parasite infestation using N-phenyl-1,1,1-trifluoromethanesulfonamide compounds are provided, together with methods of making the same compounds, and methods of using the same compounds to treat parasite infestations in vivo or ex vivo. N-phenyl-1,1,1-trifluoromethanesulfonamides are also provided.

### REFERENCE TO PRIORITY APPLICATIONS

This Application claims the benefit of U.S. Provisional Application Ser. No. 60/688,898 filed Jun. 9, 2005, which is incorporated herein in its entirety by reference.

### BACKGROUND OF THE INVENTION

1. Field of the Invention

The present invention relates to method of killing, suppressing or treating ecto- and endoparasite infections or infestations using N-[(phenyloxy)phenyl]-1,1,1-trifluoromethanesulfonamide, N-[(phenylsulfanyl)phenyl)]-1,1,1-trifluoromethansulfonamide, N-[(phenylsulfinyl)phenyl]-1,1,1-trifluoromethansulfonamide, N-[(phenylsulfonyl)phenyl]-1,1,1-trifluoromethansulfonamide and N-[(phenylamino)phenyl)]-1,1,1-trifluoromethansulfonamide compounds as parasiticides. The present invention also relates to compositions containing the above-listed compounds, and methods of treatment using the compounds, especially to control animal parasites, e.g., ecto- and endoparasites such as fleas, acaridae, helminths, and nematodes. The invention also relates to new N-[(phenyloxy)phenyl]-1,1,1-trifluoromethanesulfonamide, N-[(phenylsulfanyl)phenyl)]-1,1,1-trifluoromethansulfonamide, N-[(phenylsulfinyl)phenyl]-1,1,1-trifluoromethansulfonamide, N-[(phenylsulfonyl)phenyl]-1,1,1-trifluoromethansulfonamide and N-[(phenylamino)phenyl)]-1,1,1-trifluoromethansulfonamide compounds. The invention also relates to the use of a combination of a parasiticide of this invention and one or more additional parasiticides or other agents useful in killing parasites.

2. Background

The control of animal parasites is essential, especially in the areas of production and companion animals. Existing methods of treatment are being compromised due to growing resistance to current commercial parasiticides, such as the benzimidazoles and ivermectins. The discovery of more effective ways to control animal parasites is therefore imperative.

In DE 2,118,190 are disclosed compounds of Formula A: 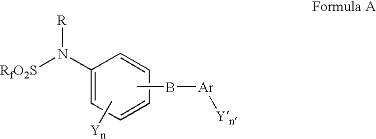
wherein:

Rf is a lower fluoroalkyl radical with at least 2 fluorine atoms attached to the alpha carbon atom;

R is hydrogen, cyano, alkyl, alkylsulfonyl, a horticulturally acceptable cation or —(C═O)—A—R′, where R′ is alkyl and A is oxygen or a carbon-carbon bond;

B is oxygen, sulphur, sulfinyl or sulfonyl;

Ar is phenyl or naphthyl;

Y and Y′ are independently halogen, alkyl, alkoxy, nitro, amino, alkanamido, haloalkyl, hydroxy, dialkylamino, alkoxycarbamoyl, alkylthio, alkylsulfonyl, alkanoyl, dialkylsulfamoyl or alkylsulfinyl;

n and n′ are independently zero, one or two provided that the individual aliphatic groups appearing in the compounds of the Formula (i.e. in R_{f}, R, R′, Y and Y′) contain from one to four carbon atoms each.

The compounds in DE 2,118,190 are claimed as plant growth regulators.

In U.S. Pat. No. 3,755,605 is disclosed a method for combating inflammatory processes in a mammalian animal which comprises administering to the animal a dose effective for he control of the inflammatory processes but less than the toxic amount of the compound of the Formula B: 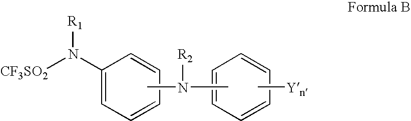
wherein R₁ is hydrogen or triethyl ammonium, R₂ is hydrogen or lower alkyl, Y′ is lower alkyl or halogen and n′ is 0 or 1.

In U.S. Pat. No. 3,906,024 are disclosed compounds of Formula C: 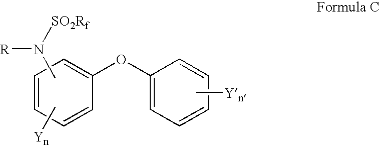
These compounds are claimed as herbicides and some are anti-inflammatory agents. In these disclosed compounds of Formula C, R_{f} is a perfluoroalkyl radical, R is hydrogen, alkyl, or a horticulturally acceptable cation, Y and Y′ are independently halogen, alkyl, alkoxy, nitro, amino, alkanamido, hydroxy, dialkylamino, alkoxycarbamoyl, cyano, alkylthio, alkylsulfonyl, alkanoyl, carboxyl, carbalkoxy, aminoalkyl, carboxamido, dialkylsulfamoyl or alkylsulfinyl provided that when Y is in the 4 or 5 position with respect to the —NRSO₂R_{f} group and the group: 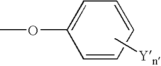
is in the 2 position with respect to the —NRSO₂R_{f} group, Y is not nitro, amino, alkanamido, dialkylamino or alkoxycarbamoyl, and n and n′ are independently 0-2 (i.e. zero, one or two) provided that the individual aliphatic groups appearing in R_{f}, R, R′, Y and Y′ contain from one to four carbon atoms each.

U.S. Pat. No. 4,164,412 discloses a method for controlling, destroying or otherwise modifying the growth of higher plants which comprises contacting the plants with an effective amount of a compound of Formula D: 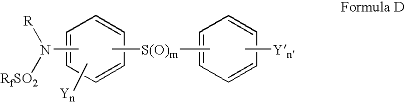
wherein:

R_{f} is a lower perfluoroalkyl radical having one or two carbon atoms, R is hydrogen, cyano, alkyl, alkylsulfonyl, a horticulturally acceptable cation or —(C═O)—A—R′, where R′ is alkyl and A is oxygen or a carbon-carbon bond, m is 0-2, Y is halogen, alkyl, alkoxy, cyano, nitro, amino, alkanamido, hydroxyl, dialkylamino, alkoxycarbamoyl, alkylthio, alkylsulfonyl, alkanoyl, dialkylsulfamoyl, or alkylsulfinyl, Y′ is fluorine, alkyl, alkoxy, cyano, nitro, amino, alkanamido, hydroxyl, dialkylamino, alkoxycarbamoyl, alkylthio, alkylsulfonyl, alkanoyl, dialkylsulfamoyl or alkylsulfinyl and n and n′ are independently 0-2 provided that the individual aliphatic groups appearing in R, R′, Y, Y′ moieties contain from one to four carbon atoms each.”

U.S. Pat. No. 5,034,417 claims alkanesulfonanilide derivatives of the Formula E: 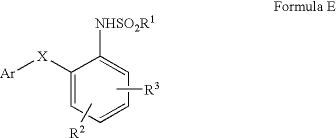
wherein

Ar is a group of the Formula F: 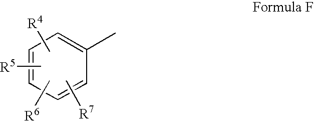
wherein R⁴ and R⁵ are each halogen, and R⁶ and R⁷ are each hydrogen, X is —S— or —NH—,
R¹ is lower alkyl, R² is lower alkanoyl and
R³ is hydrogen, or pharmaceutically acceptable salts thereof.
The compounds claimed in U.S. Pat. No. 5,034,417 are claimed to have antiinflammatory activities and analgesic activities.

U.S. Pat. No. 5,776,984 claims a compound having the Formula G 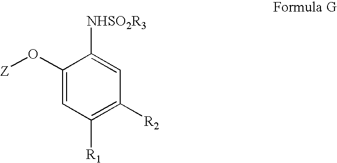
wherein

Z is selected from the group consisting of:
(a) naphthyl; and
(b) substituted naphthyl wherein the hydrogen atom attached to one to four of the carbon atoms is replaced with a substituent independently selected from R₄ wherein R₄ is —F, —CN, —Cl or —CF₃;
R₁ is selected from the group consisting of —NO₂, —CN, —Cl, and —CF₃;
R₂ is —H or R₁ and R₂ taken together with the atoms to which they are attached define a 5-, 6- or 7-membered saturated carbocyclic or saturated heterocyclic ring having a single heteroatom which is oxygen, nitrogen or sulfur wherein the carbocyclic or heterocyclic ring is unsubstituted or substituted with one or two substituents selected from the group consisting of oxo, alkyl and hydroxy; and
R₃ is selected from the group consisting of lower alkyl and CHₙF₍₃₋ₙ₎ wherein n is 0, 1, 2 or 3. The compounds of U.S. Pat. No. 5,776,984 inhibit prostaglandin synthesis.

WO 0,156,990 discloses a compound of Formula H: 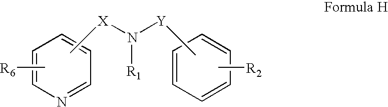
wherein
R₁ is selected from the group consisting of —C(O)R₃, —C(O)OR₄, and —SO₂R₅

wherein R₃ is selected from the group consisting of alkyl and cycloalkyl, R₄ is selected from the group consisting of alkyl and cycloalkyl, R₅ is selected from the group consisting of alkyl, cycloalkyl, and fluorinated alkyl;
R₂ is from 1 to 3 substituents independently selected from the group consisting of hydrogen, hydroxy, trisubstituted silyloxy, alkyl, substituted alkyl, alkenyl, substituted alkenyl, alkoxy, substituted alkoxy, cycloalkoxy, substituted cycloalkoxy, cycloalkyl, substituted cycloalkyl, halogen, cyano, nitro, phenyl, substituted phenyl, pyridyloxy, thiophenoxy, substituted thiophenoxy, phenylsulfinyl, substituted phenylsulfinyl, phenyl sulfonyl, substituted phenylsulfonyl, benzoyl, substituted benzoyl, phenoxy, and substituted phenoxy;
R₆ is from 1 to 2 substituents independently selected from the group consisting of hydrogen, alkyl, alkoxy, trifluoromethyl, halogen, phenoxy, and substituted phenoxy;
X is selected from the group consisting of a bond, —CH₂—, —CHR₇—, and —CH₂CH₂— wherein R₇ is lower alkyl;
Y is selected from the group consisting of a bond, —CH₂—, —CHR₈—, —CH₂CH₂—, —CHR₉CH₂—, and —CH₂CHR₉ wherein R₈ is lower alkyl and R₉ is lower alkyl;
and the pharmaceutical acceptable salts thereof and the pyriyl N-oxides thereof.
The compounds of WO 0,156,990 are potentiators of metabotropic glutamate receptor function.

U.S. Pat. No. 4,664,673 discloses a composition for dyeing and for providing keratinous material with a protecting finish against attack by insects that feed on keratin, which comprises at least one phenoxytrifluoromethanesulfonanilide, or salt thereof, having the Formula I: 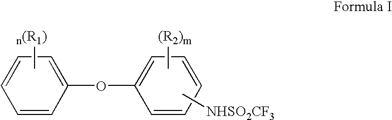
wherein:

R₁ and R₂, each independently of the other, are halogen, haloalkyl, alkyl, nitro, alkoxy or haloalkoxy,

n is 0 or a value from 1 to 4 and

m is 0 or a value from 1 to 3, with the proviso that if n or m>1, the substituents R₁ and R₂ may be identical or different, and that at least one substituent selected from the group consisting of halogen, haloalkyl and haloalkoxy is present in the molecule, and the sum of m+n is at least 2 if R₁ or R₂ is trifluoromethyl or halogen, or the sum of m+n is at least 4 if R₁ and R₂ are exclusively halogen atoms, or is at least 3 if 2 substituents R₁ and R₂ are halogen and NO₂, in a concentration sufficient to impregnate thekeratinous material with an amount of the phenoxytrifluoromethane sulfonanilide effective to provide protection against the insects. U.S. Pat. No. 4,664,673 also describes a composition containing phenoxytrifluoromethanesulfonanilide compounds of Formula J: 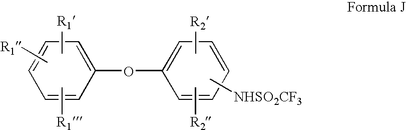
wherein

R₁′ is trifluoromethyl or chlorine

R₁″ is hydrogen, chlorine, nitro or C₁-C₄alkyl,

R₁′″ is hydrogen or chlorine

R₂′ is hydrogen, C₁-C₄alkyl or chlorine and

R₂″ is hydrogen, C₁-C₄alkyl or chlorine provided that if R₁′ is trifluoromethyl or any one of the R₁ or R₂ groups are chlorine, then no more than 3 of the R₁ and R₂ may be hydrogen, and if R₁ and R₂ groups are all selected from hydrogen, chlorine or trifluoromethyl, than no more than one such group may be hydrogen, and if 2 of the R₁ and R₂ groups are halogen, hydrogen, or nitro groups, then no more than 2 R₁ and R₂ groups can be hydrogen.

In the general area of insecticidal and acaricidal control, Japanese Laid-open Patent 57-156407A discloses trifluoromethanesulfonanilide compounds of Formula K: 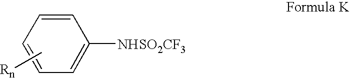
wherein:

R is selected from alkyl, alkoxyalkyl, haloalkyl, haloalkoxy, alkylcarbonyl, alkoxycarbonyl or halo; and

n is 1 to 5.

A pesticidal composition which comprises the ester 2-methoxycarbonyl-4-chlorotrifluoromethanesulfonanilide (Formula L) as an active ingredient is disclosed in U.S. Pat. No. 6,177,465 and U.S. Pat. No. 6,333,022. Examples of the pests controlled by the composition include insects and Acarina such as indoor mites, fleas, cockroaches and so on. The composition is said to be very effective for controlling house dust mites.

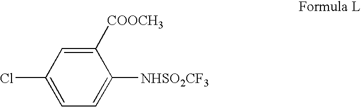

In spite of the forgoing, there remains an ongoing need in the art to provide improved methods of controlling insects and Acarina as well as compounds useful for the same and related purposes.

The citation of any reference herein should not be construed as an admission that such reference is available as “prior art” to the instant application.

### SUMMARY OF THE INVENTION

Accordingly, the present invention provides methods of treating, inhibiting and/or killing ecto and endoparasites using one or more of the N-phenyl-1,1,1-trifluoromethanesulfonamide compounds identified herein that are effective antiparasite agents.

In a first embodiment, the invention provides for a method of treating or protecting an animal or plant from a parasite infestation, the method comprising administering to the animal or plant an effective amount of an N-phenyl- 1,1,1-trifluoromethanesulfonamide compound selected from the group consisting of 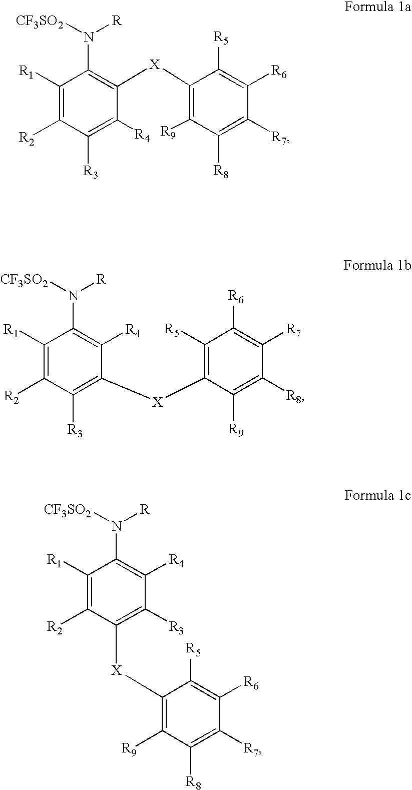
and combinations thereof, or a pharmaceutically acceptable salt thereof or solvate thereof, wherein,

R is selected from the group consisting of hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; and wherein,

R₁-R₉ are independently selected from hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy; and wherein

X is oxygen, sulfur, sulfinyl, sulfonyl or NR₁₀, wherein R₁₀ is H or alkyl.

The parasite to be prevented, killed or suppressed is, for example, an arthropod, a helminth, a cestode, a trematode and/or a protozoan.

Optionally, R₅ and R₆ together are part of the same fused carbocyclic, heterocyclic, aryl or heteroaryl ring, substituted or unsubstituted. In another option, R₆ and R₇ together are part of the same fused carbocyclic, heterocyclic, aryl or heteroaryl ring, substituted or unsubstituted.

In particular, R is selected from the group consisting of H, and one of the following optionally substituted groups, alkyl, alkenyl, alkynyl, alkoxyalkyl, alkycarbonyloxyalkyl, and wherein,

R₁-R₉ are independently selected from: hydrogen, cyano, halo and the following optionally substituted moieties: alkyl, aryl, alkoxy, haloalkyl, haloalkoxy; and wherein

X is oxygen, sulfur; or a pharmaceutically acceptable salt thereof or solvate thereof.

More particularly, a method of the present invention comprises administering to the animal or plant an effective amount of an N-phenyl-1,1,1-trifluoromethanesulfonamide compound of Formula la wherein:

R is H, or one of the following optionally substituted groups: alkyl, alkenyl, alkynyl, alkoxyalkyl, or alkylcarbonyloxyalkyl;

R₁, R₄, R₈ and R₉ are H;

R₂ is H, Cl or CF₃;

R₃ is H or Cl;

R₅ is H, F, Cl, Me, Et, iso-propyl or tert-butyl;

R₆ is H, F, Cl, CF₃, Me, MeO or CN;

R₇ is H, F, Cl, Me, tert-butyl, MeO, phenoxy or CN;

X is O or S.

Preferably, the N-phenyl-1,1,1-trifluoromethanesulfonamide compound of Formulas 1a, 1b, and/or 1c, is a compound listed as number 1 to 92, m1 to m6, or p1 to p9, as identified by Tables 1a-d, and/or combinations thereof.

In an alternative embodiment, the inventive method includes administering at least one additional agent to the plant or animal, either before, in conjunction with, and/or subsequent to the administering of the compound of the present invention.

For example, an additional agent can be a parasiticide selected from the group consisting of a cyclodiene, a member of the group of ryanoid insecticides, e.g, ryania or ryanodol (see U.S. Pat. No. 2,400,295, incorporated by reference herein), KT-199 (see Nanje Gowda D, et al., Hindustan Antibiot Bull. 1984; 26(1-2):14-7), an avermectin, a benzimidazole, a salicylanilide, a substituted phenol, a pyrimidine, an imidazothiazole, a praziquantel (e.g., see U.S. Pat. No. 4,001,411, hereby incorporated by reference), an organic phosphate and combinations thereof. The additional agent can also be an antibiotic, a plant and/or animal nutritional factor and/or supplement, e.g., fertilizer for treating plants, and vitamins and/or mineral supplements for treating animals. The additional agent can also be a herbicide.

An animal to be treated by a method of the present invention can include a mammal (such as a porcine, a bovine, or ovine, or even a human), an avian (such as a turkey or chicken), a reptile (e.g., a turtle), an amphibian (e.g., a salamander), a fish (e.g., a salmon) and a crustacean (e.g., a lobster). Plants that can be treated include crops for producing fruits, vegetables, grains and other grasses, flowers and orchids, trees (including both fruit trees and trees for lumber production) hedges, and/or other protective and/or ornamental plants.

In another embodiment, the invention provides for new compounds having anti-parasite activity. These new compounds include an N-phenyl-1,1,1-trifluoromethanesulfonamide compound selected from the group consisting of 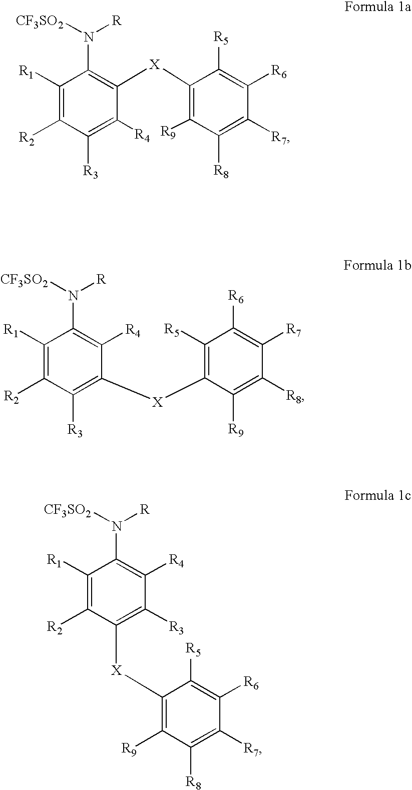
and combinations thereof, wherein

R is selected from the group consisting of alkenyl, alkynyl, arylalkyl, cycloalkylalkyl, heterocyclylalkyl, heteroarylalkyl, with the proviso that (pyridyl)alkyl substituents are excluded, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, aroyl, heterocycloyl, heteroaroyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, arylsulfonyl, heterocyclylsulfonyl and heteroarylsulfonyl; and wherein,

R₁-R₉ are independently selected from the following: hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy; and wherein

X is oxygen, sulfur, sulfinyl, sulfonyl or NR₁₀, wherein R₁₀ is hydrogen or alkyl.

Preferably, the N-phenyl-1,1,1-trifluoromethanesulfonamide compound is one or more of compounds 1, 2, 4, 5, 9, 12, 14-16, 20, 21, 25, 26, 30, 38, 55, 59, 68, 70-73, 75, 79-85, 88-89, 92, m3-m5, m7 and p3-p5 of Tables 1a-d. These are illustrated, as follows.

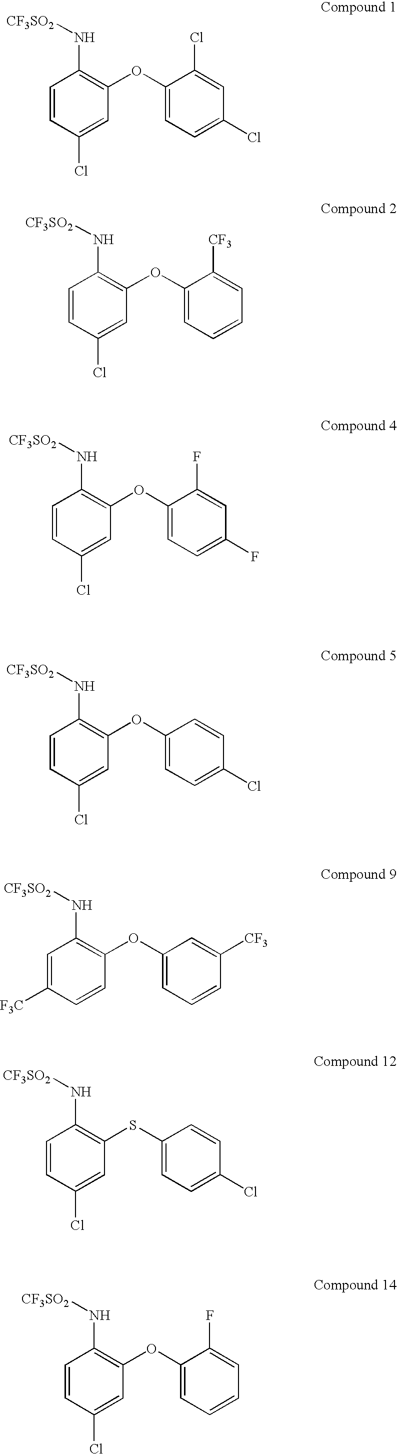

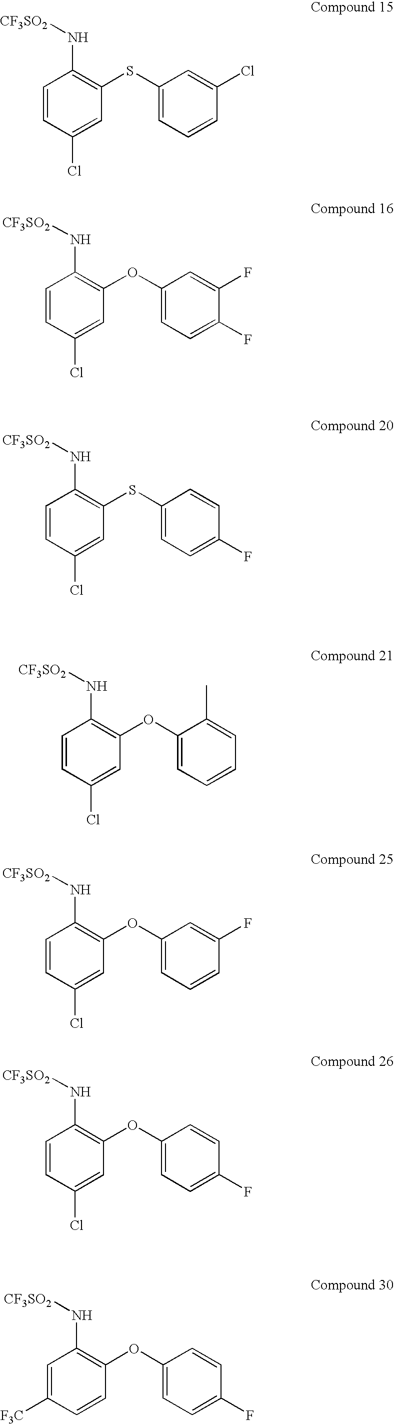

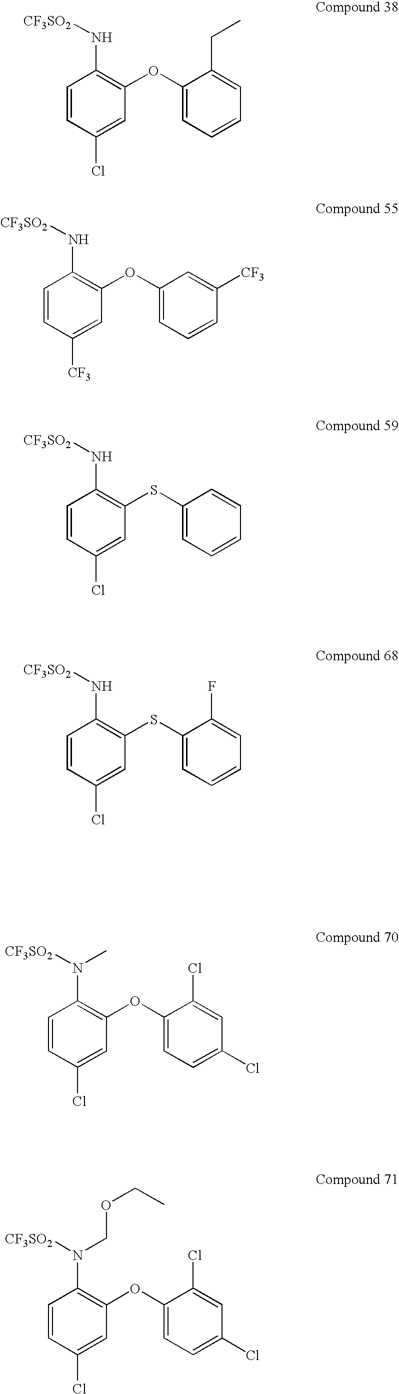

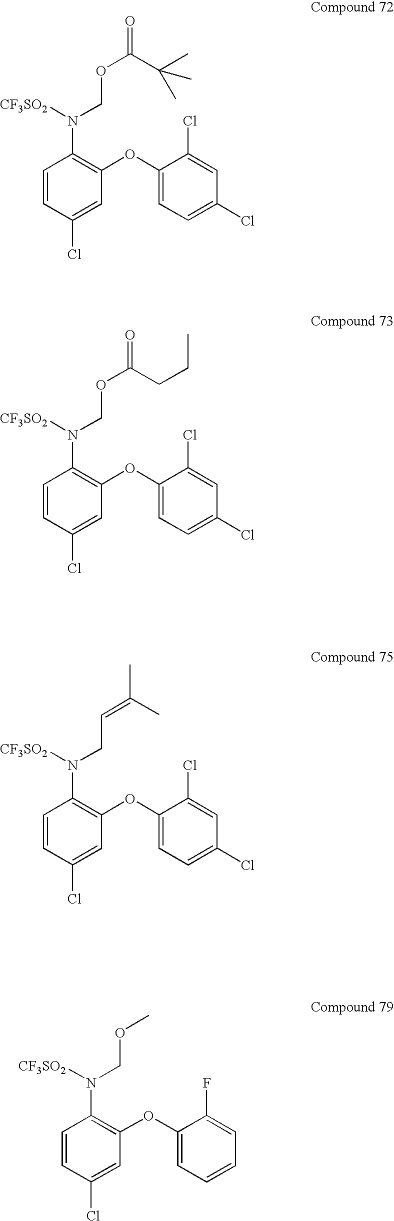

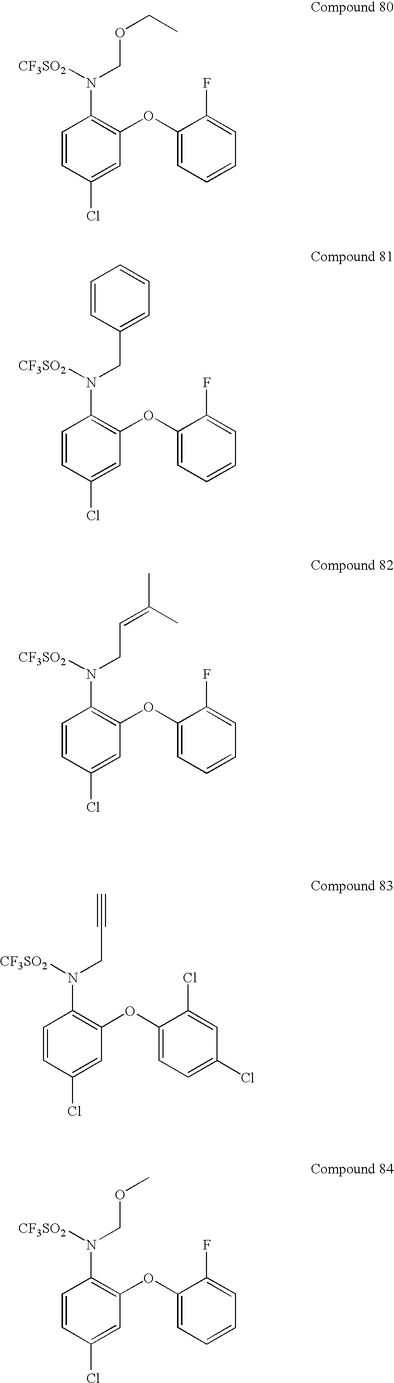

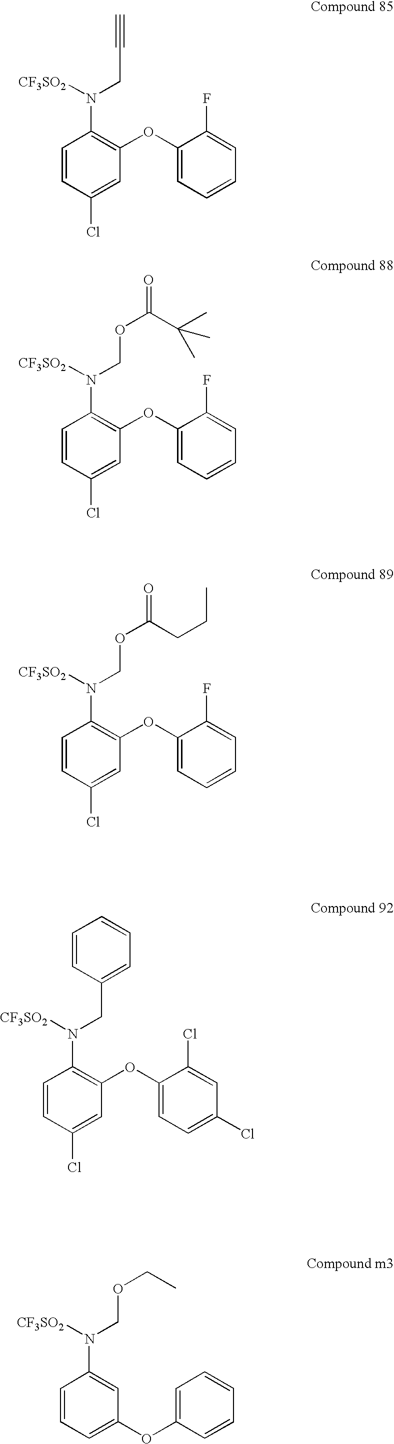

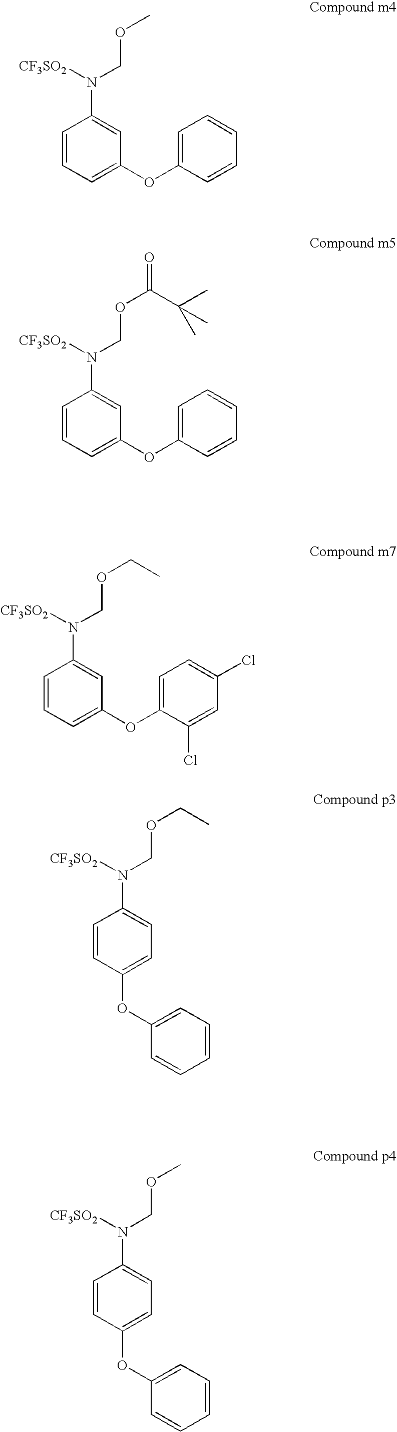

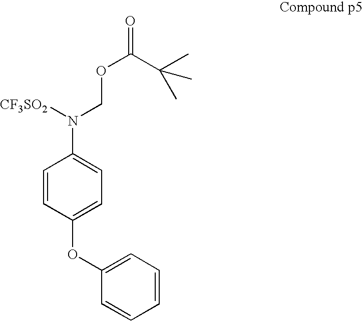

The invention further provides for a pharmaceutical composition that comprises a therapeutically effective dosage amount of at least one of the above-described new compounds, and a pharmaceutically acceptable excipient.

Optionally, the pharmaceutical composition comprises at least one additional active agent. For example, the additional agent is a parasiticide selected from the group consisting of a cyclodiene, a member of the group of ryanoid insecticides, e.g, ryania or ryanodol (see U.S. Pat. No. 2,400,295, incorporated by reference herein), KT-199 (see Nanje Gowda D, et al., Hindustan Antibiot Bull. 1984; 26(1-2):14-7), an avermectin, a benzimidazole, a salicylanilide, a substituted phenol, a pyrimidine, an imidazothiazole, a praziquantel, an organic phosphate and combinations thereof. The additional agent can also be an antibiotic, a plant or animal nutritional factor or supplement, e.g., fertilizer for allowing or promoting the growth of treated plants, and a vitamin or mineral supplement for treating animals. The additional agent can also be a herbicide.

In a still further embodiment, the invention provides for a parasiticidal composition that comprises at least one inventive compound in a concentration effective to kill or suppress an arthropod, helminth, cestode, trematode and/or protozoan, and a suitable carrier. The parasiticidal composition can be administered on the surface of an animal or plant, and/or on any environmental surface and/or structure, e.g., buildings, enclosures, bedding or absorbant material present around animals (for animal husbandry) and/or on the ground, and/or around the foliage, and the like.

In yet a still further embodiment, the invention provides methods of killing or inhibiting the growth of a parasite selected from the group consisting of an arthropod, helminth, cestode, trematode and protozoan, the method comprising contacting the parasite with an effective amount of an N-phenyl-1,1,1-trifluoromethanesulfonamide compound selected from the group consisting of 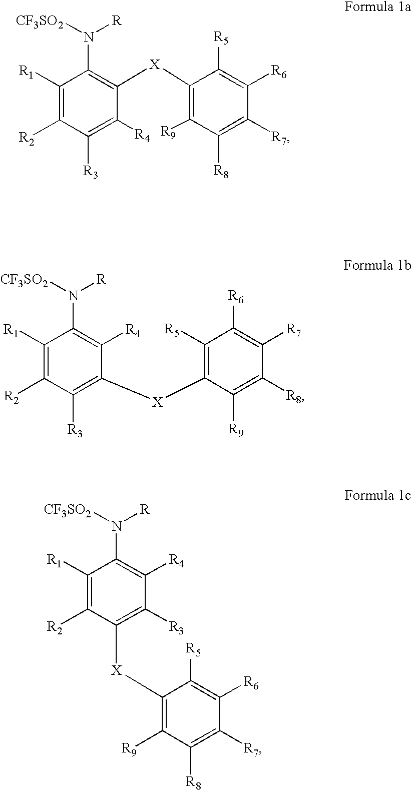
and combinations thereof,
or a pharmaceutically acceptable salt thereof or solvate thereof, wherein,

R is selected from the group consisting of hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; and wherein,

R₁-R₉ are independently selected from hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy; and wherein

X is oxygen, sulfur, sulfinyl, sulfonyl or NR₁₀, wherein R₁₀ is H or alkyl.

### BRIEF DESCRIPTION OF THE DRAWINGS

FIG. 1 illustrates reaction scheme 1 for preparing a compound of Formula 1a from a starting compound of Formula 2a.

FIG. 2 illustrates reaction scheme 2 for preparing a compound of Formula 1b from a starting compound of Formula 2b.

FIG. 3 illustrates reaction scheme 3 for preparing a compound of Formula 1c from a starting compound of Formula 2c.

### DETAILED DESCRIPTION OF THE INVENTION

The invention provides methods of treating and/or preventing endo- and/or ectoparasite infestations of animals, as well as methods of killing or suppressing such parasites by contacting such parasites with compositions comprising N-[(phenyloxy)phenyl]-1,1,1-trifluoromethanesulfonamide, N-[(phenylsulfanyl)phenyl)]-1,1,1-trifluoromethansulfonamide, N-[(phenylsulfinyl)phenyl]-1,1,1-trifluoromethansulfonamide, N-[(phenylsulfonyl)phenyl]-1,1,1-trifluoromethansulfonamide, and/or N-[(phenylamino)phenyl]-1,1,1-trifluoromethanesulfonamide derivatives.

In certain preferred embodiments, new N-[(phenyloxy)phenyl]-1,1,1-trifluoromethanesulfonamide, N-[(phenylsulfanyl)phenyl)]-1,1,1-trifluoromethansulfonamide, N-[(phenylsulfinyl)phenyl]-1,1,1-trifluoromethansulfonamide, N-[(phenylsulfonyl)phenyl]-1,1,1-trifluoromethansulfonamide and/or N-[(phenylamino)phenyl]-1,1,1-trifluoromethanesulfonamide compounds are provided, as listed herein below by compounds 71-73, 75, 79-85, 88-89, 92, m3-m5, m7 and p3-p5.

In order to more fully appreciate the description of the invention, the following definitions are provided. As used herein, the following terms are employed as defined below, unless otherwise indicated.

The use of singular terms for convenience in the description is in no way intended to be so limiting. Thus, for example, reference to “a parasite” includes reference to one or more of such parasites. The use of plural terms is also not intended to be limiting, unless otherwise specified. For example, phrases such as, “N-[(phenyloxy)phenyl]-1,1,1-trifluoromethanesulfonamide, N-[(phenylsulfanyl)phenyl)]-1,1,1-trifluoromethansulfonamide, N-[(phenylsulfinyl)phenyl]-1,1,1-trifluoromethansulfonamide, N-[(phenylsulfonyl)phenyl]-1,1,1-trifluoromethansulfonamide and N-[(phenylamino)phenyl]-1,1,1-trifluoromethanesulfonamide compounds” refers to any N-[(phenyloxy)phenyl]-1,1,1-trifluoromethanesulfonamide, N-[(phenylsulfanyl)phenyl)]-1,1,1-trifluoromethansulfonamide, N-[(phenylsulfinyl)phenyl]-1,1,1-trifluoromethansulfonamide and N-[(phenylsulfonyl)phenyl]-1,1,1-trifluoromethansulfonamide compound identified herein, includes a single such compound alone, or a combination of two or more such compounds, unless otherwise specified.

As used herein the term “approximately” is used interchangeably with the term “about” and generally signifies that a value is within twenty percent of the indicated value, unless otherwise indicated.

In this specification “optionally substituted” means that a functional group is either substituted or unsubstituted, at any available position. Substitution can be with one or more functional groups selected from, e.g., alkyl, alkenyl, alkynyl, aryl, cycloalkyl, cycloalkylalkyl, cycloalkenyl, alkylcycloalkyl, alkylcycloalkenyl, arylcycloalkyl, arylcycloalkenyl, halo, cyano, nitro, haloalkyl, haloalkenyl, haloalkynyl, haloaryl, halocycloalkyl, halocycloalkenyl, hydroxy, alkoxy, cycloalkoxy, alkenyloxy, aryloxy, haloalkoxy, haloalkenyloxy, haloaryloxy, halocycloalkyloxy, heterocyclyl, heterocyclylalkyl, heteroarylalkyl, heterocyclyloxy, heterocyclylamino, heterocyclylalkyl, heterocyclyloxyalkyl, heterocyclylthioalkyl, haloheterocyclyl, haloheterocyclylalkyl, haloheterocyclyloxyalkyl, haloheterocyclylthioalkyl, nitroaryl, nitroheterocyclyl, amino, akylamino, dialklamino, alkenylamino, alkynylamino, arylamino, acyl, alkenylacyl, arylacyl, acylamino, alkylsulphonyloxy, alkoxycarbonyl, alkylthio, alkylsulphonyl, arylthio, arylsulphonyl, aminosulphonyl, dialkylaminosulphonyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, and any other art-known substituents.

“Alkyl” whether used alone, or in compound words such as alkoxalkyl, alkoxyalkoxyalkyl, alkoxy, alkylthio, alkylamino, alkylcarbonyloxyalkyl, dialkylamino or haloalkyl, represents straight or branched chain hydrocarbons ranging in size from one to about 20 carbon atoms, or more. Thus alkyl moieties include, without limitation, moieties ranging in size, for example, from one to about 10 carbon atoms or greater, e.g., methyl, ethyl, n-propyl, iso-propyl and/or butyl, pentyl, hexyl, and higher isomers, including, e.g., those straight or branched chain hydrocarbons ranging in size from about 11 to about 20 carbon atoms, or greater. Preferably, an alkyl group ranges in size from 1 to about 6 carbons.

“Alkenyl” whether used alone, or in compound words such as alkenyloxy or haloalkenyl, represents straight or branched chain hydrocarbons containing at least one carbon-carbon double bond, including, without limitation, moieties ranging in size from two to about 6 carbon atoms or greater, such as, methylene, ethylene, 1-propenyl, 2-propenyl, and/or butenyl, pentenyl, hexenyl, and higher isomers, including, e.g., those straight or branched chain hydrocarbons ranging in size, for example, from about 2 to about 20 carbon atoms, or greater. Preferably, an alkenyl ranges in size from 2 to about 6 carbons.

“Alkynyl” whether used alone, or in compound words such as alkynyloxy, represents straight or branched chain hydrocarbons containing at least one carbon-carbon triple bond, including, without limitation, moieties ranging in size from, e.g., two to about 6 carbon atoms or greater, such as, ethynyl, 1-propynyl, 2-propynyl, and/or butynyl, pentynyl, hexynyl, and higher isomers, including, e.g., those straight or branched chain hydrocarbons ranging in size from, e.g., about 6 to about 20 carbon atoms, or greater. The preferred size is from 1 to about 6 carbons.

“Aryl” whether used alone, or in compound words such as arylalkyl, aryloxy or arylthio, represents: (i) an optionally substituted mono- or polycyclic aromatic carbocyclic moiety, e.g., of about 6 to about 20 carbon atoms, such as phenyl, naphthyl or fluorenyl; or, (ii) an optionally substituted partially saturated polycyclic carbocyclic aromatic ring system in which an aryl and a cycloalkyl or cycloalkenyl group are fused together to form a cyclic structure such as a tetrahydronaphthyl, indenyl or indanyl ring. The preferred number of carbons in an aryl group ranges from 6 to about 10.

“Heteroaryl” whether used alone, or in compound words means an aromatic monocyclic or multicyclic ring system comprising about 5 to about 14 ring atoms, preferably about 5 to about 10 ring atoms, in which one or more of the ring atoms is an element other than carbon, for example nitrogen, oxygen or sulfur, alone or in combination. Preferred heteroaryls contain about 5 to about 6 ring atoms. The “heteroaryl” can be optionally substituted by one or more “ring system substituents” which may be the same or different, and are as defined herein. The prefix aza, oxa or thia before the heteroaryl root name means that at least a nitrogen, oxygen or sulfur atom respectively, is present as a ring atom. A nitrogen atom of a heteroaryl can be optionally oxidized to the corresponding N-oxide. Non-limiting examples of suitable heteroaryls include pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl and the like. The term “heteroaryl” also refers to partially saturated heteroaryl moieties such as, for example, tetrahydroisoquinolyl, tetrahydroquinolyl and the like.

“Cycloalkyl” represents a mono- or polycarbocyclic ring system of varying sizes, e.g., from about 3 to about 20 carbon atoms, e.g., cyclopropyl, cyclobutyl, cyclopentyl, cyclohexyl or cycloheptyl. The term cycloalkyloxy represents the same groups linked through an oxygen atom such as cyclopentyloxy and cyclohexyloxy. The term cycloalkylthio represents the same groups linked through a sulfur atom such as cyclopentylthio and cyclohexylthio. The preferred number of carbons in a cycloalkyl group ranges from 3 to about 7.

“Alkylcycloalkyl” denotes alkyl substitution on a cycloalkyl moiety. Examples include 4-methylcyclohexyl and isopropylcyclopentyl. The preferred number of carbons in an alkylcycloalkyl group ranges from about 4 to about 12.

The term “acyl,” means an H—C(O)—, alkyl-C(O)— or cycloalkyl-C(O)—, group in which the various groups are as described herein. The bond to the parent moiety is through the carbonyl. “Acyl”, whether used alone or in compound words such as alkenylacyl and arylacyl, denotes the radical formed after removing the hydroxyl group from an organic acid. Acyl includes: alkanoyl, aroyl, heteroaroyl.

“Alkanoyl” means the group RCO where R is alkyl. Examples include formyl, acetyl, propionyl, and the different butyryl, valeryl, caproyl and higher isomers.

“Aroyl” means an acyl group derived from an aromatic acid. “Heteroaroyl” means the group RCO where R is heteroaryl. Preferred acyl groups contain from 1 to about 10 carbons.

The term, “carbamoyl” denotes the group R₂N—CO wherein R is H, alkyl, aryl, heteroaryl or heterocyclyl. Examples include N-methylcarbamoyl, and N,N-dimethylcarbamoyl.

“Thiocarbamoyl” denotes a group R₂N—CS where R is H, alkyl, aryl, heteroaryl or heterocyclyl. Examples include N-methylthiocarbamoyl, and N,N-dimethylthiocarbamoyl.

The term “halo”, either alone or in compound words such as “haloalkyl”, denotes fluorine, chlorine, bromine or iodine. Further, when used in compound words such as “haloalkyl” the alkyl may be partially halogenated or fully substituted with halogen atoms which may be the same or different. Examples of haloalkyl include CH₂CH₂F, CF₂CF₃ and CH₂CHFCl. Examples of “haloalkenyl” include Cl₂C═CHCH₂ and CF₃CH₂CH═CHCH₂. Examples of “haloalkynyl” include HC≡CCHCl, CF₃C≡C, CCl₃C≡C and FCH₂C≡CCH₂. Examples of “haloalkoxy” include CF₃O, CCl₃CH₂O, CF₂CH₂CH₂O and CF₃CH₂O. Examples of “haloalkylthio” include CCl₃S, CF₃S, CCl₃CH₂S and CH₂ClCH₂ClCH₂CH₂S. Examples of “haloalkylsulfonyl” include CF₃SO₂, CCl₃SO₂, CF₃CH₂SO₂ and CF₃CF₂SO₂.

“Heterocyclyl” denotes a group comprising a 3 to 10 membered, preferably 5 to 8 membered, ring containing one to three hetero atoms such as oxygen, nitrogen or sulfur, which ring may be substituted and/or carry fused rings. Examples of such groups include, pyrrolidinyl, morpholinyl, thiomorpholinyl, or fully or partially hydrogenated thienyl, furanyl, pyrrolyl, thiazolyl, oxazoyl, oxazinyl, thiazinyl, pyridinyl and azepinyl. The heterocyclyl group may be aromatic in which case it may be referred to herein as a “heteroaryl” group. Examples of heteroaryl include pyridyl, furanyl, thienyl, pyrrolyl, pyrazoyl, benzthiazolyl, indolyl, benzofuranyl, benzothiophenyl, pyrazinyl, quinoyl, pyrimidinyl.

“Alkoxy” denotes an alkyl group linked to the rest of the molecule via an oxygen atom, for example methoxy, ethoxy, n-propoxy, iso-propyloxy, and the different butyloxy, pentyloxy, hexyloxy and higher isomers. The preferred number of carbons in an alkoxy group ranges from 1 to about 6.

“Alkenyloxy” denotes straight chain or branched alkenyloxy moieties. Examples of alkenyloxy include CH₂═CHCH₂O, (CH₃) ₂C═CHCH₂O, (CH₃)CH═C(CH₃)CH₂O and CH₂C═CHCH₂CH₂O. The preferred number of carbons in an alkenyloy group ranges from 2 to 6.

“Aryloxy” denotes an aryl group linked to the rest of the molecule via an oxygen atom, for example phenoxy. “Aryloxyalkyl” denotes aryloxy substitution on alkyl. “Alkyloxyaryl” denotes alkoxy substitution on aryl. “Arylalkoxy” denotes aryl substitution on an alkoxy group, e.g. benzyloxy and 2-phenylethoxy.

“Alkoxycarbonyl” denotes a group ROC═O where R is alkyl. Examples of “alkoxycarbonyl” include CH₃OC(═O), CH₃CH₂OC(═O), CH₃CH₂CH₂OC(═O), (CH₃)₂CHOC(═O) and the different butoxy-, pentoxy-, hexyloxycarbonyl and higher isomers. The preferred range of carbons for an alkoxycarbonyl group is from 2 to about 8.

“Alkylthio” denotes alkyl groups linked to the rest of the molecule via a sulfur atom, for example methylthio, ethylthio, n-propylthio, iso-propylthio, and the different butylthio, pentylthio, hexylthio and higher isomers.

“Sulfonyl” represents an —SO₂R group that is linked to the rest of the molecule through a sulfur atom.

“Alkylsulfonyl” represents an —SO₂-alkyl group in which the alkyl group is as defined supra.

“Arylsulfonyl” represents an —SO₂-aryl group in which the aryl group is as defined supra.

“Phenylsulfanyl” denotes a —S-Ph group that is linked to the rest of the molecule via a sulfur atom.

“Phenylsulfinyl”′ represents an —SO-Ph group that is linked to the rest of the molecule through a sulfur atom.

“Phenylsulfonyl” represents an —SO2-Ph group that is linked to the rest of the molecule through a sulfur atom.

“Phenylamino” represents an —NR₁₀-Ph group, wherein R₁₀ is hydrogen or alkyl which is linked to the rest of the molecule through a nitrogen atom.

“Cyano” represents a —CN moiety.

“Cyanoalkyl” represents an alkyl group that contains a cyano substituent.

“Heterocyclylalkyl” denotes a heterocyclyl substitution on an alkyl moiety.

“Heteroarylalkyl” denotes a heteroaryl substitution on an alkyl moiety.

“Hydroxyalkyl” denotes an alkyl group that contains an alcohol substituent.

“Alkoxyalkyl” denotes an alkoxy substitution on an alkyl moiety.

“Aryloxyalkyl” denotes an aryloxy substitution on an alkyl moiety.

“Alkylcarbonylalkyl” denotes an acyl substitution on an alkyl moiety, in which the acyl group is a alkyl-C(O)—.

“Cycloalkylcarbonylalkyl” denotes acyl substitution on an alkyl moiety, in which the acyl group is a cycloalkyl-C(O)—.

“Arylcarbonylalkyl” denotes an aroyl substitution on an alkyl moiety.

“Heterocyclylcarbonylalkyl” denotes an acyl substitution on an alkyl moiety, in which the acyl group is a heterocyclyl-C(O)—.

“Heteroarylcarbonylalkyl” denotes an acyl substitution on an alkyl moiety, in which the acyl group is a heteroaryl-C(O)—.

“Alkoxycarbonylalkyl” denotes an alkyl group that contains an alkoxycarbonyl substituent.

“Alkylaminocarbonylalkyl” denotes an alkyl group that contains the “carbamoyl” group R₂N-CO— wherein R is alkyl.

“Trialkylsilylalkyl” denotes an alkyl group that contains the substituent R₃Si— wherein R is alkyl.

“Trialkoxysilylalkyl” denotes an alkyl group that contains the substituent (RO)₃Si— wherein R is alkyl.

“Dialkoxyphosphonatoalkyl” denotes an alkyl group that contains the substituent (RO)₂P(═O)— wherein R is alkyl.

“Heterocyclyloxyalkyl” denotes an alkyl group that contains the substituent R—O— wherein R is heterocyclyl.

“Heteroaryloxyalkyl” denotes an alkyl group that contains the substituent R—O— wherein R is heteroaryl.

“Alkylcarbonyloxyalkyl” denotes an alkyl group that contains the substituent R(CO)—O— wherein R is alkyl.

“Arylcarbonyloxyalkyl” denotes an alkyl group that contains the substituent R(CO)—O— wherein R is aryl.

“Heterocyclylcarbonyloxyalkyl” denotes an alkyl group that contains the substituent R(CO)—O— wherein R is heterocyclyl.

“Heteroarylcarbonyloxyalkyl” denotes an alkyl group that contains the substituent R(CO)—O— wherein R is heteroaryl.

“Alkoxycarbonyloxyalkyl” denotes an alkyl group that contains the substituent RO(CO)O— wherein R is alkyl.

“Aryloxycarbonyloxyalkyl” denotes an alkyl group that contains the substituent RO(CO)O— wherein R is aryl.

“Heterocyclyloxycarbonyloxyalkyl” denotes an alkyl group that contains the substituent RO(CO)O— wherein R is heterocyclyl.

“Heteroaryloxycarbonyloxyalkyl” denotes an alkyl group that contains the substituent RO(CO)O— wherein R is heteroaryl.

“Alkylaminocarbonyloxyalkyl” denotes an alkyl group that contains the substituent R₂N(CO)O— wherein at least one R is alkyl.

“Arylaminocarbonyloxyalkyl” denotes an alkyl group that contains the substituent R₂N(CO)O— wherein at least one R is aryl.

“Heterocyclylaminocarbonyloxyalkyl” denotes an alkyl group that contains the substituent R₂N(CO)O— wherein at least one R is heterocyclyl.

“Heteroarylaminocarbonyloxyalkyl” denotes an alkyl group that contains the substituent R₂N(CO)O— wherein at least one R is heteroaryl

“Alkylcarbonylaminoalkyl” denotes an alkyl group that contains the substituent R(CO)NH— wherein R is alkyl.

“Arylcarbonylaminoalkyl” denotes an alkyl group that contains the substituent R(CO)NH— wherein R is aryl.

“Heterocyclylcarbonylaminoalkyl” denotes an alkyl group that contains the substituent R(CO)NH— wherein R is heterocyclyl.

“Heteroarylcarbonylaminoalkyl” denotes an alkyl group that contains the substituent R(CO)NH— wherein R is heteroaryl.

“Alkylsulfonylalkyl” represents an alkyl group that contains an alkylsulfonyl substituent.

“Arylsulfonylalkyl” represents an alkyl group that contains an arylsufonyl substituent.

“Heterocyclylsulfonylalkyl” denotes an alkyl group that contains the substituent R(SO₂)— wherein R is heterocyclyl.

“Heteroarylsulfonylalkyl” denotes an alkyl group that contains the substituent R(SO₂)—wherein R is heteroaryl.

“Aryloxycarbonyl” denotes a group ROC═O where R is aryl.

“Heterocyclyloxycarbonyl” denotes a group ROC═O where R is heterocyclyl.

“Heteroaryloxycarbonyl” denotes a group ROC═O where R is heteroaryl.

The term “prodrug” as used herein refers to a compound which is convertible in use, e.g., on an environmental surface and/or in vivo, by metabolic means or other processes (e.g., by hydrolysis) to one of the compounds of the invention, e.g., a compound of Formula 1a, 1b, and 1c. For example, derivatization of the compound of Formula 1a, 1b, and 1c, wherein R is hydrogen, is contemplated to provide a compound convertible by hydrolysis in vivo to the parent molecule. In certain optional embodiments, delivery of the active compound in prodrug form achieves improved delivery of the inventive compound by improving its physicochemical/pharmacokinetic properties, e.g., by enhancing systemic absorption, delaying clearance or breakdown, in vivo. A discussion of prodrugs is provided in Higuchi and Stella, Pro-drugs as Novel Delivery Systems, 14 of the A. C. S. Symposium Series (1987); and in Bioreversible Carriers in Drug Design, Edward B. Roche, ed., American Pharmaceutical Association and Pergamon Press (1987).

A parasite “infestation” refers to the presence of parasites in numbers that pose a risk to humans or animals. The presence can be in the environment, e.g., on plants, in animal bedding, on the skin or fur of an animal, etc. When the infestation that is referred to is within an animal, e.g., in the blood or other internal tissues, the term infestation is also intended to be synonymous with the term, “infection,” as that term is generally understood in the art, unless otherwise stated.

An “effective amount,” is the amount or quantity of a compound according to the invention that is required to alleviate or reduce parasite numbers in a sample of such parasites, and/or to reduce the numbers of such parasites in and/or on an animal, and/or to inhibit the development of parasite infestation in or on an animal, in whole or in part. This amount is readily determined by observation or detection of the parasite numbers both before and after contacting the sample of parasites with the compound, directly and/or indirectly, e.g., by contacting articles, surfaces, foliage, or animals with the compound. For an in vivo administration of the compound according to the invention, an effective amount is synonymous with a “pharmaceutically effective amount,” which is the dose or amount that treats or ameliorates symptoms and/or signs of parasite infection or infestation by the treated animal. This latter amount is also readily determined by one of ordinary skill in the art, e.g., by observing or detecting changes in clinical condition or behavior of treated animals, as well as by observing or detecting relative changes in parasite numbers after such treatment. Whether the compound is applied in vivo or ex vivo, the treatment is effective when the parasite count is reduced, after a first application or administration, by an amount ranging from 5% to about 100%. Alternatively, the reduction in parasite count ranges from about 10% to about 95%, relative to the parasite count in an equivalent untreated sample.

Compounds of this invention can exist as one or more stereoisomers. The various stereoisomers include enantiomers, diastereomers and geometric isomers. Those skilled in the art will appreciate that one stereoisomer may be more active than the other(s). In addition, the skilled artisan would know how to separate such stereoisomers. Accordingly, the present invention comprises mixtures, individual stereoisomers, and optically active mixtures of the compounds described herein.

Certain compounds of the present invention will be acidic in nature and can form pharmaceutically acceptable metal, ammonium and organic amine salts. The metal salts include alkali metal (e.g., lithium, sodium and potassium), alkaline earth metal (e.g., barium, calcium and magnesium) and heavy metal (e.g., zinc and iron) salts as well as other metal salts such as aluminum. The organic amine salts include the salts of pharmaceutical acceptable aliphatic (e.g., alkyl), aromatic and heterocyclic amines, as well as those having a mixture of these types of structures.

Amines useful in preparing the salts of the invention can be primary, secondary or tertiary and preferably contain not more than 20 carbon atoms. The salts of the invention are prepared by contacting the acid form with a sufficient amount of the appropriate base to produce a salt in the conventional manner. The acid forms may be regenerated by treating the salt with a suitable dilute aqueous acid solution. The acid forms differ from their respective salt forms somewhat in certain physical properties, such as solubility in polar solvents, but the salts are otherwise equivalent to their respective acid forms for the purposes of the invention.

All such salts are intended to be pharmaceutically acceptable within the scope of the invention and all salts are considered equivalent to the acid form for the purposes of the invention.

The compounds of the invention, and the compounds employed in the methods of the invention can also form stable complexes with solvent molecules that remain intact after the non-complexed solvent molecules are removed from the compounds. These complexes are referred to herein as “solvates”. In certain instances the solvate will be capable of isolation, for example when one or more solvent molecules are incorporated in the crystal lattice of the crystalline solid. A “solvate” encompasses both solution-phase and isolatable solvates. Non-limiting examples of suitable solvates include ethanolates, methanolates, and the like. A “hydrate” is a solvate in which the solvent molecule is water. Solvates of the compounds of the present invention are also included in the present invention.

For all of the methods and new compounds described herein, it is also contemplated that the identified compounds are readily employed in combination with one or more art-known agents for killing or controlling various types of parasites, e.g., including all of the ecto- and endoparasites described herein. Thus, although the inventive compounds and methods are preferred over previously known agents and methods of using previously known agents, in certain optional embodiments they are contemplated to be employed in combination, simultaneously, or sequentially (e.g. in the same composition or in separate compositions), with other art-known agents or combinations of such art-known agents employed for killing or controlling various types of pests.

These additional agents include, for example, art-known anthelmintics, such as, for example, avermectins (e.g. ivermectin, moxidectin, milbemycin), benzimidazoles (e.g. albendazole, triclabendazole), salicylanilides (e.g. closantel, oxyclozanide), substituted phenols (e.g. nitroxynil), pyrimidines (e.g. pyrantel), imidazothiazoles (e.g. levamisole) and praziquantel.

Additional art-known agents for killing or controlling pests include the organophosphate pesticides. This class of pesticides has very broad activity, e.g. as insecticides and, in certain instances, anthelminitic activity. Organophosphate pesticides include, e.g., dicrotophos, terbufos, dimethoate, diazinon, disulfoton, trichlorfon, azinphos-methyl, chlorpyrifos, malathion, oxydemeton-methyl, methamidophos, acephate, ethyl parathion, methyl parathion, mevinphos, phorate, carbofenthion, phosalone, to name but a few such compounds. It is also contemplated to include combinations of the inventive methods and compounds with carbamate type pesticides, including, e.g., carbaryl, carbofuran, aldicarb, molinate, methomyl, carbofuran, etc., as well as combinations with the organochlorine type pesticides. It is further contemplated to include combinations with biological pesticides, including e.g. repellents, the pyrethrins (as well as synthetic variations thereof, e.g., allethrin, resmethrin, permethrin, tralomethrin), and nicotine, that is often employed as an acaricide. Other contemplated combinations are with miscellaneous pesticides including: bacillus thuringensis, chlorobenzilate, formamidines, (e.g. amtitaz), copper compounds, e.g., copper hydroxide, cupric oxychloride sulfate, cyfluthrin, cypermethrin, dicofol, endosulfan, esenfenvalerate, fenvalerate, lambda-cyhalothrin, methoxychlor, sulfur.

In addition, for all of the methods and new compounds described herein, it is further contemplated that the identified compounds can be readily employed in combination with syngergists such as piperonyl butoxide (PBO) and triphenyl phosphate (TPP); and/or with Insect Growth Regulators (IGRs) and Juvenile Hormone Analogues (JHAs) such as diflubenzuron, cyromazine, methoprene etc. , thereby providing both initial and sustained control of parasites (at all stages of insect development, including eggs) on the animal subject, as well as within the environment of the animal subject.

Combinations with cyclodienes, ryania, KT-199 and/or older art-known anti-helminth agents, such as avermectins (e.g., ivermectin, moxidectin, milbemycin), benzimidazoles (e.g. albendazole, triclabendazole), salicylanilides (e.g., closantel, oxyclozanide), substituted phenols (e.g., nitroxynil), pyrimidines (e.g., pyrantel), imidazothiazoles (e.g., levamisole), praziquantel and some organophosphates such as naphthalophos and pyraclofos, are also contemplated to be employed in such combinations.

In particular, additional antiparasitic compounds useful within the scope of the present invention are preferably comprised of the class of avermectin compounds. As stated above, the avermectin family of compounds is a series of very potent antiparasitic agents known to be useful against a broad spectrum of endoparasites and ectoparasites in mammals.

A preferred compound for use within the scope of the present invention is Ivermectin. Ivermectin is a semi-synthetic derivative of avermectin and is generally produced as a mixture of at least 80% 22,23-dihydroavermectin B1ₐ and less than 20% 22,23-dihydroavermectin B1_{b}. Ivermectin is disclosed in U.S. Pat. No. 4,199,569, hereby incorporated by reference. Ivermectin has been used as an antiparasitic agent to treat various animal parasites and parasitic diseases since the mid-1980's.

Abamectin is an avermectin that is disclosed as avermectin B1a/B1b in U.S. Pat. No. 4,310,519, which is hereby incorporated by reference in its entirety. Abamectin contains at least 80% of avermectin B1ₐ and not more than 20% of avermectin B1_{b}.

Another preferred avermectin is Doramectin also known as 25-cyclohexyl-avermectin B₁. The structure and preparation of Doramectin, is disclosed in U.S. Pat. No. 5,089,480, which is hereby incorporated by reference in its entirety.

Another preferred avermectin is Moxidectin. Moxidectin, also known as LL-F28249 alpha is known from U.S. Pat. No. 4,916,154, which is hereby incorporated by reference in its entirety.

Another preferred avermectin is Selamectin. Selamectin is 25-cyclohexyl-25-de(1-methylpropyl)-5-deoxy-22,23-dihydro-5-(hydroxyimino- ) avermectin B₁ monosaccharide.

Milbemycin, or B41, is a substance which is isolated from the fermentation broth of a Milbemycin producing strain of Streptomyces. The microorganism, the fermentation conditions and the isolation procedures are more fully described in U.S. Pat. Nos. 3,950,360 and 3,984,564.

Emamectin (4“-deoxy4” epimethylaminoavermectin B₁), which can be prepared as described in U.S. Pat. Nos. 5,288,710 or 5,399,717, is a mixture of two homologues, 4“-deoxy4” epimethylaminoavermectin B1a and 4″-deoxy4″-epimethylaminoavermectin B1b. Preferably, a salt of Emamectin is used. Non-limiting examples of salts of Emamectin which may be used in the present invention include the salts described in U.S. Pat. No. 5,288,710, e.g., salts derived from benzoic acid, substituted benzoic acid, benzenesulfonic acid, citric acid, phosphoric acid, tartaric acid, maleic acid, and the like. Most preferably, the Emamectin salt used in the present invention is Emamectin benzoate.

Eprinomectin is chemically known as 4″-epi-Acetylamino-4″-deoxy-avermectin B₁. Eprinomectin was specifically developed to be used in all cattle classes and age groups. It was the first avermectin to show broad-spectrum activity against both endo- and ecto-parasites while also leaving minimal residues in meat and milk. It has the additional advantage of being highly potent when delivered topically.

The composition of the present invention optionally comprises combinations of one or more of the following antiparasite compounds.

The antiparasite imidazo[1,2-b]pyridazine compounds as described by U.S. Patent Application Publication No. 2005/0182059, incorporated by reference herein.

The antiparasite 1-(4-mono and di-halomethylsulphonylphenyl)-2-acylamino-3-fluoropropanol compounds, as described by U.S. Patent Application Publication No. 2005/0182139, incorporated by reference herein.

The antiparasite phenyl-3-(1H-pyrrol-2-yl)acrylonitrile compounds, as described by U.S. application Ser. No. 11/280,739, filed on Nov. 19, 2004, incorporated by reference herein.

The antiparasite trifluoromethanesulfonanilide oxime ether compounds, as described by U.S. application Ser. No. 11/231,423, filed on Sep. 23, 2004, incorporated by reference herein.

The composition of the present invention optionally comprises combinations of one or more of the following antiparasite compounds.

The compositions of the present invention may also further comprise a flukicide. Suitable flukicides include, for example, Triclabendazole, Fenbendazole, Albendazole, Clorsulon and Oxibendazole. It will be appreciated that the above combinations may further include combinations of antibiotic, antiparasitic and anti-fluke active compounds.

In addition to the above combinations, it is also contemplated to provide combinations of the inventive methods and compounds, as described herein, with other animal health remedies such as trace elements, anti-inflammatories, anti-infectives, hormones, dermatological preparations, including antiseptics and disinfectants, and immunobiologicals such as vaccines and antisera for the prevention of disease.

For example, such antinfectives include one or more antibiotics that are optionally co-administered during treatment using the inventive compounds or methods, e.g., in a combined composition and/or in separate dosage forms. Art-known antibiotics suitable for this purpose include, for example, those listed hereinbelow.

One useful antibiotic is Florfenicol, also known as (D-(threo)-1-p-methylsulfonyl phenyl-2-dichloroacetamido-3-fluoro-1-propanol). Another preferred antibiotic compound is D-(threo)-1-p-methylsulfony-I phenyl-2-difluoroacetamido-3-fluoro-1-propanol. Another useful antibiotic is Thiamphenicol. Processes for the manufacture of these antibiotic compounds, and intermediates useful in such processes, are described in U.S. Pat. Nos. 4,311,857; 4,582,918; 4,973,750; 4,876,352; 5,227,494; 4,743,700; 5,567,844; 5,105,009; 5,382,673; 5,352,832; and 5,663,361, hereby incorporated by reference. Other florfenicol analogs and/or prodrugs have been disclosed and such analogs also can be used in the compositions and methods of the present invention [see e.g., U.S. Patent Application Publication No: 2004/0082553, and U.S. Patent Application Publication No. 2005/0182031, both of which are hereby incorporated by reference in their entireties]. When the antibiotic compound is Florfenicol, the concentration of Florfenicol typically is from about 10% to about 50% w/v, with the preferred level between about 20% and about 40% w/v, even more preferred being at least about 30% w/v.

Another useful antibiotic compound is Tilmicosin. Tilmicosin is a macrolide antibiotic that is chemically defined as 20-dihydro-20-deoxy-20-(cis-3,5-dimethylpiperidin-1-yl)-desmycosin and which is reportedly disclosed in U.S. Pat. No. 4,820,695, hereby incorporated by reference. Also disclosed in U.S. Pat. No. 4,820,695 is an injectable, aqueous formulation comprising 50% (by volume) propylene glycol, 4% (by volume) benzyl alcohol, and 50 to 500 mg/ml of active ingredient. Tilmicosin may be present as the base or as a phosphate. Tilmicosin has been found to be useful in treatment of respiratory infections, particularly Pasteurella haemolytica infections in cattle when administered by injection over a 4 day treatment period. Accordingly, Tilmicosin may be used in treatment of, for example, neonatal calf pneumonia and bovine respiratory disease. When Tilmicosin is present, it is present in an amount of about 1 % to about 50%, preferably 10% to about 50%, and in a particular embodiment, 30%.

Another useful antibiotic for use in the present invention is Tulathromycin. Tulathromycin has the following chemical structure.

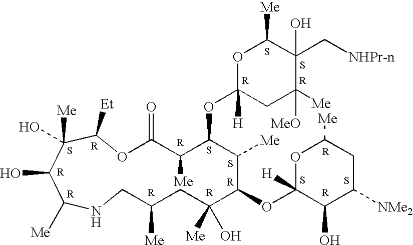

Tulathromycin may be identified as 1-oxa-6-azacyclopentadecan-15-on- e, 13-[[2,6-dideoxy-3-C-methyl-3-O-methyl-4-C-[(propylamino)methyl]-.a/pha-L-ribo-hexopyranosyl]oxy]-2-ethyl-3,4, 1 0-trihydroxy-3,5,8,10,12,14-hexa- methyl-11-[[3,4,6-trideoxy-3-(dimethylamino)-beta-D-xylo-hexopyranosyl]o- xy]-, (2R, 3S, 4R, 5R, 8R,10R, 11 R, 12S, 13S, 14R). Tulathromycin may be prepared in accordance with the procedures set forth in U.S. Patent Publication No. 2003/0064939 A1, which is hereby incorporated by reference in its entirety. Tulathromycin may be present in injectable dosage forms at concentration levels ranging from about 5.0% to about 70% by weight. Tulathromycin is most desirably administered in dosages ranging from about 0.2 mg per kg body weight per day (mg/kg/day) to about 200 mg/kg/day in single or divided doses (i.e., from 1 to 4 doses per day), and more preferably 1.25, 2.5 or 5 mg/kg once or twice weekly, although variations will necessarily occur depending upon the species, weight and condition of the subject being treated. Tulathromycin may be present in injectable dosage forms at concentration levels ranging from about 5.0% to about 70% by weight.

Further antibiotics for use in the present invention include the cephalosporins such as, for example, Ceftiofur, Cefquinome, etc. The concentration of the cephalosporin in the formulation of the present invention optionally varies between about 1 mg/ml to 500 mg/ml.

Another useful antibiotic includes the fluoroquinolones, such as, for example, Enrofloxacin, Danofloxacin, Difloxacin, Orbifloxacin and Marbofloxacin. In the case of Enrofloxacin, it may be administered in a concentration of about 100 mg/ml. Danofloxacin may be present in a concentration of about 180 mg/ml.

Other useful macrolide antibiotics include compounds from the class of ketolides, or, more specifically, the azalides. Such compounds are described in, for example, U.S. Pat. Nos. 6,514,945, 6,472,371, 6,270, 768, 6,437,151 and 6,271,255, and U.S. Pat. Nos. 6,239,112, 5,958,888, and 6,339,063 and 6,054,434, all of which are hereby incorporated by reference in their entireties.

Other useful antibiotics include the tetracyclines, particularly Chlortetracycline and Oxytetracycline. Other antibiotics may include p-lactams such as penicillins, e.g., Penicillin, Ampicillin, Amoxicillin, or a combination of Amoxicillin with Clavulanic acid or other beta lactamase inhibitors.

Additionally, the present invention optionally includes a composition for the treatment of a microbial and parasitic infection in an animal that comprises one or more of the above-listed antibiotics admixed and/or in combination with one or more of the inventive compounds, and an optional carrier and/or excipient.

Further, it is also contemplated that the inventive methods and compounds be advantageously employed in combination, simultaneously or sequentially, with art-known animal health remedies e.g., trace elements, vitamins, anti-inflammatories, anti-infectives and the like, in the same or different compositions.

### Inventive Compounds and Compounds Employed In The Inventive Methods

In one preferred embodiment of the invention, the inventive methods include contacting susceptible endo and/or ecto parasites with an effective amount of a N-phenyl-1,1,1-trifluoromethanesulfonamide compound of Formula 1a, 1b or 1c, or a pharmaceutically acceptable salt thereof or a solvate thereof: 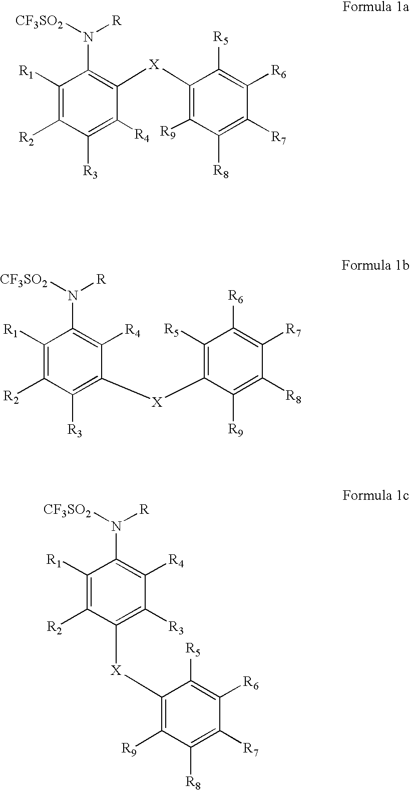
In Formula 1a, 1b, and 1c:

R is selected from the group consisting of hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; and wherein,

R₁-R₉ are independently selected from the following: hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy; and wherein

X is selected from oxygen, sulfur, sulfinyl, sulfonyl or NR₁₀ wherein R₁₀ is hydrogen or alkyl.

A preferred embodiment of the invention provides a method of killing, or suppressing the growth of an ecto- or endoparasite, comprising contacting a susceptible ecto- or endoparasite with an effective amount of a N-phenyl-1,1,1-trifluoromethanesulfonamide compounds of Formula 1, wherein

R is selected from the group consisting of H, and one of the following optionally substituted groups, alkyl, alkenyl, alkynyl, alkoxyalkyl, alkycarbonyloxyalkyl, and wherein,

R₁-R₉ are independently selected from the following: hydrogen, cyano, halo and the following optionally substituted moieties: alkyl, aryl, alkoxy, haloalkyl, haloalkoxy, additionally R₅/R₆ or R₆/R₇ can be connected in a fused ring consisting of 5-7 members; and

wherein X is selected from oxygen, and sulfur, or a pharmaceutically acceptable salt thereof or solvate thereof.

In a preferred embodiment, the inventive method is conducted with a compound of Formula 1a wherein

R is selected from the group consisting of H, and one of the following optionally substituted groups, alkyl, alkenyl, alkynyl, alkoxyalkyl, alkylcarbonyloxyalkyl;

R₁, R₄, R₈ and R₉ are H;

R₂ is H, Cl or CF₃;

R₃ is H or Cl;

R₅ is selected from H, F, Cl, Me, Et, isopropyl, tert-butyl;

R₆ is selected from H, F, Cl, CF₃, Me, MeO, CN;

R₇ is selected from H, F, Cl, Me, tert-butyl, MeO, phenoxy, CN;

X is O or S.

More preferably, the inventive method is conducted with a N-phenyl-1,1,1-trifluoromethanesulfonamide compound of Formula 1a, 1b or 1c selected from the group identified in Tables 1a-d, or a pharmaceutical acceptable salt thereof or solvate thereof.

Preferably, the parasite to be killed or suppressed is an ectoparasite or an endoparasite, which can be present in the environment, on or within a plant or animal (ex vivo or in vivo).

In another embodiment, the invention also provides for new N-phenyl-1,1,1-trifluoromethanesulfonamide compounds of Formula 1a, 1b or 1c, wherein

R is selected from the group consisting of alkenyl, alkynyl, arylalkyl, cycloalkylalkyl, heterocyclylalkyl, heteroarylalkyl, with the proviso that (pyridyl)alkyl substituents are excluded, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, aroyl, heterocycloyl, heteroaroyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, arylsulfonyl, heterocyclylsulfonyl and heteroarylsulfonyl; and wherein,

R₁-R₉ are independently selected from the following: hydrogen, cyano, nitro, halo and the following optionally substituted moieties: alkyl, cycloalkyl, aryl, heterocyclyl, heteroaryl, alkoxy, cycloalkoxy, aryloxy, heteroaryloxy, heterocyclyloxy, haloalkyl, haloalkoxy; and wherein

X is selected from oxygen, sulfur, sulfinyl, sulfonyl, or NR₁₀ wherein R₁₀ is hydrogen or alkyl.

In certain particular embodiments, the invention also provides for a new N-phenyl-1,1,1-trifluoromethanesulfonamide compound of Formula 1a, 1b, and 1c, that is selected from the group of compounds 71-73, 75, 79-85, 88-89, 92, m3-m5, m7 and p3-p5 of Tables 1a-d and/or a pharmaceutical composition that includes a therapeutically effective dosage amount of the compound of one or more compounds 71-73, 75, 79-85, 88-89, 92, m3-m5, m7 and p3-p5, and a pharmaceutically acceptable excipient.

Some compounds that are particularly preferred in the inventive methods, and several new compounds based on Formula 1a 1b, and 1c, are set forth in Tables 1a-d, as follows.

TABLE 1a*

| Cpd | R | R₁ | R₂ | R₃ | R₄ | R₅ | R₆ | R₇ | R₈ | R₉ | X |
|---|---|---|---|---|---|---|---|---|---|---|---|
| 1 | H | H | H | Cl | H | Cl | H | Cl | H | H | O |
| 2 | H | H | H | Cl | H | CF₃ | H | H | H | H | O |
| 3 | H | H | H | Cl | H | H | H | tert- | H | H | O |
| | | | | | | | | Bu | | | |
| 4 | H | H | H | Cl | H | F | H | F | H | H | O |
| 5 | H | H | H | Cl | H | H | H | Cl | H | H | O |
| 6 | H | H | H | Cl | H | Cl | H | H | H | H | O |
| 7 | H | H | H | Cl | H | H | Cl | Cl | H | H | O |
| 8 | H | H | Cl | H | H | Cl | H | Cl | H | H | O |
| 9 | H | H | CF₃ | H | H | H | CF₃ | H | H | H | O |
| 10 | H | H | CF₃ | H | H | Cl | H | Cl | H | H | O |
| 11 | H | H | H | H | Cl | Cl | H | Cl | H | H | O |
| 12 | H | H | H | Cl | H | H | H | Cl | H | H | S |
| 13 | H | H | Cl | Cl | H | Cl | H | Cl | H | H | O |
| 14 | H | H | H | Cl | H | F | H | H | H | H | O |
| 15 | H | H | H | Cl | H | H | Cl | H | H | H | S |
| 16 | H | H | H | Cl | H | H | F | F | H | H | O |
| 17 | H | H | H | Cl | Cl | F | H | H | H | H | O |
| 18 | H | H | Cl | Cl | H | H | H | tert- | H | H | O |
| | | | | | | | | Bu | | | |
| 19 | H | H | Cl | Cl | H | Cl | H | F | H | H | O |
| 20 | H | H | H | Cl | H | H | H | F | H | H | S |
| 21 | H | H | H | Cl | H | Me | H | H | H | H | O |
| 22 | H | H | CF₃ | Cl | H | Cl | H | Cl | H | H | O |
| 23 | H | H | H | Cl | H | H | H | Cl | H | H | sulfinyl |
| 24 | H | H | H | Cl | H | H | H | Cl | H | H | sulfonyl |
| 25 | H | H | H | Cl | H | H | F | H | H | H | O |
| 26 | H | H | H | Cl | H | H | H | F | H | H | O |
| 27 | H | H | H | Cl | H | Me | Me | H | H | H | O |
| 28 | See Table | | | | | | | | | | |
| | 1b, below | | | | | | | | | | |
| 29 | H | H | CF₃ | H | H | H | H | Cl | H | H | O |
| 30 | H | H | CF₃ | H | H | H | H | F | H | H | O |
| 31 | H | H | CF₃ | H | H | H | F | H | H | H | O |
| 32 | H | H | CF₃ | H | H | F | H | H | H | H | O |
| 33 | H | H | CF₃ | H | H | Me | H | H | H | H | O |
| 34 | H | H | CF₃ | H | H | H | Me | H | H | H | O |
| 35 | H | H | CF₃ | H | H | H | H | Me | H | H | O |
| 36 | H | H | CF₃ | H | H | Cl | H | H | H | H | O |
| 37 | H | H | CF₃ | H | H | H | Cl | H | H | H | O |
| 38 | H | H | H | Cl | H | Et | H | H | H | H | O |
| 39 | H | H | H | Cl | H | iso- | H | H | H | H | O |
| | | | | | | Pr | | | | | |
| 40 | H | H | H | Cl | H | H | H | H | H | H | O |
| 41 | H | H | CF₃ | H | H | H | H | H | H | H | O |
| 42 | H | H | H | Cl | H | tert- | H | H | H | H | O |
| | | | | | | Bu | | | | | |
| 43 | H | H | CF₃ | H | H | F | H | F | H | H | O |
| 44 | H | H | CF₃ | H | H | H | F | F | H | H | O |
| 45 | H | H | CF₃ | H | H | H | Cl | H | H | H | S |
| 46 | H | H | CF₃ | H | H | H | H | Cl | H | H | S |
| 47 | H | H | H | Cl | H | H | H | PhO | H | H | O |
| 48 | See Table | | | | | | | | | | |
| | 1b, below | | | | | | | | | | |
| 49 | H | H | H | Cl | H | H | H | MeO | H | H | O |
| 50 | H | H | H | Cl | H | H | CN | H | H | H | O |
| 51 | H | H | H | CN | H | H | H | Cl | H | H | O |
| 52 | H | H | H | CN | H | Cl | H | Cl | H | H | O |
| 53 | H | H | H | CN | H | F | H | H | H | H | O |
| 54 | H | H | H | CN | H | Me | H | H | H | H | O |
| 55 | H | H | H | CF₃ | H | H | CF₃ | H | H | H | O |
| 56 | H | H | H | Cl | H | H | H | CN | H | H | O |
| 57 | H | H | H | CN | H | H | F | F | H | H | O |
| 58 | H | H | H | Cl | H | H | MeO | H | H | H | O |
| 59 | H | H | H | Cl | H | H | H | H | H | H | S |
| 60 | H | H | H | CN | H | H | CF₃ | H | H | H | O |
| 61 | H | H | CF₃ | H | H | H | MeO | H | H | H | O |
| 62 | H | H | H | Cl | H | Cl | H | H | H | H | S |
| 63 | H | H | CF₃ | H | H | H | H | H | H | H | S |
| 64 | H | H | CF₃ | H | H | Cl | H | H | H | H | S |
| 65 | H | H | CF₃ | H | H | H | H | F | H | H | S |
| 66 | H | H | CF₃ | H | H | F | H | H | H | H | S |
| 67 | H | H | CF₃ | H | H | H | H | Br | H | H | S |
| 68 | H | H | H | Cl | H | F | H | H | H | H | S |
| 69 | H | H | H | Cl | H | Cl | H | H | Cl | H | O |
| 70 | Me | H | H | Cl | H | Cl | H | Cl | H | H | O |
| 71 | EtOCH₂ | H | H | Cl | H | Cl | H | Cl | H | H | O |
| 72 | (Me)₃CCO₂CH₂ | H | H | Cl | H | Cl | H | Cl | H | H | O |
| 73 | MeCH₂CH₂CO₂CH₂ | H | H | Cl | H | Cl | H | Cl | H | H | O |
| 74 | H | H | H | Cl | H | Ph | H | H | H | H | O |
| 75 | (Me)₂C═CHC₂ | H | H | Cl | H | Cl | H | Cl | H | H | O |
| 76 | Et | H | H | Cl | H | Cl | H | Cl | H | H | O |
| 77 | Me | H | H | Cl | H | F | H | H | H | H | O |
| 78 | Et | H | H | Cl | H | F | H | H | H | H | O |
| 79 | MeOCH₂ | H | H | Cl | H | F | H | H | H | H | O |
| 80 | EtOCH₂ | H | H | Cl | H | F | H | H | H | H | O |
| 81 | PhCH₂ | H | H | Cl | H | F | H | H | H | H | O |
| 82 | (Me)₂C═CHCH₂ | H | H | Cl | H | F | H | H | H | H | O |
| 83 | 2- | H | H | Cl | H | Cl | H | Cl | H | H | O |
| | Propynyl | | | | | | | | | | |
| 84 | MeOCH₂ | H | H | Cl | H | Cl | H | Cl | H | H | O |
| 85 | 2- | H | H | Cl | H | F | H | H | H | H | O |
| | Propynyl | | | | | | | | | | |
| 86 | iso-Pr | H | H | Cl | H | Cl | H | Cl | H | H | O |
| 87 | iso-Pr | H | H | Cl | H | F | H | H | H | H | O |
| 88 | (Me)₃CCO₂CH₂ | H | H | Cl | H | F | H | H | H | H | O |
| 89 | MeCH₂CH₂CO₂CH₂ | H | H | Cl | H | F | H | H | H | H | O |
| 90 | H | H | H | H | H | H | H | H | H | H | NH |
| 91 | H | H | H | Cl | H | H | H | Cl | H | H | NH |
| 92 | PhCH₂ | H | H | Cl | H | Cl | H | Cl | H | H | O |

*Based on Formula 1a, as set forth above.

TABLE 1b

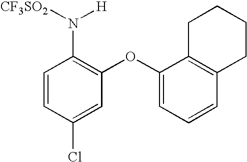

Compound 28

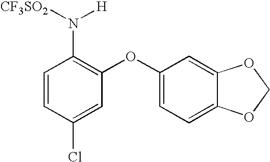

Compound 48

TABLE 1c*

| Cpd | R | R₁ | R₂ | R₃ | R₄ | R₅ | R₆ | R₇ | R₈ | R₉ | X |
|---|---|---|---|---|---|---|---|---|---|---|---|
| m1 | H | H | H | H | H | H | H | H | H | H | O |
| m2 | Me | H | H | H | H | H | H | H | H | H | O |
| m3 | EtOCH₂ | H | H | H | H | H | H | H | H | H | O |
| m4 | MeOCH₂ | H | H | H | H | H | H | H | H | H | O |
| m5 | (Me)₃CO₂CH₂ | H | H | H | H | H | H | H | H | H | O |
| m6 | H | H | H | H | H | Cl | H | Cl | H | H | O |
| m7 | EtOCH₂ | H | H | H | H | Cl | H | Cl | H | H | O |

*Based on Formula 1b, as set forth above.

TABLE 1d*

| Cpd | R | R₁ | R₂ | R₃ | R₄ | R₅ | R₆ | R₇ | R₈ | R₉ | X |
|---|---|---|---|---|---|---|---|---|---|---|---|
| p1 | H | H | H | H | H | H | H | H | H | H | O |
| p2 | Me | H | H | H | H | H | H | H | H | H | O |
| p3 | EtOCH₂ | H | H | H | H | H | H | H | H | H | O |
| p4 | MeOCH₂ | H | H | H | H | H | H | H | H | H | O |
| p5 | (Me)₃CCO₂CH₂ | H | H | H | H | H | H | H | H | H | O |
| p6 | H | CF₃ | H | H | H | Cl | H | Cl | H | H | O |
| p7 | H | H | Cl | H | H | Cl | H | Cl | H | H | O |
| p8 | H | H | F | H | H | Cl | H | Cl | H | H | O |
| p9 | H | H | CF₃ | H | H | Cl | H | Cl | H | H | O |

*Based on Formula 1c, as set forth above.

### Preparation Of The Inventive Compounds

Simply by way of example, and without limitation, the inventive compounds, including those set forth by Tables 1a-1d, above, are prepared using one or more of the reaction schemes and methods described below. Certain of the inventive compounds are also exemplified by the preparative examples provided below, which should not be construed to limit the scope of the disclosure.

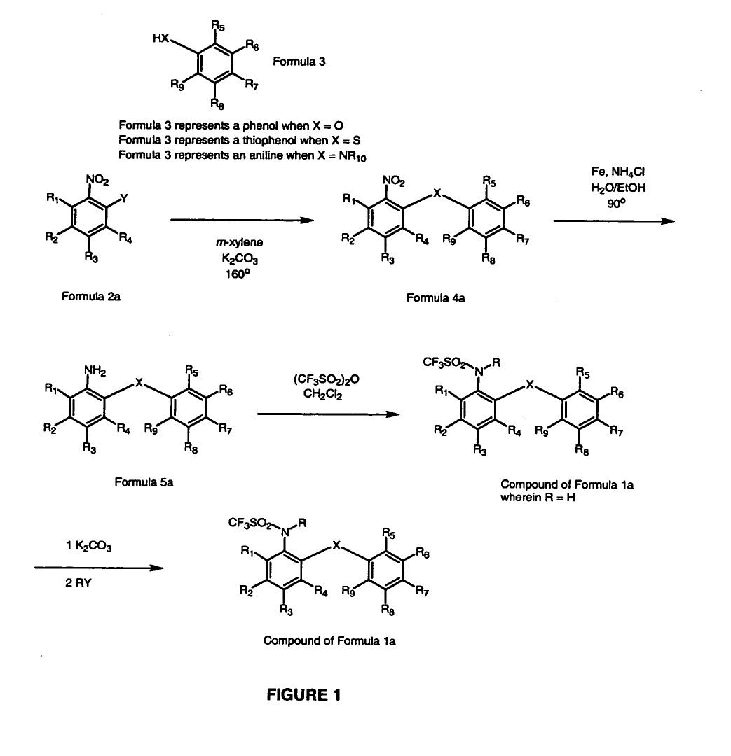

Preferred methods of synthesis of N-phenyl-1,1,1-trifluoromethane-sulfonamide compounds of Formula 1a generally commence from 2-halo-1-nitrobenzene compounds of Formula 2a, wherein Y is fluorine, chlorine, bromine or iodine, as is illustrated in FIG. 1.

Thus, by way of non-limiting example, and with reference to FIG. 1, a nitro compound of Formula 2a, wherein R₁, R₂, R₃ and R₄ are the same as set forth above, and Y is fluorine, chlorine, bromine or iodine, is reacted with a phenol, a thiophenol, or an aniline to afford the corresponding nitro compounds of Formula 4a, wherein X is O, S, or NR₁₀ respectively, as follows:

(i) a phenol compound of Formula 3, wherein R₅, R₆, R₇, R₈ and R₉ are the same as set forth above, and X is O, and the reaction is conducted using the procedure of Tsuji et al. [Chem. Pharm. Bull., 40, 9, 2399-2409 (1992), hereby incorporated by reference]; or

(ii) a thiophenol compound of Formula 3, and the reaction is conducted using the procedure of Tsuji et al. Id. (modified by the use of thiophenol), wherein R₅, R₆, R₇, R₈ and R₉ are the same as set forth above, and X is S; or

(iii) an aniline compound of Formula 3, and the reaction is conducted using a modification of the procedure of Kottenham et al. [J Org. Chem., 28, 3114-3120 (1963) hereby incorporated by reference], wherein R₅, R₆, R₇, R₈ and R₉ are the same as set forth above, and X is NR₁₀, and wherein R₁₀ is hydrogen or alkyl.

Reactions of compounds such as Formula 2a, 2b and 2c with phenols, thiophenols and anilines of Formula 3 are typically carried out in solvents, by way of non limiting example, xylenes or toluene.

Another preferred method of preparing compounds of Formula 1a, wherein X is NR₁₀, and wherein R₁₀ is H or alkyl, commences from 1,2-dinitrobenzene compounds of Formula 2, wherein Y is a nitro group, as is shown in FIG. 1. Thus, in a non-limiting example, and with reference to FIG. 1, a dinitro compound of Formula 2a is reacted with an aniline compound of Formula 3 using a modification of the procedure of Abramovitch and Davis [J Chem. Soc. C.,119-126, (1968), hereby incorporated by reference] to afford a nitro compound of Formula 4, wherein X is NR₁₀, and R₁₀ is H or alkyl; wherein R₁, R₂, R₃, and R₄ are the same as set forth above, Y is a nitro group, and R₅, R₆, R₇, R₈, and R₉ are the same as set forth above.

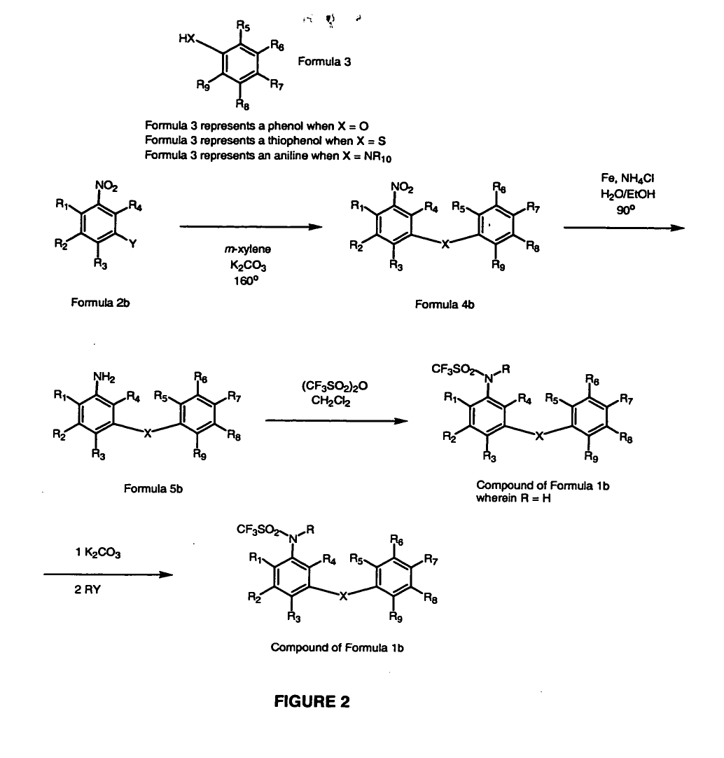

Preferred methods of synthesis of N-phenyl-1,1,1-trifluoromethane-sulfonamide compounds of Formula 1b generally commence from 3-halo-1-nitrobenzene compounds of Formula 2b, wherein Y is fluorine, chlorine, bromine or iodine, are as shown in FIG. 2.

Thus, by way of non-limiting example, and with reference to FIG. 2, a nitro compound of the Formula 2b, wherein R₁, R₂, R₃, and R₄ are the same as set forth above, and Y is fluorine, chlorine, bromine or iodine, is reacted with a phenol, a thiophenol, or an aniline to afford the corresponding nitro compounds of Formula 4b, wherein X is O, S, or NR₁₀ respectively, as follows:

(i) a phenol compound of Formula 3, wherein R₅, R₆, R₇, R₈, and R₉ are the same as set forth above and X is O, and the reaction is carried out in N,N-dimethylformamide (“DMF”) at 200° C. in the presence of potassium carbonate and CuCl, as is described in Example 10, below.

(ii) a thiophenol compound of Formula 3, and the reaction is conducted using the procedure of Tsuji et al., [Chem. Pharm. Bull., 40, 9, 2399-2409 (1992), hereby incorporated by reference] (modified by the use of thiophenol), wherein R₅, R₆, R₇, R₈ and R₉ are the same as set forth above, and X is S; or

(iii) an aniline compound of Formula 3, and the reaction is conducted using a modification of the procedure of Kottenham et al. [J Org. Chem., 28, 3114-3120 (1963), hereby incorporated by reference], wherein R₅, R₆, R₇, R₈ and R₉ are the same as set forth above and when X is NR₁₀, and R₁₀ is H or alkyl.

An alternative method of preparation of a compound of Formula 4b, wherein X is NR₁₀, involves the reaction of a compound of Formula 2b, wherein Y is fluorine, chlorine, bromine or iodine, with an acetanilide derivative of Formula 3 (wherein the substituent HX is replaced by CH₃CONR¹⁰) as described by Moore et al.,[J. Med. Chem., 18, 386-391 (1975), hereby incorporated by reference].

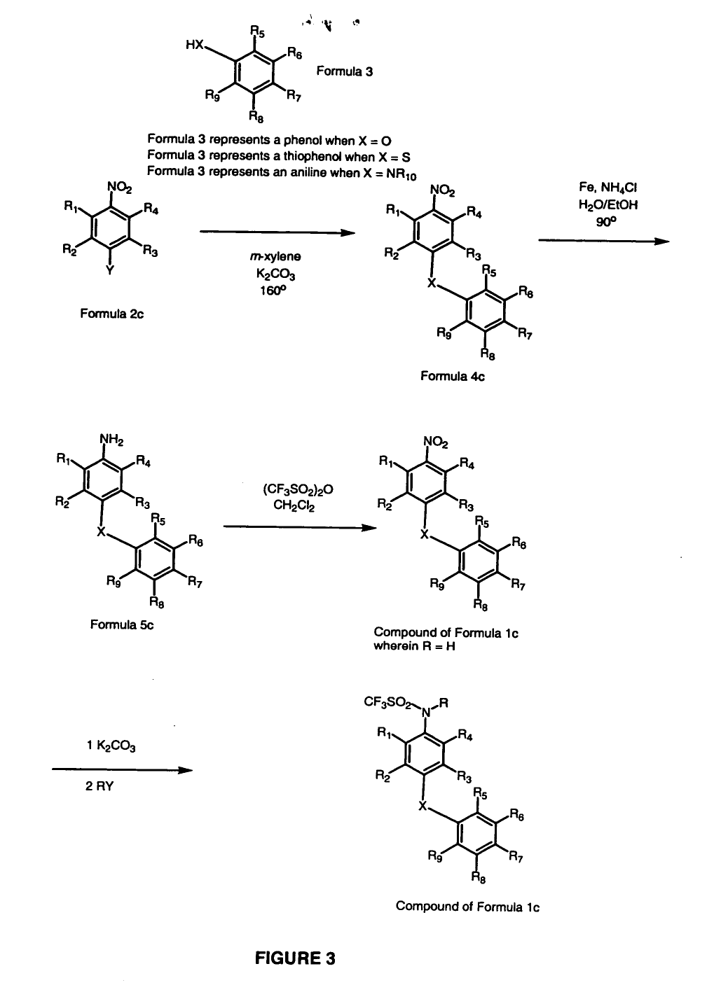

Preferred methods of synthesis of N-phenyl-1,1,1-trifluoromethane-sulfonamide compounds of Formula 1c generally commence from 4-halo-1-nitrobenzene compounds of Formula 2c, wherein Y is fluorine, chlorine, bromine or iodine, as illustrated by FIG. 3.

Thus, by way of non-limiting example, and with reference to FIG. 3, a nitro compound of the Formula 2c, wherein R₁, R₂, R₃ and R₄ are the same as set forth above and Y is fluorine, chlorine, bromine or iodine is reacted with a phenol, a thiophenol, or an aniline to afford the corresponding nitro compounds of Formula 4c, wherein X is O, S, or NR₁₀ respectively, as follows:

(i) a phenol compound of Formula 3 (wherein R₅, R₆, R₇, R₈ and R₉ are the same as set forth above and X is O), and the reaction is conducted using the procedure of Tsuji et al., [Chem. Pharm. Bull., 40, 9, 2399-2409 (1992), hereby incorporated by reference]; or

(ii) a thiophenol compound of Formula 3, and the reaction is conducted using the procedure of Tsuji et al., [Chem. Pharm. Bull., 40, 9, 2399-2409 (1992), hereby incorporated by reference] (modified by the use of thiophenol), wherein R₅, R₆, R₇, R₈ and R₉ are the same as set forth above and X is S; or

(iii) an aniline compound of Formula 3 using a modification of the procedure of Kottenham et al. [J Org. Chem., 28, 3114-3120 (1963), hereby incorporated by reference] wherein R₅, R₆, R₇, R₈ and R₉ are the same as set forth above and X is NR₁₀, wherein R₁₀ is H or alkyl.

Reduction of the nitro group in the compounds of Formula 4a, 4b, and 4c (wherein X is O, S or NR¹⁰) is preferentially achieved with iron powder in the presence of an acid, such as NH₄Cl using the method of Tsuji et al., [Chem. Pharm. Bull., 40, 9, 2399-2409 (1992), hereby incorporated by reference], or alternatively, with PtO₂/H₂ using the general method by Leonard, et al., [J. Org. Chem., 11, 405-418, (1946), hereby incorporated by reference] to afford the corresponding amine derivatives of Formula 5a, 5b, and 5c. Compounds of Formula 5a, 5b, and 5c are dissolved in a solvent such as dichloromethane and treated with trifluoromethanesulfonic anhydride (using a modification of the procedure by Harrington et al.,[J. Med. Chem., 13, 137 (1970), hereby incorporated by reference] to yield trifluoromethanesulfonamide compounds of Formulas 1a, 1b, and 1c, wherein R=H and X is O, S or NR¹⁰.

A preferred method of preparing compounds of Formula 1a, 1b, and 1c wherein X is sulfinyl involves the reaction of the corresponding N-[(phenylsulfanyl)phenyl]-1,1,1,-trifluoromethanesulfonamide of Formula 1a, 1b, and 1c (wherein X is S) with sodium periodate [Moore et al., Journal of Medicinal Chemistry, 18, 386-391 (1975), hereby incorporated by reference] or with aqueous hydrogen peroxide in acetone at −6° C. [U.S. Pat. No. 4,005,141, hereby incorporated by reference].

A preferred method of preparing compounds of Formula 1a, 1b, and 1c, wherein X is sulfonyl involves the reaction of the corresponding N-[(phenylsulfanyl)phenyl]-1,1,1-trifluoromethanesulfonamide of Formula 1a, 1b, and 1c (wherein X is S) with aqueous hydrogen peroxide in acetic acid [U.S. Pat. No. 4,005,141, hereby incorporated by reference].

A preferred method of preparing compounds of Formula 1a, 1b, and 1c, wherein R is other than hydrogen, involves the reaction of a compound of Formula 1a, 1b, and 1c wherein R is H, with a base, e.g., potassium carbonate, followed by reaction with an electrophilic reagent RY, wherein R is as defined above, and Y is a leaving group such as chloride, bromide, iodide or an alkylsulfonate or arylsulfonate. By way of non-limiting examples the base may be an inorganic base such as potassium carbonate or an organic base such as triethylamine. For example, reaction of a compound of Formula 1a, 1b, and 1c wherein R is H with alkoxymethyl chloride in the presence of potassium carbonate affords the corresponding compound of Formula 1a, 1b, and 1c wherein R is alkoxymethyl; and reaction of a compound of Formula 1a, 1b, and 1c wherein R is H with alkoxycarbonylalkyl chloride in the presence of potassium carbonate affords the corresponding compound of Formula 1a, 1b, and 1c, wherein R is alkoxycarbonylalkyl.

Reacting a compound of Formula 1a, 1b and 1c, wherein R is H,

(i) with acyl chlorides in the presence of a base, such as triethylamine, in methylene chloride affords the corresponding compound of formula 1a, 1b and 1c wherein R is aroyl (according to the method of Hendrickson, J. B., Bergeron, R., Giga, A., Sternbach, D., Journal of the American Chemical Society, 1973, 95, 3412-3413, incorporated by reference herein).

(ii) with alkylchloroformates affords the corresponding compound of formula 1a, 1b and 1c, wherein R is alkoxycarbonyl (according to the method of DE 2,118,190, incorporated by reference herein).

(iii) with arylisocyanates or arylisothiocyanates in the presence of either aqueous sodium hydroxide and acetone or triethylamine in toluene affords the corresponding compounds of formula 1a, 1b and 1c wherein R is N-arylcarbamoyl or N-arylthiocarbamoyl (according to the method of Howbert, et al., Journal of Medicinal Chemistry, 1990, 33, 2393-2407, incorporated by reference herein).

### Animals To Be Treated

The present invention provides methods for the prevention and/or treatment of infestation, diseases and/or related disorders caused by, and/or as a result of, parasites and/or other pests that are killed or inhibited (e.g., growth-suppressed) by the N-phenyl-1,1,1-trifluoromethanesulfonamide compound of Formula 1a, 1b, and 1c identified herein. The animal is preferably a vertebrate, and more preferably a mammal, avian or fish. Any of the N-phenyl-1,1,1-trifluoromethanesulfonamide compounds of Formula 1a, 1b and 1c identified herein, or a suitable combination of such compounds, may be administered directly to the animal subject and/or indirectly by applying it to the local environment in which the animal dwells (such as bedding, enclosures, or the like). Direct administration includes contacting the skin, fur or feathers of a subject animal with the compounds, or by feeding or injecting the compounds into the animal. Appropriate animal subjects include those in the wild, livestock (e.g., raised for meat, milk, butter, eggs, fur, leather, feathers and/or wool), beasts of burden, research animals, companion animals, as well as those raised for/in zoos, wild habitats and/or circuses.

In a particular embodiment, the animal subject is a mammal (including great apes, such as humans). Other mammalian subjects include primates (e.g., monkeys), bovine (e.g., cattle or dairy cows), porcine (e.g., hogs or pigs), ovine (e.g., goats or sheep), equine (e.g., horses), canine (e.g., dogs), feline (e.g., house cats), camels, deer, antelopes, rabbits, and rodents (e.g., guinea pigs, squirrels, rats, mice, gerbils, and hamsters). Avians include Anatidae (e.g., swans, ducks and geese), Columbidae (e.g., doves and pigeons), Phasianidae (e.g., partridges, grouse and turkeys) Thesienidae (e.g., domestic chickens), Psittacines (e.g., parakeets, macaws, and parrots), game birds, and ratites, (e.g., ostriches).

Birds treated or protected by the inventive compounds can be associated with either commercial or noncommercial aviculture. These include e.g., Anatidae, such as swans, geese, and ducks, Columbidae, e.g., doves and pigeons, such as domestic pigeons, Phasianidae, e.g., partridge, grouse and turkeys, Thesienidae, e.g., domestic chickens, Psittacines, e.g., parakeets, macaws, and parrots, e.g., raised for the pet or collector market, among others.

For purposes of the present invention, the term “fish” shall be understood to include without limitation, the Teleosti grouping of fish, i.e., teleosts. Both the Salmoniformes order (which includes the Salmonidae family) and the Perciformes order (which includes the Centrarchidae family) are contained within the Teleosti grouping. Examples of potential fish recipients include the Salmonidae family, the Serranidae family, the Sparidae family, the Cichlidae family, the Centrarchidae family, the three-Line Grunt (Parapristipoma trilineatum), and the Blue-Eyed Plecostomus (Plecostomus spp), among others.

Other animals are also contemplated to benefit from the inventive methods, including marsupials (such as kangaroos), reptiles (such as farmed turtles), crustaceans (such as lobsters, crabs, shrimp and prawns) and other economically important domestic animals for which the inventive methods are safe and/or effective in treating and/or preventing parasite infection or infestation.

### Crops and Crop Pests To Be Treated

The inventive methods are also contemplated to be employed in protecting against agricultural pests that attack plants by application of the N-phenyl-1,1,1-trifluoromethanesulfonamide compounds of Formula 1a, 1b, and 1c identified herein. In particular, plants to be protected or treated include crops of economic or other importance, i.e., in agriculture and related endeavors. Agricultural pests contemplated to be controlled by the inventive methods include, for example, insect pests, including those that can attack stored grains e.g., Tribolium sp., Tenebrio sp. Other agricultural pests include spider mites, (Tetranychus sp.), aphids, Acyrthiosiphon sp.; migratory orthopterans such as locusts, and the immature stages of insects that live on plant tissue such as the Southern army worm and Mexican bean beetle larvae.

Further pests of agricultural importance that are contemplated to be treated or controlled by the inventive methods include, e.g., Acrobasis vaccinii, Agrotis spp, Alsophila pometaria, Archips spp, Argyrotaenia citrana, A velutinana, Autographa californica, Bacillus thuringiensis, Callopistria floridensis, Choristoneura fumiferana, C. occidentalis, C. pinus, C. rosaceana, Cryptophlebia ombrodelta, Cydia (Laspeyresia) pomonella, C. caryana, Dasychira pinicola, Datana ministra, Desmia funeralis, Diatrea saccharalis, Dichocrocis punctiferalis, Dioryctria Zimmerman, Ectropis excursaria, Ematurga amitaria, Ennomos subsignaria, Eoreuma loftini, Epiphyas postvittana, Euproctis chrysorrhoea, Grapholita packardi, Hellula rogatalis, Homoeosoma vagella, Hyphantria cunea, Lambdina fiscellaria, Liphophane antennata, Lobesia botrana, Lophocampa maculata, Lymantria dispar, Malacosoma spp, Manduca spp, Megalopyge opercularis, Mnesampela privata, Orgyia pseudotsugata, O. vetusta, Ostrinia nubilalis, Platynota flavedana, P. stultana, Pseudaletia unipuncta, Rhopobota naevana, Rhyacionia spp, Spodoptera eridania, S. exigua, S. frugiperda, S. ornithogalli, Thaumatopoea pityocampa, Thridopteryx ephemeraeformis, Thyrinzeina arnobia, and others too numerous to mention.

Crops that can be treated in order to kill, remove and/or prevent infestation with crop-related pests include, broadly, crops for producing fruits, vegetables, grains and other grasses, flowers and orchids, trees, including both fruit trees and trees for lumber production, hedges, and other protective or ornamental plants. In particular, crops to be treated or protected include, but are not limited to, e.g., alfalfa, apples, avocados, blueberries, brassicas, breadfruit, brocolli, bush berries, cabbage, cane berries, cherry, citrus, citrus oil, clover, cole crops, cotton, cucumber, cranberries, currants, apples, eucalyptus, forestry, beet roots and tops, grapes, grapefruit, gooseberries, hay, huckleberries, kiwi fruit, leafy and fruiting vegetables, legumes, lemon, lime, macadamia nuts, mint, orange, ornamentals, peaches, pears, pecans, peppers, plums, pome fruit, potatoes, raspberry, shrubs, soy, starfruit, sugarcane, sunflower, squash, table beets, tangerine, treenuts, trees, turnips, walnuts, the various grain grasses, including corn or maize, wheat, rye, rice, oats, barley, spelt and millet.

Susceptible Parasites

The N-phenyl-1,1,1-trifluoromethanesulfonamide compounds of Formula 1a, 1b, and 1 c identified herein as useful in practicing the inventive methods are broadly described as endectoparasiticides, and include compounds that are active against ectoparasites (arthropods, acarines, etc.) and endoparasites (helminths, e.g., nematodes, trematodes, cestodes, canthocephalans, etc.), including pests that prey on agricultural crops and stored grains (spider mites, aphids, caterpillars, migratory orthopterans such as locusts). Parasitical protozoa (Flagellata, Sarcodina Ciliophora, and Sporozoa, etc.) are also contemplated to be treated by the inventive compounds. The N-phenyl-1,1,1-trifluoromethanesulfonamide compounds of Formula 1a, 1b, and 1c identified herein are also active against household pests, and particularly against arthropod pests, such as spiders, mites, and insects, including flies, mosquitoes, ants, termites, silverfish, cockroach, clothes moth, and a myriad of beetles and beetle larvae that impact households. Susceptible parasites are listed in greater detail in the following sections.

1. Helminths

The disease or group of diseases described generally as helminthiasis is due to infection of an animal host with parasitic worms known as helminths. Helminthiasis is a prevalent and serious economic problem with domesticated animals such as swine, sheep, horses, cattle, goats, dogs, cats and poultry. Among the helminths, the group of worms described as nematodes causes widespread and at times serious infection in various species of animals. Nematodes that are contemplated to be treated by the N-phenyl-1,1,1-trifluoromethanesulfonamide compounds of Formula 1a, 1b, and 1c identified herein and by the inventive methods include, without limitation, the following genera:

Acanthocheilonema, Aelurostrongylus, Ancylostoma, Angiostrongylus, Ascaridia, Ascaris, Brugia, Bunostomum, Capillaria, Chabertia, Cooperia, Crenosoma, Dictyocaulus, Dioctophyme, Dipetalonema, Diphyllobothrium, Diplydium, Dirofilaria, Dracunculus, Enterobius, Fluorides, Haemonchus, Heterakis, Lagochilascaris, Loa, Mansonella, Muellerius, Nanophyetus, Necator, Nematodirus, Oesophagostomum, Opisthorchis, Ostertagia, Oxyuris, Parafilaria, Paragonimus, Parascaris, Physaloptera, Protostrongylus, Setaria, Spirocerca, Spirometra, Stephanofilaria, Strongyloides, Strongylus, Thelazia, Toxascaris, Toxocara, Trichinella, Trichonema, Trichostrongylus, Trichuris, Uncinaria, and Wuchereria.

Of the above, the most common genera of nematodes infecting the animals referred to above are Haemonchus, Trichostrongylus, Ostertagia, Nemaodirus, Cooperia, Ascaris, Bunostomum, Oesophagostomum, Chabertia, Trichuris, Strongylus, Trichonema, Dictyocaulus, Capillaria, Heterakis, Toxocara, Ascaridia, Oxyuris, Ancylostoma, Unicinaria, Toxascaris and Parascaris. Certain of these, such as Nematodirus, Cooperia and Oesophagostomum attack primarily the intestinal tract while others, such as Haemonchus and Ostertagia, are more prevalent in the stomach while others such as Dictyocaulus are found in the lungs. Still other parasites may be located in other tissues such as the heart and blood vessels, subcutaneous and lymphatic tissue and the like. Table 2, below, lists a number of these, by Family and Genus, that are of economic (medical and veterinary) importance.

TABLE 2

| Class | Family | Genus (examples) |
|---|---|---|
| Trematoda | Fasciolidae | Fasciola |
| Cestoda | Anoplocephalidae | Moniezia |
| ″ | Dilepididae | Dipylidium |
| ″ | Taeniidae | Taenia, Echinococcus |
| Nematoda | Strongyloididae | Stongyloides |
| ″ | Strongylidae | Strongylus, |
| | | Oesophagostomum |
| ″ | Syngamidae | Syngamus |
| ″ | Trichostrongylidae | Trichostrongylus, |
| | | Cooperia, |
| | | Ostertagia, Haemonchus |
| ″ | Heligmonellidae | Nippostrongylus |
| ″ | Dictyocaulidae | Dictyocaulus |
| ″ | Ascarididae | Ascaris |
| ″ | Toxocaridae | Toxacara |
| ″ | Oxyuridae | Oxyuris |
| ″ | Filaridae | Parafilaria |
| ″ | Onchocercidae | Onchocerca |
| ″ | Trichinellidae | Trichinella |
| ″ | Trichuridae | Trichuris |
| ″ | Capillariidae | Capillaria |

The most common genera of parasites of the gastrointestinal tract of humans are Ancylostoma, Necator, Ascaris, Strongyloides, Trichinella, Capillaria, Trichuris, and Enterobius. Other medically important genera of parasites which are found in the blood or other tissues and organs outside the gastrointestinal tract are the filarial worms such as Wuchereria, Brugia, Onchocerca and Loa, Dracunculus and extra intestinal stages of the intestinal worms Strongyloides and Trichinella.

Numerous other helminth genera and species are known to the art, and are also contemplated to be treated by the compounds of the invention. These are enumerated in great detail in TEXTBOOK OF VETERINARY CLINICAL PARASITOLOGY, VOLUME 1, HELMINTHS, by E. J .L. Soulsby, Publ. F. A. Davis Co., Philadelphia, Pennsylvania; HELMINTHS, ARTHROPODS AND PROTOZOA (Sixth Ed. of MONNIG'S VETERINARY HELMINTHOLOGY AND ENTOMOLOGY) by E. J. L. Soulsby, Publ. The Williams and Wilkins Co., Baltimore, Md., the contents of both of which are hereby incorporated by reference in their entireties.

The parasitic infections known as helminthiasis lead to anemia, malnutrition, weakness, weight loss, severe damage to the walls of the intestinal tract and other tissues and organs and, if left untreated, may result in death of the infected host. The compounds described herein have unexpectedly high activity against these parasites, and in addition are also active against Dirofilaria in dogs, and Namatospiroides, Syphacia, Aspiculuris in rodents. The inventive compounds are also useful as a nematocide for the control of soil nematodes and plant parasites such as Meloidogyne spp.

2. Arthropods

It is also contemplated that the inventive compounds are effective against a number of ectoparasites of animals, e.g., arthropod ectoparasites of mammals and birds. Arthropods include those summarized in Table 3, as follows.

TABLE 3
Summary Of Taxonomy for
Important Arthropod Pests

| Subphylum | Class | Order | Examples |
|---|---|---|---|
| Trilobita | | | |
| Cheliceratac | | | |
| helicera and | | | |
| pedipalps | | | |
| | Merostomata | | |
| | Arachnida | | |
| | | Araneae | spiders |
| | | Scorpionida | scorpions |
| | | Acari | mites and |
| | | | ticks |
| Uniramia | | | |
| | Chilopoda | | centipedes |
| | Diplopoda | | millipedes |
| | Pauropoda | | Soft bodied |
| | | | myriapods |
| | Insecta | | |
| | | Hymenoptera | bees, wasps |
| | | Lepidoptera | moths, |
| | | | butterflies |
| | | Hoptera | grasshoppers |
| | | Diptera | true flies |
| | | Hemiptera | true bugs |
| | | Coleoptera | beetles |

Thus, insect pests include, e.g., biting insects, such as flies and mosquitoes, mites, ticks, lice, fleas, true bugs, parasitic maggots, and the like.

Biting insects include, e.g., migrating diperous larvae as Hypoderma sp. in cattle, Gastrophilus in horses, and Cuterebra sp. in rodents, as well as biting flies and mosquitoes of all types. For example, bloodsucking adult flies include, e.g., the horn fly or Haematobia irritans, the horse fly or Tabanus spp., the stable fly or Stomoxys calcitrans, the black fly or Simulium spp., the deer fly or Chrysops spp., the louse fly or Melophagus ovinus, the tsetse fly or lossina spp. Parasitic fly maggots include, e.g., the bot fly (Oestrus ovis and Cuterebra spp.), the blow fly or Phaenicia spp., the screwworm or Cochliomyia hominivorax, the cattle grub or Hypoderma spp., and the fleeceworm. Mosquitoes, include, for example, Culex spp., Anopheles spp., and Aedes spp.

Mites include Mesostigmata spp. e.g., mesostigmatids such as the chicken mite, Dermanyssus gallinae; itch or scab mites such as Sarcoptidae spp. for example, Sarcoptes scabiei; mange mites such as Psoroptidae spp. including Chorioptes bovis and Psoroptes ovis; chiggers e.g., Trombiculidae spp. for example the North American chigger, Trombicula alfreddugesi.

Ticks include, e.g., soft-bodied ticks including Argasidae spp. for example Argas spp. and Ornithodoros spp.; hard-bodied ticks including Ixodidae spp., for example Rhipicephalus sanguineus, and Boophilus spp.

Lice include, e.g., sucking lice, e.g., Menopon spp. and Bovicola spp.; biting lice, e.g., Haematopinus spp., Linognathus spp. and Solenopotes spp.

Fleas include, e.g., Ctenocephalides spp., such as dog flea (Ctenocephalides canis) and cat flea (Ctenocephalides felis); Xenopsylla spp. such as oriental rat flea (Xenopsylla cheopis); and Pulex spp. such as human flea (Pulex irritans).

True bugs include, e.g., Cimicidae or e.g., the common bed bug (Cimex lectularius); Triatominae spp. including triatomid bugs also known as kissing bugs; for example Rhodnius prolixus and Triatoma spp.

Generally, flies, fleas, lice, mosquitoes, gnats, mites, ticks and helminths cause tremendous losses to the livestock and companion animal sectors. Arthropod parasites also are a nuisance to humans and can vector disease-causing organisms in humans and animals.

Numerous other arthropod pests and ectoparasites are known to the art, and are also contemplated to be treated by the compounds of the invention. These are enumerated in great detail in MEDICAL AND VETERINARY ENTOMOLOGY, by D. S. Keftle, Publ. John Wiley & Sons, New York and Toronto; CONTROL OF ARTHROPOD PESTS OF LIVESTOCK: A REVIEW OF TECHNOLOGY, by R. O. Drummand, J. E. George, and S. E. Kunz, Publ. CRC Press, Boca Raton, Fla., the contents of both of which are hereby incorporated by reference in their entireties.

3. Protozoa

It is also contemplated that the N-phenyl-1,1,1-trifluoromethanesulfonamide compounds of Formula 1a, 1b, and 1c identified herein, and the inventive methods, are effective against a number of protozoa endoparasites of animals, including those summarized by Table 4, as follows.

TABLE 4
Exemplary Parasitic Protozoa and Associated Human Diseases

| | | | Human Disease or |
|---|---|---|---|
| Phylum | Subphylum | Representative Genera | Disorder |
| Sarcomastigophora | Mastigophora | Leishmania | Visceral, cutaneous |
| (with flagella, | (Flagella) | | and mucocutaneous |
| pseudopodia, | | | Infection |
| or both) | | | |
| | | Trypansoma | Sleeping sickness |
| | | | Chagas' disease |
| | | Giardia | Diarrhea |
| | | Trichomonas | Vaginitis |
| | Sarcodina | Entamoeba | Dysentery, liver |
| | (pseudopodia) | | Abscess |
| | | Dientamoeba | Colitis |
| | | Naegleria and | Central nervous system and |
| | | Acanthamoeba | corneal ulcers |
| | | Babesia | Babesiesis |
| Apicomplexa | | Plasmodium | Malaria |
| (apical complex) | | Isospora | Diarrhea |
| | | Sarcocystis | Diarrhea |
| | | Cryptosporidum | Diarrhea |
| | | Toxoplasma | Toxoplasmosis |
| Microspora | | Enterocytozoon | Diarrhea |
| Ciliephora | | Balantidium | Dysentery |
| (with cilia) | | | |
| Unclassified | | Pneumocystis | Pneumonia |

4. Animal Pests, Generally

Livestock pests to be controlled by the N-phenyl-1,1,1-trifluoromethanesulfonamide compounds of Formula 1a, 1b, and 1c identified herein and the inventive methods include parasites identified above as helminths, arthropods and protozoa. In addition, and simply by way of example, a number of agricultural arthropod pests are summarized by Table 5, below, in association with exemplary livestock for which these pests are of economic significance.

TABLE 5

| | |
|---|---|
| Companion animals, | Flies, fleas, ticks, mites. |
| e.g., canine, feline. | |
| Horses and other | Horse bots. |
| equines. | Horse flies and Deer flies. |
| Cattle | Horn flies, Face flies, Pinkeye and lice. |
| Sheep | Sheep keds (biting flies). |
| Poultry | Lesser Mealworms or Litter beetles. |
| General Pests | Rat-tailed maggots. |
| | Moth flies. |
| | Ants, including Allegheny mound ants. |

5. Crop Pests

Simply by way of example, a number of agricultural crop pests to be controlled by the N-phenyl-1,1,1-trifluoromethanesulfonamide compounds of Formula 1a, 1b, and 1c identified herein, and the inventive methods, are summarized by Table 6, in association with exemplary crops for which these pests are of economic significance.

TABLE 6

| Crop | Parasite or Pest |
|---|---|
| Alfalfa | Blister beetles, |
| | generally |
| | Clover Root curculio |
| | Potato leafhoppers |
| Corn | Armyworms |
| | Corn borers, e.g, the |
| | Common Stalk borer |
| | and the European |
| | Corn borer |
| | Corn Leaf aphid |
| | Cutworm |
| | Lesser Cornstalk |
| | borer |
| | Seedcorn Maggots |
| | Southwestern Corn |
| | Borer |
| | Stink bugs |
| | Wireworms |
| Soybeans | Beetles, such as the |
| | Japanese and the |
| | Bean Leaf beetles |
| | Cutworms |
| | Green cloverworm |
| | Seedcorn maggot |
| | Soybean podworm |
| Small | Aphids and Barley |
| Grains | Yellow Dwarf |
| | Armyworms |
| | generally, e.g., in |
| | small grains. |
| | Cereal Leaf beetle |
| | Hessian fly |
| | Wheat Streak Mosaic |
| | virus and the Wheat |
| | Curl mite |
| Stored | Beetles, such as the |
| Grain | Cadelle beetle and |
| | Flour beetle |
| | Indianmeal moth |
| | Lesser Grain borer |
| Greenhouse | Cyclamen Mites |
| Plants | Float Plant pests, |
| | generally |
| | Springtails |
| General | Aphids |
| Crop Pests | Beet armyworm |
| | Garden fleahopper |
| | Grasshopper, e.g., |
| | redlegged, the two- |
| | striped, and the |
| | differential |
| | grasshopper. |
| | Japanese beetles |
| | Seed maggots |
| | Two-Spotted Spider |
| | mites |
| | Whiteflies |
| Potatoes | Colorado Potato |
| | beetle |
| Peppers | Beet Armyworm |
| | European Corn borer |
| | Pepper Maggot |
| Other | Cabbage Webworm |
| Vegetables | Cabbage insects, |
| | generally |
| | Squash Vine Borer |
| | and Squash Bug |
| Greenhouse | Float Plant pests, |
| | generally |
| | Cyclamen mites |
| | (e.g., in a |
| | Greenhouse) |
| Tree Fruits | Cherry Fruit flies |
| | Codling moth |
| | European Red mite |
| | Green fruitworms |
| | Leafhoppers |
| | (e.g, on Apples) |
| | Leaf rollers |
| | Oriental Fruit moth |
| | Peachtree borer |
| | Rosy Apple aphid |
| | San Jose scale |
| | Woolly Apple aphid |
| | Lesser Peachtree |
| | borer |
| | Plum vurculio |
| Nuts | Nut weevils |
| | Pecan Insects |
| Grapes | Grape Berry moth |
| | Grape Cane |
| | Gallmaker |
| | Grape Cane Girdler |
| | Grape Flea beetle |
| | Grape Insects, |
| | generally |
| | phylloxera, e.g., on |
| | grapes |
| | Grape Root borer |
| Berries | Rednecked and |
| | Raspberry Cane |
| | Borers |
| | Root weevils |

6. Household Pests

The inventive compounds are also contemplated to be active against household pests such as the cockroach, Blatella sp., clothes moth, Tineola sp., carpet beetle, Attagenus sp., and the housefly, Musca domestics. In particular, susceptible household pests include those that cause sanitary or economic problems in association with residential and office space and materials, as follows.
Ants, including Carpenter ants (Camponotus spp), Pavement ants (Tetramorium caespitum), Pharaoh ants (Monomorium pharaonis), Thief ants (Solenopsis molesta), Yellow ants (Acanthomyops spp.), Red ants;
Bed Bugs (Cimex spp.);
Beetles, e.g., Carpet (Attagenus spp.), Longhorned, Flour (Tribolium spp.), Drugstore (Stegobium paniceum), Elm Leaf, Ladybird (Harmonia axyridis);
Old House Borer and Flatheaded Wood Borer, Family Buprestidae., to name but a few;
Boxelder Bug (Boisea trivittata);
Carpenter bees;
Centipedes (Scutigera coleopterata);
Cockroaches, including, e.g., the American cockroach (Periplaneta americana), German cockroach (Blattella germanica), Brownbanded cockroach (Supella longipalpa), Oriental Cockroach (Blatta orientalis), to name but a few.
Earwigs (Forficula sp.);
Field crickets;
Flies, including Cluster flies, Pollenia rudis; fruit flies, Moth flies, Psychoda spp. gnats, including, e.g., the Fungus gnat, Sciara spp. Phorids, Family Phoridae
Millipede (Looceles reclusa);
Mites, e.g., Clover mites;
Mosquitoes, e.g., Culex spp., Anopheles spp., Aedes spp.;

Moths, including Clothes (Tineola sp., Tinea sp.); and Indian Meal (Plodia interpunctella);
Psocids (Liposcellis sp.);
Silverfish (Lepisma saccharina);
Sowbugs;
Spiders, including, e.g., the Black Widow, (Lactrodectus spp.), and the Orb Weaver;
Springtails, Order Collembola
Ticks, e.g., the American Dog tick, the Lone Star tick (Amblyomma americanium); and
Wasps, such as the Yellowjacket (Dolichovespula spp. and Vespula spp.).

We exclude from contemplated use, against insects that feed on keratin compounds, compounds disclosed in U.S. Pat. No. 4,664,673.

### Treating And Inhibiting Parasite Infestation Of Animals

It will be understood by the artisan that the methods of the present invention are useful in treating diseases and disorders that are known to be associated with the presence of helminths, cestodes, trematodes, and protozoa, including for example, those listed above, that are present in the tissue or body fluids of animals.

For such infections or infestations, systemic administration is preferred, e.g., administration of the N-phenyl-1,1,1-trifluoromethanesulfonamide compounds of Formula 1a, 1b, and 1c identified herein, by a route selected from the oral or rectal route, a parenteral route, e.g., by intraruminal, intramuscular, intravenous, intratracheal, subcutaneous injection or other type of injection or infusion. A N-phenyl-1,1,1-trifluoromethanesulfonamide compound of Formula 1a, 1b, and 1c or suitable mixture of such compounds is optionally administered in the form of a pharmaceutically acceptable oral or parenteral composition, or in the feed or water or other liquid composition, as discussed in greater detail, below.

Generally, good results are obtained with a N-phenyl-1,1,1-trifluoromethanesulfonamide compound of Formula 1a, 1b, and 1c as identified herein by the systemic administration of up to about 100 mg per kg of animal body weight. In particular, good results are obtained by the systemic administration of from about 0.001 to 100 mg per kg of animal body weight, or more particularly, from about 0.01 to about 25 mg per kg of animal body weight, such total dose being given at one time or in divided doses over a relatively short period of time such as 1-5 days. With the disclosed inventive compound, excellent control or prevention of such parasites is obtained in animals, by the systemic administration of up to about 50 mg per kg of animal body weight.

In particular, control or prevention of such parasites is obtained by administering a N-phenyl-1,1,1-trifluoromethanesulfonamide compound of Formula 1a, 1b, and 1c as identified herein in an amount ranging from about 0.025 to 50 mg per kg of body weight in a single dose, or more particularly, from about 0.025 to about 25 mg per kg of body weight in a single dose, or optionally, from about 1 to about 5 mg per kg in a single dose. Repeat treatments are given as required to combat re-infections and are dependent upon the species of parasite and the husbandry techniques being employed. The techniques for administering these materials to animals are known to the artisan. The exact amount of the N-phenyl-1,1,1-trifluoromethanesulfonamide compound of Formula. 1a, 1b, and 1c to be given will of course depend on several factors including the specific compound selected, the animal being treated, the parasite(s) infecting the animal, severity of infection, etc. and all such factors being considered by the artisan in calculating the required effective dose without undue experimentation.

In one preferred embodiment, the N-phenyl-1,1,1-trifluoromethanesulfonamide compounds of Formula 1a, 1b, and 1c identified herein are administered to animals in an oral unit dosage form, such as a capsule, bolus or tablet, or as a liquid drench where used as an anthelmintic in mammals. The drench is normally a solution, suspension or dispersion of the active ingredient usually in water together with a suspending agent such as bentonite and a wetting agent or like excipient. Generally, the drenches also contain an antifoaming agent.

By way of example, drench formulations for immediate administration to animals generally include up to about 50%, by weight, of a N-phenyl-1,1,1-trifluoromethanesulfonamide compound of Formula 1a, 1b, and 1c as identified herein. In particular, drench formulations for immediate administration to animals generally include from about 0.0001 to about 50% by weight of the N-phenyl-1,1,1-trifluoromethanesulfonamide compound of Formula 1a, 1b, and 1c. Preferred drench formulations contain from about 0.001 to about 10% by weight of the inventive compound. More preferred drench formulations contain from about 0.1 to about 5% by weight of the inventive compound. The drench capsules and boluses comprise the active ingredient admixed with a carrier vehicle such as starch, talc, magnesium stearate, or di-calcium phosphate. In certain optional embodiments, e.g., for large animals, such drench formulations are applied topically, and provide a surface concentration on the animal that is effective to kill or suppress parasites, e.g., by providing a concentration of the inventive compound ranging from about 0.001 μg/cm² to about 1000 μg/cm², or more preferably, from about 0.01 μg/cm² to about 100 μg/cm².

In a further optional embodiment, the N-phenyl-1,1,1-trifluoromethanesulfonamide compounds of Formula 1a, 1b, and 1c are formulated as topical formulations, e.g., for spot-on or pour-on administration. Such a topical formulation includes an effective amount of one or more of the N-phenyl-1,1,1-trifluoromethanesulfonamide compounds of Formula 1a, 1b, and 1c, in an amount sufficient to provide an effective amount on topical application, e.g., by providing a concentration of the inventive compound ranging from about 0.001 μg/cm² to about 1000 μg/cm², or more preferably, from about 0.01 μg/cm² to about 100 μg/cm². The topical formulation is optionally admixed with suitable carriers or diluants, including, for example, one or more carriers or emollients such as polyvinylpyrrolidone, polyvinyl alcohols, copolymers of vinyl acetate, and vinylpyrrolidone, polyethylene glycols, benzyl alcohol, mannitol, glycerol, sorbitol, polyoxyethylenated sorbitan esters, lecithin, sodium carboxymethylcellulose, silicone oils, anionic surfactants, cationic surfactants, nonionic surfactants, and amphoteric surfactants, or a mixture of at least two of these agents.

In certain other optional embodiments, the N-phenyl-1,1,1-trifluoromethanesulfonamide compounds of Formula 1a, 1b, and 1c may be administered in a controlled release form, e.g., in a subcutaneous slow release formulation, or in the form of a controlled release device affixed to an animal such as a so-called flea collar, or ear tag, in which the desired chemical or chemicals have been impregnated into a suitable release matrix, such as a polymer. Collars for the controlled release of an insecticide agent for long term protection against flea infestation in a companion animal are art-known, and are described, for example, by U.S. Pat. Nos. 3,852,416, 4,224,901, 5,555,848, and 5,184,573, hereby incorporated by reference.

Where it is desired to administer the N-phenyl-1,1,1-trifluoromethane-sulfonamide compounds of Formula 1a, 1b, and 1c in a dry, solid unit dosage form, capsules, boluses or tablets containing the desired amount of active compound usually are employed. These dosage forms are prepared by intimately and uniformly mixing the active ingredient with suitable finely divided diluents, fillers, disintegrating agents and/or binders such as starch, lactose, talc, magnesium stearate, vegetable gums and the like. Such unit dosage formulations may be varied widely with respect to their total weight and content of the antiparasitic agent depending upon factors such as the type of host animal to be treated, the severity and type of infection and the weight of the host.

When the N-phenyl-1,1,1-trifluoromethanesulfonamide compound of Formula 1a, 1b, and 1c is to be administered via an animal feedstuff, one or more of the compounds are intimately dispersed in the feed, or used as a top dressing, or in the form of pellets, which may then be added to the finished feed or optionally fed separately.

Alternatively, the N-phenyl-1,1,1-trifluoromethanesulfonamide compound of Formula 1a, 1b, and 1c is to be administered to animals parenterally, for example, by intraruminal, intramuscular, intratracheal, or subcutaneous injection in which event the active ingredient is dissolved or dispersed in a liquid carrier vehicle. For parenteral administration, the active material is suitably admixed with an acceptable vehicle, preferably of the vegetable oil variety such as peanut oil, cotton seed oil and the like. Other parenteral vehicles such as organic preparation using solketal, glycerol formal, and aqueous parenteral formulations are also used. The selected N-phenyl-1,1,1-trifluoromethanesulfonamide compound of Formula 1a, 1b, and 1c is dissolved or suspended in the parenteral formulation for administration; such formulations generally contain from 0.005 to about 25% by weight of the active compound, or optionally, from about 1% to about 10% by weight of the active compound, or from about 1% to about 5% of the active compound (w/w).

The N-phenyl-1,1,1-trifluoromethanesulfonamide compound of Formula 1a, 1b, and 1c, as identified herein, is also employed to prevent and treat diseases caused by other parasites, for example, arthropod parasites such as ticks, lice, fleas, mites and other biting insects in domesticated animals, including poultry. These compounds are also effective in treatment of parasitic diseases that occur in other animals including humans. The optimum amount to be employed for best results will, of course, depend upon the particular compound employed, the species of animal to be treated and the type and severity of parasitic infection or infestation.

When the N-phenyl-1,1,1-trifluoromethanesulfonamide compounds of Formula 1a, 1b, and 1c described herein are administered as a component of the feed of the animals, or dissolved or suspended in the drinking water, compositions are provided in which the active agent(s) are intimately dispersed in an inert carrier or diluent. An inert carrier is one that will not react with the antiparasitic agent and one that may be administered safely to animals. Preferably, a carrier for feed administration is one that is, or may be, an ingredient of the animal ration.

Suitable compositions include feed pre-mixes or supplements in which the active ingredient is present in relatively large amounts and which are suitable for direct feeding to the animal or for addition to the feed either directly or after an intermediate dilution or blending step. Typical carriers or diluents suitable for such compositions include, for example, distillers' dried grains, corn meal, citrus meal, fermentation residues, ground oyster shells, wheat shorts, molasses solubles, corn cob meal, edible bean mill feed, soya grits, crushed limestone, and the like. The active N-phenyl-1,1,1-trifluoromethanesulfonamide compound of Formula 1a, 1b, and 1c is intimately dispersed throughout the carrier by methods such as grinding, stirring, milling or tumbling. Compositions containing from about 0.05 to about 5.0%, or from about 0.005 to about 2.0% by weight of the active N-phenyl-1 1,1-trifluoromethanesulfonamide compound of Formula 1a, 1b, and 1c are particularly suitable as feed pre-mixes. Feed supplements, which are fed directly to the animal contain from about 0.0002 to 0.3% by weight of the active N-phenyl-1,1,1-trifluoromethanesulfonamide compound of Formula 1a, 1b, and 1c.

Such supplements are added to the animal feed in an amount to give the finished feed the concentration of active compound desired for the treatment and control of parasitic diseases. Although the desired concentration of active N-phenyl-1,1,1-trifluoromethanesulfonamide compound of Formula 1a, 1b, and 1c will vary depending upon the factors mentioned supra as well as upon the particular derivative employed, the compound is usually fed at concentrations of between about 0.0001 to 0.02% or from about 0.00001 to about 0.002% in the feed in order to achieve the desired antiparasitic result.

The inventive methods are also useful in combating agricultural pests that inflict damage upon crops while they are growing or while in storage. The N-phenyl-1,1,1-trifluoromethanesulfonamide compounds of Formula 1a, 1b, and 1c are applied using known techniques as sprays, dusts, emulsions and the like, to the growing or stored crops to effect protection from such agricultural pests.

1. Routes of Administration for Animals

As used herein, the terms, “administer” or “administration” refer to the delivery of a N-phenyl-1,1,1-trifluoromethanesulfonamide compound of Formula 1a, 1b, and 1c, salt, solvate, or prodrug thereof, or of a pharmaceutical composition containing the N-phenyl-1,1,1-trifluoromethanesulfonamide compound of Formula 1a, 1b, and 1c, salt, solvate, or prodrug, to an organism for the purpose of treating and/or preventing a parasite infestation in animals.

Suitable routes of administration may include, without limitation, oral, rectal, topical, transmucosal, intramuscular, subcutaneous, intramedullary, intrathecal, direct intraventricular, intravenous, intravitreal, intraperitoneal, intra-ruminal, intranasal, aural or intraocular. The preferred routes of administration are oral, topical, and parenteral.

Alternatively, one may administer the N-phenyl-1,1,1-trifluoromethanesulfonamide compounds of Formula 1a, 1b, and 1c in a local rather than systemic manner, for example, by preparation as a salve or topically applied formulation that is applied directly to the infected area or by injection of the N-phenyl-1,1,1-trifluoromethanesulfonamide compounds of Formula 1a, 1b, and 1c directly into infected tissue. Topical routes of administration include pour-on or spot-on administration, e.g., topically applying a suitable formulation to a localized region, allowing for diffusion of an effective amount of the N-phenyl-1,1,1-trifluoromethanesulfonamide compounds of Formula 1a, 1b, and 1c into infected or infested areas. In either case, a sustained release formulation may be used.

Thus, administration of the N-phenyl-1,1,1-trifluoromethanesulfonamide compounds of Formula 1a, 1b, and 1c of the invention, solvates thereof, or a pharmaceutically acceptable salt, in pure form or in an appropriate pharmaceutical composition, can be carried out via any of the accepted modes of administration or agents for serving similar utilities. The routes of administration can be any known to those of ordinary skill. The inventive compounds are given to those in need thereof in any art recognized form, i.e., solid, semi-solid, lyophilized powder, or liquid dosage forms, such as for example, tablets, suppositories, pills, soft elastic and hard gelatin capsules, powders, solutions, suspensions, or aerosols, or the like, in unit or multi-dosage forms suitable for simple administration of precise dosages. The compositions will include a conventional pharmaceutical carrier or excipient and a N-phenyl-1,1,1-trifluoromethanesulfonamide compounds of Formula 1a, 1b, and 1c as the active agent, and, in addition, may include other medicinal agents, pharmaceutical agents, carriers, etc.

For aquatic animal species, e.g., vertebrate fish species, methods of administering the N-phenyl-1,1,1-trifluoromethanesulfonamide compounds of Formula 1a, 1b, and 1c include the foregoing, e.g., by injection or by admixing the effective compounds in the feed of farmed fish, and so forth. Method of administering to aquatic animal species also include dipping the fish into water comprising an effective concentration of the N-phenyl-1,1,1-trifluoromethanesulfonamide compounds of Formula 1a, 1b, and 1c, spraying the fish with an effective concentration of the compound, while the fish is briefly separated from the water, and so forth.

2. Composition/Formulation for Animals

Pharmaceutical compositions of the present invention may be manufactured by processes well known in the art, e.g., using a variety of well-known mixing, dissolving, granulating, dragee-making, levigating, emulsifying, encapsulating, entrapping or lyophilizing processes. The compositions may be formulated in conjunction with one or more physiologically acceptable carriers comprising excipients and auxiliaries which facilitate processing of the active N-phenyl-1,1,1-trifluoromethanesulfonamide compounds of Formula 1a, 1b, and 1c into preparations which can be used pharmaceutically. Proper formulation is dependent upon the route of administration chosen.

For injection, including, without limitation, intravenous, intramuscular and subcutaneous injection, the N-phenyl-1,1,1-trifluoromethanesulfonamide compounds of Formula 1a, 1b, and 1c may be formulated in aqueous solutions, preferably in physiologically compatible buffers known to those of ordinary skill, as well as other excipients or other materials known to those of ordinary skill. For transmucosal administration, penetrants appropriate to the barrier to be permeated are used in the formulation. Such penetrants are generally known in the art.

For oral administration, the N-phenyl-1,1,1-trifluoromethanesulfonamide compounds of Formula 1a, 1b, and 1c can be formulated by combining the active compound with pharmaceutically acceptable carriers well-known in the art. Such carriers enable the N-phenyl-1,1,1-trifluoromethanesulfonamide compounds of Formula 1a, 1b, and 1c to be formulated as tablets, pills, lozenges, dragees, capsules, liquids, gels, syrups, pastes, slurries, solutions, suspensions, concentrated solutions and suspensions for diluting in the drinking water of a patient, premixes for dilution in the feed of a patient, and the like, for oral ingestion by a patient. Pharmaceutical preparations for oral use can be made using a solid excipient, optionally grinding the resulting mixture, and processing the mixture of granules, after adding other suitable auxiliaries if desired, to obtain tablets or dragee cores. Useful excipients are, in particular, fillers such as sugars, including lactose, sucrose, mannitol, or sorbitol, cellulose preparations such as, for example, maize starch, wheat starch, rice starch and potato starch and other materials such as gelatin, gum tragacanth, methyl cellulose, hydroxypropyl- methylcellulose, sodium carboxy-methylcellulose, and/or polyvinylpyrrolidone (PVP). If desired, disintegrating agents may be added, such as cross-linked polyvinyl pyrrolidone, agar, or alginic acid. A salt such as sodium alginate may also be used.

Dragee cores are provided with suitable coatings. For this purpose, concentrated sugar solutions may be used which may optionally contain gum arabic, talc, polyvinyl pyrrolidone, carbopol gel, polyethylene glycol, and/or titanium dioxide, lacquer solutions, and suitable organic solvents or solvent mixtures. Dyestuffs or pigments may be added to the tablets or dragee coatings for identification or to characterize different combinations of active compound doses.

Pharmaceutical compositions that can be used orally include push-fit capsules made of gelatin, as well as soft, sealed capsules made of gelatin and a plasticizer, such as glycerol or sorbitol. The push-fit capsules can contain the active ingredients in admixture with a filler such as lactose, a binder such as starch, and/or a lubricant such as talc or magnesium stearate and, optionally, stabilizers. In soft capsules, the active N-phenyl-1,1,1-trifluoromethanesulfonamide compounds of Formula 1a, 1b, and 1c may be dissolved or suspended in suitable liquids, such as fatty oils, liquid paraffin, or liquid polyethylene glycols. Stabilizers also may be added in these formulations.

For administration by inhalation, the N-phenyl-1,1,1-trifluoromethanesulfonamide compounds of Formula 1a, 1b, and 1c can conveniently be delivered in the form of an aerosol spray using a pressurized pack or a nebulizer and a suitable propellant, e.g., without limitation, dichlorodifluoro- methane, trichlorofluoromethane, dichlorotetrafluoroethane or carbon dioxide. In the case of a pressurized aerosol, the dosage unit may be controlled by providing a valve to deliver a metered amount. Capsules and cartridges of, for example, gelatin for use in an inhaler or insufflator may be formulated containing a powder mix of the compound and a suitable powder base such as lactose or starch.

The N-phenyl-1,1,1-trifluoromethanesulfonamide compounds of Formula 1a, 1b, and 1c compounds may also be formulated for parenteral administration, e.g., by bolus injection or continuous infusion. Formulations for injection may be presented in unit dosage form, e.g., in ampoules or in multi-dose containers. Useful compositions include, without limitation, suspensions, solutions or emulsions in oily or aqueous vehicles, and may contain adjuncts such as suspending, stabilizing and/or dispersing agents. Pharmaceutical compositions for parenteral administration include aqueous solutions of a water soluble form, such as, without limitation, a salt, of the active compound. Additionally, suspensions of the active compounds may be prepared in a lipophilic vehicle. Suitable lipophilic vehicles include fatty oils such as sesame oil, synthetic fatty acid esters such as ethyl oleate and triglycerides, or materials such as liposomes. Aqueous injection suspensions may contain substances that increase the viscosity of the suspension, such as sodium carboxymethyl cellulose, sorbitol, or dextran. Optionally, the suspension may also contain suitable stabilizers and/or agents that increase the solubility of the compounds to allow for the preparation of highly concentrated solutions. Alternatively, the active ingredient may be in powder form for constitution with a suitable vehicle, e.g., sterile, pyrogen-free water, before use.

The N-phenyl-1,1,1-trifluoromethanesulfonamide compounds of Formula 1a, 1b, and 1c may also be formulated in rectal compositions such as suppositories or retention enemas, using, e.g., conventional suppository bases such as cocoa butter or other glycerides.

In addition to the formulations described supra, the N-phenyl-1,1,1-trifluoromethanesulfonamide compounds of Formula 1a, 1b, and 1c may also be formulated as a depot preparation. Such long acting formulations may be administered by implantation (for example, subcutaneously or intramuscularly) or by intramuscular or subcutaneous injection. N-phenyl-1,1,1-trifluoromethanesulfonamide compounds of Formula 1a, 1b, and 1c may be formulated for this route of administration with suitable polymeric or hydrophobic materials (for instance, in an emulsion with a pharmacologically acceptable oil), with ion exchange resins, or as a sparingly soluble derivative such as, without limitation, a sparingly soluble salt.

Other delivery systems for relatively hydrophobic pharmaceutical compounds may be employed. Liposomes and emulsions are well-known examples of delivery vehicles or carriers for hydrophobic drugs. In addition, organic solvents such as dimethylsulfoxide may be used, if needed.

Additionally, the N-phenyl-1,1,1-trifluoromethanesulfonamide compounds of Formula 1a, 1b, and 1c may be delivered using a sustained-release system, such as semi-permeable matrices of solid hydrophobic polymers containing the therapeutic agent. Various sustained-release materials have been established and are well known by those skilled in the art. Sustained-release capsules may, depending on their chemical nature, release the compounds for a few weeks up to over 100 days. Depending on the chemical nature and the biological stability of the particular compound, additional stabilization strategies may be employed.

Pharmaceutical compositions useful herein also may comprise solid or gel phase carriers or excipients. Examples of such carriers or excipients include, but are not limited to, calcium carbonate, calcium phosphate, various sugars, starches, cellulose derivatives, gelatin, and polymers such as polyethylene glycols.

3. Delivery to Plants/Crops, Facilities, Habitats

The N-phenyl-1,1,1-trifluoromethanesulfonamide compounds of Formula 1a, 1b, and 1c can be readily formulated by art-known methods for delivery for killing, suppressing or inhibiting endo- or ectoparasites in or on plants generally, and particularly in crop plants, e.g., to kill or suppress any of the myriad plant pests enumerated above. In addition, the N-phenyl-1,1,1-trifluoromethanesulfonamide compounds of Formula 1a, 1b, and 1c can be applied or distributed into selected environmental areas to kill or suppress endo or ectoparasites, where desired. These compounds are readily formulated, by methods known to the art, into compositions suitable for such applications. Such compositions optionally include more than one of the inventive compounds, each selected for an optimal spectrum of activity. In certain optional embodiments, the compositions include other agents, e.g., other art-known antiparasitic agents, pesticides and the like, as enumerated supra, that may provide a useful complementary or synergistic anti-parasitical effect.

It is further contemplated that the compositions optionally include other useful agents, including weed killers, fertilizers, and the like, for efficient agriculture management.

Compositions for such distribution include solutions, suspensions and dry forms of the inventive compound(s) as discussed supra. This process of administering such compositions can be achieved by methods well known to the art. These include spraying, brushing, dipping, rinsing, washing, dusting, using art-known equipment, in a selected area. The selected area optionally includes plants, e.g., crops, and/or animals.

Thus, environmental areas contemplated to be treated in this way include, e.g., fields, orchids, gardens and the like, buildings and their environs, including landscaping; storage facilities, transport or fixed storage containers or analogous structures and structural components, such as walls, floors, roofs, fences, windows and window screens, and the like. Animal living spaces are also included, e.g., animal pens, chicken coops, corals, barns and the like. Human homes and other human residential, business or commercial and educational facilities are also contemplated to be treated or contacted with the inventive compounds or compositions thereof as described above.

The application of the compounds, compositions and formulations of the present invention also can be achieved using art-known spraying devices, e.g., self-pressurized aerosol containers, larger devices employing compressed air or centrifugal distribution, as well as crop dusters, and the like.

### Confirming Anti-Parasite Activity

Exemplified compounds of Formula 1a are listed by Table 1a and Table 1b, above. Exemplified compounds of Formula 1b and Formula 1c are listed by Table 1c and Table 1d, above. The activity of these compounds against Haemonchus contortus and cat flea (Ctenocephalides felis) is summarized by Table 7, below. The data is presented in the following formats.

The LD₉₉ value is the dose, expressed as pg/ml, that was required to kill 99% of a sample of Haemonchus contortus.

The LC₅₀ value is the concentration, expressed as μg/cm², that was required to kill 50% of the sample of cat fleas on contact with the tested compound. Certain tests are also reported as the percent of a sample of cat fleas that were killed at a concentration of 1.26 μg/cm² (“% mortality”), for the compounds tested in this way.

a) Haemonchus Contortus Larvacidal Assay:

The effect of compounds on larval development was determined in the assay described by Gill et al. [International Journal of Parasitology 25:463-470 (1995)]. Briefly, in this assay, nematode eggs are applied to the surface of an agar matrix containing the test compound and then allowed to develop through to the L3, infective stage (6 days). The wells for each dilution of every compound (from highest to lowest concentration) are inspected to determine the well number corresponding to the lowest concentration at which development is inhibited in 99% of the nematode larvae present (LD₉₉). Because well numbers correspond to a two-fold serial dilution of each compound, a titre (dilution factor) is generated as 2ⁿ⁻¹, where n is the well number. By dividing the highest concentration tested by the titre an LD₉₉ value can be obtained, representing the concentration required to inhibit development in 99% of the nematode larvae present. The compounds supplied as solid and viscous liquids are dissolved in DMSO. Twelve serial one-half dilutions in DMSO solution are prepared from the stock solution, each of which is then diluted 1/5 with water. Aliquots (10 μl) of each dilution are transferred to the bioassay plates to give a final concentration range of 0.024 to 50 μg/ml.

b) Ctenocephalides felis Adulticide Assay: C.felis single dose screen

The purpose of this example is to confirm that sample compounds or formulations exhibit significant insecticidal activity against cat fleas contacted with a treated glass surface. Mortality of fleas is the primary endpoint in the assay. Fleas are considered dead if they do not move or are on their sides and unable to walk or right themselves. In the screening assay a single concentration of a test compound is selected to demonstrate insecticidal activity. The concentration chosen (1.26 μg/cm²) is higher than that known to kill 90% of cat fleas (LC₉₀) using the reference compound, permethrin.

The test species employed was the cat flea (Ctenocephalides felis). The strain used was obtained from external suppliers as pupae and held in the laboratory under testing conditions until the adults had emerged. Fifteen (15) fleas were used in a minimum of four replicates against a single concentration level (approximately 60 fleas). The insects were selected to be in the adult life stage, aged between 3 and 7 days post emergence.

The compounds to be tested were supplied as solids and were prepared in acetone as described below prior to testing. Samples were stored in a refrigerator (5±1° C.) unless otherwise specified.

During the mortality testing, the temperature was maintained at 25±1° C. Humidity was maintained at 75±5%. The base (area=159 mm²) of a 100 mL glass Erlenmeyer (conical) flask provided the treatment surface. Flasks were pre-treated with Coatasil™ glass treatment to maximise bio-availability of test compounds by preventing them from binding to glass the surface. The base of the 100 mL Erlenmeyer flask was treated with 0.5 mL of test sample in acetone and gently swirled. This volume was sufficient to cover the base of the flask. Flasks were left to dry for 24 hours before flea exposure.

Adult cat fleas were placed into a sorting chamber, which allowed fleas to jump into the Erlenmeyer flasks. Fifteen (15) adult cat fleas were collected in each flask. The top of the flasks were then covered in Parafilm™ and small holes were made to allow gas exchange. A 0.5 mL volume of acetone as a solvent control was applied to the base of an Erlenmeyer flask and the testing proceeded in the same manner described above. Cat fleas in the treatment containers were held under testing conditions for 8 and/or 24 hours. Mortality was recorded at 24 hours. Pooled 24 hour mortality data were converted to percentages and are summarized by Table 4, below.

c) Ctenocephalides felis Adulticide Assay: C. felis dose response The purpose of this example is to determine the LC₅₀ when cat fleas are contacted with a glass surface treated with sample compounds or formulations prepared as described above. Mortality of fleas is defined as follows: fleas are considered dead if they don't move or are on their sides and unable to walk or right themselves. LC₅₀: Lethal Concentration 50— concentration of glass surface treatment at which 50% of the cat fleas are killed.

The test species employed was the cat flea (Ctenocephalides felis). The strain used was obtained from external suppliers as pupae and held in the laboratory under testing conditions until the adults had emerged. Fifteen (15) fleas were used in a minimum of four replicates for each dose level (total of 60 fleas per dose level). The insects were selected to be in the adult life stage, aged between 3 and 7 days post emergence.

The compounds to be tested were dissolved in acetone just prior to testing. Samples of compounds were stored in a refrigerator (5±1° C.) unless otherwise specified. During the mortality testing, the temperature was maintained at 25±1° C. Humidity was maintained at 75±5%. The base (area=159 mm²) of a 100 mL glass Erlenmeyer (conical) flask provided the treatment surface. Flasks were pre-treated with Coatasil™ glass treatment to maximise bio-availability of test compounds by preventing them from binding to the glass surface.

Six dose levels (concentrations) of test sample, in the form of a serial dilution, were derived from a pilot study and covered a range that produced very low to very high mortality. The base of the 100 mL Erlenmeyer flask was treated with 0.5 mL of test sample in acetone and gently swirled. This volume was sufficient to cover the base of the flask. Flasks were left to dry for 24 hours before flea exposure. Adult cat fleas were lightly anaesthetised by cooling and then placed into a sorting chamber, which allowed fleas to revive and jump into the Erlenmeyer flasks. Fifteen (15) adult cat fleas were collected in each flask. The top of the flasks were then covered in Parafilm™ and small holes made to allow gas exchange. A 0.5 mL volume of acetone was applied to the base of an Erlenmeyer flask and the testing proceeded in the same manner described above. Cat fleas in the treatment containers were held under testing conditions for 24 hours. Mortality resulting from the treatments was recorded at 24 hours. Pooled 24 hour mortality data were subjected to probit analysis to obtain concentration response data (LC₅₀) [Finney, Probit Analysis. 3rd ed. Cambridge Univ. Press, London (1971)].

d) Topical Application On Brown Dog Ticks (Rhipicephalus sanguineus)

The aim of the test is to determine the presence of significant acaricidal activity in sample compounds or formulations when applied topically on brown dog ticks. A tick is defined as dead if it gives no apparent response when: (i) touched lightly and (ii) then observed for 1 minute. To assess the experimental compound for acaricidal activity, a single dose level is chosen based on known results from previous experiments with a commercially available active reference compound.

In the present example, both permethrin and fipronil were employed as reference compounds. The insect species tested was the Brown Dog Tick (Rhipicephalus sanguineus). Mixed sex adult ticks were used for tests. The strain used was cultured from a field strain and supplied as unfed adult ticks (mixed sex). Ticks were maintained in controlled conditions (temp. 18°±2° C., humidity 75±5% RH).

Test compounds (formulations or active ingredients) were stored in a refrigerator (5±1° C.) unless otherwise specified. The temperature was maintained at 25±1° C. and the humidity was ambient. The screening dose chosen was higher than that known kill 90% of insects (LD₉₀) using the reference compound. In the case of topical application of active compounds on adult ticks, the reference compound was fipronil and the dose chosen was 10 μg of active per tick (=10 μg of fipronil/1 μl of acetone). Ticks were each treated on the abdomen with 1 μL of a single dose level of test sample in acetone; ten ticks were treated with solvent only (acetone) in each test. Tests were replicated 4 times (total of 40 ticks treated). Ticks were held in recovery containers maintained under appropriate rearing conditions for 24 hours. Mortality resulting from the treatments was recorded at 24 hours. Pooled 24 hour mortality data were converted to percentages.

In Table 7, provided below, are listed the Haemonchus contortus LD₉₉ values (measured in micrograms/mL), the Ctenocephalides felis rapid screening values (measured in % mortality), the Ctenocephalides felis LC₅₀ values (measured in micrograms/cm²) and the Rhipicephalus sanguineus rapid screening values (measured in % mortality) for selected compounds in accordance with the present invention. The tabulated data confirm that the inventive compounds have significant antiparasite activity for both endo and ectoparasites, as shown.

TABLE 7

| | Ctenocephalides | Rhipicephalus | | Haemonchus |
|---|---|---|---|---|
| | felis | sanguineus | Ctenocephalides | contortus |
| Cd | Mortality (%) | Mortality (%) | felis | LD₉₉ |
| # | 24 h | 24 h | LC₅₀ (μg/cm²) | (μg/mL) |
| 1 | 100 | 68 | 0.32 | 1.5 |
| 2 | 100 | 28 | 0.19 | 5.5 |
| 3 | 58 | | | 7.0 |
| 4 | 98 | 83 | 0.27 | 12.0 |
| 5 | 100 | | 0.66 | 11.0 |
| 6 | 74 | | | 15.0 |
| 7 | 22 | | | 1.63 |
| 8 | 62 | | 0.59 | 2.75 |
| 9 | 94 | 25 | 0.09 | 2.5 |
| 10 | 38 | | | 1.5 |
| 11 | 20 | | | 2.5 |
| 12 | 100 | 50 | 0.15 | 2.8 |
| 13 | 48 | | | 1.8 |
| 14 | 100 | 98 | 0.05 | 13.0 |
| 15 | 100 | | 0.30 | 5.5 |
| 16 | 100 | | 0.78 | 11.0 |
| 17 | 19 | | | 7.5 |
| 18 | 19 | | | 2.8 |
| 19 | 42 | | | 5.0 |
| 20 | 100 | 95 | 0.13 | 13.0 |
| 21 | 100 | 90 | 0.12 | 15.0 |
| 22 | 4 | | | 0.63 |
| 23 | 3 | | | |
| 24 | 19 | | | 12.0 |
| 25 | 100 | | 0.73 | |
| 26 | 100 | | 0.33 | |
| 27 | 59 | | | 14 |
| 28 | 10 | | | 12 |
| 29 | 57 | | | 7.0 |
| 30 | 100 | | 0.71 | |
| 31 | 25 | | | |
| 32 | 18 | | | |
| 33 | 19 | | | |
| 34 | 8 | | | |
| 35 | 42 | | | |
| 36 | 49 | | | |
| 37 | 21 | | | |
| 38 | 95 | | 0.75 | |
| 39 | 75 | | | |
| 40 | 39 | | | |
| 41 | 23 | | | |
| 42 | 88 | | | |
| 43 | 17 | | | |
| 44 | 25 | | | |
| 45 | 79 | | | |
| 46 | 70 | | | |
| 47 | 36 | | | |
| 48 | 61 | | | |
| 49 | 24 | | | |
| 50 | 14 | | | |
| 51 | 10 | | | |
| 52 | 23 | | | |
| 53 | 9 | | | |
| 54 | 5 | | | |
| 55 | 100 | | 1.88 | |
| 56 | 6 | | | |
| 57 | 2 | | | |
| 58 | 87 | | | |
| 59 | 100 | | 0.97 | |
| 60 | 5 | | | |
| 61 | 2 | | | |
| 62 | 25 | | | |
| 63 | 10 | | | |
| 64 | 14 | | | |
| 65 | 21 | | | |
| 66 | 20 | | | |
| 67 | 5 | | | |
| 68 | 100 | 55 | 0.59 | |
| 69 | 58 | | | |
| 70 | 11, 91^{#} | 5 | | |
| 71 | 0, 100^{#} | 5 | | |
| 72 | 14, 100^{#} | 0 | | |
| 73 | 31, 100^{#} | 8 | | |
| 74 | 81 | | | |
| 75 | 97 | 3 | | |
| 76 | 3 | | | |
| 77 | 20 | | | |
| 78 | 80 | | | |
| 79 | 60 | | | |
| 80 | 9 | | | |
| 81 | 1 | | | |
| 82 | 90 | 0 | | |
| 83 | 100 | 8 | | |
| 84 | 100 | 0 | | |
| 85 | 97 | 5 | | |
| 86 | 66 | | | |
| 87 | 24 | | | |
| 88 | 73 | | | |
| 89 | 6 | | | |
| 90 | 88 | 13 | | |
| 91 | 13 | | | |
| 92 | 57 | | | |
| m1 | 93 | 38 | | |
| m2 | 88 | | | |
| m3 | 57 | 38 | | |
| m4 | 90 | 8 | | |
| m5 | 72 | | | |
| m6 | 34 | | | |
| m7 | 5 | | | |
| p1 | 84 | | | |
| p2 | 64 | | | |
| p3 | 72 | | | |
| p4 | 49 | | | |
| p5 | 54 | | | |
| p6 | 28 | | | |
| p7 | 22 | | | |
| p8 | 4 | | | |
| p9 | 44 | | | |

^{#}Mortality measured at 48 hours

### EXAMPLES

The following preparative examples of preferred novel derivatives of Formula 1a, 1b, and 1c serve to provide further appreciation of the invention but are not meant in any way to restrict the effective scope of the invention.

### EXAMPLE 1

The following compounds were prepared according to the reaction scheme illustrated in FIG. 1.

Preparation of N-[4-Chloro-2-(2,4-dichlorophenoxy)phenyl]-1,1,1-trifluoromethanesulfonamide (Compound 1)

a) A mixture of 2,4-dichloronitrobenzene (3.18 g, 16.56 mmol), 2,4-dichlorophenol (3.0 g, 18.40 mmol) and potassium carbonate (3.05 g, 22.10 mmol) in m-xylene (30 mL) was heated in an oil bath at 160° C. for 15 h. After cooling, the insoluble materials were filtered off and the solvent evaporated in vacuo. The residue was passed through a pad of silica (5 g of SiO₂, 50% CH₂Cl₂ in petroleum spirit) and the solvent evaporated. The residue obtained was recrystallised from absolute ethanol to afford 4.44 g (84%) of 4-chloro-2-(2,4-dichlorophenoxy)-1-nitrobenzene as yellow crystals. ¹H NMR (200 MHz, CDCl₃) δ 7.98 (d, J=8.8 Hz, 1H), 7.53 (d, J=2.4 Hz, 1H), 7.31 (dd, J=2.4, 8.8 Hz, 1H), 7.20 (dd, J=2.2, 8.8 Hz, 1H), 7.07 (d, J=8.8 Hz, 1H), 6.78 (d, J=2.2 Hz, 1H).

b) Iron powder (1.75 g, 31.39 mmol) and ammonium chloride (168 mg, 3.14 mmol) were added to a solution of 4-chloro-2-(2,4-dichlorophenoxy)-1-nitrobenzene (2.0 g, 6.28 mmol) in ethanol (50 mL) and water (25 mL). The mixture was refluxed for 30 min. The hot mixture was filtered and the insoluble materials were washed with ethyl acetate. Additional ethyl acetate (100 mL) and water (100 mL) were added and the aqueous layer separated and extracted with ethyl acetate. The combined organic layers were dried and the solvent evaporated in vacuo. The residue was passed through a pad of silica (20 g of SiO₂, 50% ethyl acetate in petroleum spirit) and the solvent evaporated to afford 1.81 g of 4-chloro-2-(2,4-dichlorophenoxy)phenylamine as a brown oil, which was used in the next step without further purification. ¹H NMR (200 MHz, CDCl₃) δ 7.47 (d, J=2.4 Hz, 1H), 7.19 (dd, J=2.4, 8.8 Hz, 1H), 6.95 (dd, J=2.2, 8.6 Hz, 1H), 6.87 (d, J=8.8 Hz, 1H), 6.74 (d, J=8.6 Hz, 1H), 6.71 (d, J=2.2 Hz, 1H), 3.86 (br s, 2H).

c) Trifluoromethanesulfonic anhydride (1.60 mL, 9.51 mmol) in dichloromethane (25 mL) was added dropwise over 30 min to an ice-cold solution of 4-chloro-2-(2,4-dichlorophenoxy)phenylamine (1.83 g, 6.34 mmol) in dichloromethane (75 mL). The reaction was allowed to warm up slowly overnight. Water (100 mL) was added and the organic layer separated then washed with brine, dried and the solvent evaporated in vacuo. The residue was passed through a pad of silica (5 g of SiO₂, 70% CH₂Cl₂ in petroleum spirit) and the solvent evaporated. The residue obtained was recrystallised from diethyl ether/petroleum spirit to afford 1.50 g (56%) of N-[4-chloro-2-(2,4-dichlorophenoxy)phenyl]-1,1,1-trifluoromethanesulfonamide as a white solid, mp 97-98° C. ¹H NMR (200 MHz, CDCl₃) δ 7.56 (m, 2H), 7.34 (dd, J=2.6, 8.8 Hz, 1H), 7.09 (m, 2H), 6.58 (d, J=2.2 Hz, 1H). APCl-MS 418 m/z (M−H)⁺.

The following N-[(2-phenoxy)phenyl]-1,1,1-trifluoromethanesulfonamide compounds, as listed by Table 1a, above, were prepared using similar preparative methods: Compounds 2-11, 13-14, 16-19, 21-22, 25-44, 47-58, 60-61, 69 and 74.

Additional data for selected compounds of Example 1, supra, are provided in Table 8, below.

TABLE 8

| Compd | |
|---|---|
| # | ¹H n.m.r. (200MHz, CDCl₃) |
| 2 | 7.62-7.50, m, 3H; 7.33, m, 1H; 7.26-7.21, |
| | m, 1H; 7.14, dd, J=2.2 |
| | and 8.8Hz, 1H; 6.80, d, J=2.2Hz, 2H. |
| 4 | 7.56, d, J=8.8Hz, 1H; 7.22-6.92, m, 5H; 6.65, d, J=1.8Hz, 1H. |
| 5 | 7.55, d, J=8.8Hz, 1H; 7.45-7.36, m, |
| | 2H; 7.14, broad s, 1H; 7.08, |
| | dd, J=8.8 and 2.2Hz, 1H; 7.05-6.96,. m, |
| | 2H; 6.76, d, J=2.2Hz, 1H. |
| 9 | 7.92, d, J=1.8Hz, 1H; 7.62-7.55, m, 2H; 7.47, dd, J=8.8 and |
| | 2.2Hz, 1H; 7.38, broad s, 1H; 7.30-7.23, m, 2H; 6.90, |
| | d, J=8.8Hz, 1H. |
| 14 | 7.55, d, J=8.8Hz, 1H; 7.30-7.12, m, 5H; 7.08, dd, J=8.8 and |
| | 2.2Hz, 1H; 6.70, d, J=2.2Hz, 1H. |
| 16 | 7.53, d, J=8.8Hz, 1H; 7.32-7.16, m, 1H; 7.11, dd, J=8.8 and |
| | 2.2Hz, 1H; 7.07, broad s, 1H; 6.98-6.78, m, 2H; 6.77, d, |
| | J=2.2Hz, 1H. |
| 21 | 7.54, d, J=8.8Hz, 1H; 7.35-7.18, m, 4H; 7.05, dd, J=8.8 and |
| | 2.2Hz, 1H; 6.94, d, J=8.8Hz, 1H; 6.55, d, J=2.2Hz, 1H; 2.19, s, |
| | 3H. |

### EXAMPLE 2

N-[4-Chloro-2-((4-chlorophenyl)sulfanyl)phenyl]-1,1,1-trifluoromethanesulfonamide [Compound 12], N-[4-chloro-2-(4-(chlorophenyl)sulfinyl)phenyl]-1,1,1-trifluoromethanesulfonamide [Compound 23] and N-[4-chloro-2-(4-(chlorophenyl)sulfonyl)phenyl]-1,1,1-trifluoromethanesulfonamide (Compound 24)

A mixture of 2,4-dichloronitrobenzene (1.29 g, 6.71 mmol), 4-chlorobenzenethiol (1.0 g, 6.71 mmol) and potassium carbonate (1.11 g, 8.05 mmol) in m-xylene (10 mL) was heated in an oil bath at 160° C. for 15 h. After cooling, the insoluble materials were filtered off and the solvent evaporated in vacuo. The residue was passed through a pad of silica (5 g of SiO₂, 50% CH₂Cl₂ in petroleum spirit) and the solvent evaporated. The residue obtained was purified by radial chromatography eluting with 5% CH₂Cl₂ in petroleum spirit to afford 1.80 g (89%) of 4-chloro-2-(4-chlorophenylsulfanyl)-1-nitrobenzene as a yellow solid. ¹H NMR (200 MHz, CDCl₃) δ 7.20 (d, J=8.8 Hz, 1H), 7.51 (m, 4H), 7.19 (dd, J=2.2, 8.8 Hz, 1H), 6.76 (d, J=2.2 Hz, 1H).

b) Iron powder (372 mg, 6.66 mmol) and ammonium chloride (36 mg, 0.67 mmol) were added to a solution 4-chloro-2-(4-chlorophenylsulfanyl)-1-nitrobenzene (400 mg, 1.33 mmol) in ethanol (30 mL) and water (15 mL). The mixture was refluxed for 30 min. The hot mixture was filtered and the insoluble materials were washed with ethyl acetate. Additional ethyl acetate (100 mL) and water (100 mL) were added and the aqueous layer separated and extracted with ethyl acetate. The combined organic layers were dried and the solvent evaporated in vacuo. The residue was passed through a pad of silica (10 g of SiO₂, 50% ethyl acetate in petroleum spirit) and the solvent evaporated to afford 355 mg of 4-chloro-2-(4-chlorophenylsulfanyl)phenylamine as an orange oil, which was used in the next step without further purification. ¹H NMR (200 MHz, CDCl₃) δ 7.42 (d, J=2.6 Hz, 1H), 7.20 (m, 3H), 7.02 (m, 2H), 6.72 (d, J=8.6 Hz, 1H), 4.06 (br s, 2H).

c) Trifluoromethanesulfonic anhydride (229 μL, 1.36 mmol) in dichloromethane (5 mL) was added dropwise over 15 min to an ice-cold solution of 4-chloro-2-(4-chlorophenylsulfanyl)phenylamine (245 mg, 6.91 mmol) in dichloromethane (20 mL). The reaction was allowed to warm up slowly overnight. Water (100 mL) was added and the organic layer separated then washed with brine, dried and the solvent evaporated in vacuo. The residue was passed through a pad of silica (5 g of SiO₂, 80% CH₂Cl₂ in petroleum spirit) and the solvent evaporated. The residue obtained was purified by radial chromatography using gradient elution with 10, 20 and 30% CH₂Cl₂ in petroleum spirit to afford 85 mg (23%) of N-[4-chloro-2-(4-chloro-phenylsulfanyl)phenyl]-1,1,1-trifluoromethanesulfonamide as a cream solid, mp 83-84° C. ¹H NMR (200 MHz, CDCl₃) δ 7.60 (d, J=8.8 Hz, 1H), 7.36 (m, 4H), 7.13 (m, 2H). APCl-MS 400 m/z (M−H)⁺.

d) N-[4-chloro-2-(4-chlorophenylsulfanyl)phenyl]-1,1,1-trifluoromethanesulfonamide (200 mg, 0.48 mmol) was added to a suspension of sodium perborate tetrahydrate (77 mg, 0.48 mmol) in acetic acid (3.5 mL) and the reaction was heated at 60° C. for 2 hours. Ice-cold water (20 mL) and diethyl ether (20 mL) were added to the cooled reaction mixture, the phases separated, and then the aqueous phase was extracted again with diethyl ether. The combined organic layers were washed with brine, dried over Na₂SO₄ and the solvent was evaporated under reduced pressure. The residue was purified by radial thin layer chromatography [eluting with ethyl acetate/petroleum spirit (40-60° C.), 2:3] to afford N-[4-chloro-2-(4-(chlorophenyl)sulfinyl)phenyl]-1,1,1-trifluoromethanesulfonamide (Compound 23)(100 mg, 48%), as a white solid. ¹H n.m.r. (200 MHz, CDCl₃) δ 7.57, d, J=8.6 Hz, 2H; 7.50, d, J=8.8 Hz, 1H; 7.36, d, J=8.6 Hz, 2H; 7.25, d, J=2.4 Hz, 1H; 7.18, dd, J=2.4 and 8.8 Hz, 1H.

e) Hydrogen peroxide (30% w/v; 38 μL, 0.34 mmol) was added to a solution of N-[4-chloro-2-(4-chlorophenylsulfanyl)phenyl]-1,1,1 -trifluoromethanesulfonamide (130 mg, 0.32 mmol) in acetic acid (2 mL), and the reaction allowed to stir at room temperature for about 60 hours. Additional hydrogen peroxide (30% w/v; 38 μL, 0.34 mmol) was added to complete the reaction, and the solution was heated at 110° C. for 2 hours. Water (20 mL) and ethyl acetate (20 mL) were added to the cooled reaction mixture, the phases separated, and the aqueous phase was extracted again with ethyl acetate. The combined organic layers were washed with brine, dried over Na₂SO₄, filtered through a pad of silica (eluting with ethyl acetate) and the solvent evaporated under reduced pressure. The residue was recrystallized from ethyl acetate/petroleum spirit (40-60° C.) to afford N-[4-chloro-2-(4-(chlorophenyl)sulfonyl)phenyl]-1,1,1-trifluoromethanesulfonamide (Compound 24)(140 mg, 100%), as a white solid. ¹H n.m.r. (200 MHz, CDCl₃) δ 7.97, d, J=2.4 Hz, 1H; 7.83, d, J=8.6Hz, 2H; 7.59, d, J=9.0 Hz, 1H; 7.46, m, 3H.

The following N-[2-((phenyl)sulfanyl)phenyl]-1,1,1-trifluoromethanesulfonamide, N-[2-((phenyl)sulfinyl)phenyl]-1,1,1-trifluoromethanesulfonamide and N-[2-((phenyl)sulfonyl)phenyl]-1,1,1-trifluoromethanesulfonamide compounds, listed in Table 1a, infra, were prepared using similar preparative methods: Compounds 15, 20, 45, 46, 59, and 62-68.

Additional data for some of the compounds of Example 2, supra, are provided by Table 9, below.

TABLE 9

| Compd # | ¹H n.m.r. (200MHz, CDCl₃) |
|---|---|
| 15 | 7.64, d, J=8.8Hz, 1H; 7.51, d, J=2.4Hz, 1H; 7.42, dd, J=2.4 |
| | and 8.8Hz, 1H; 7.26, m, 2H; 7.12, m, 1H; 7.07-6.98, m, 1H. |
| 20 | 7.57, m, 1H; 7.37-7.21, m, 4H; 7.13-7.01, m, 2H. |

### EXAMPLE 3

The following compounds were prepared according to the reaction scheme illustrated in FIG. 1

Preparation of N-[4-Chloro-2-(2,4-dichlorophenoxy)phenyl]-N-methyl-1,1,1-trifluoromethanesulfonamide (Compound 70)

A mixture of N-[4-chloro-2-(2,4-dichlorophenoxy)phenyl]-1,1,1-trifluoromethane sulfonamide (222 mg, 0.528 mmol), methyl iodide (450 mg, 3.17 mmol), potassium carbonate (438 mg, 3.17 mmol) and acetone (4 mL) was refluxed for 16h. The mixture was cooled and filtered and evaporated in vacuo. The crude product was filtered though a pad of silica, eluting with dichloromethane to give N-[4-chloro-2-(2,4-dichlorophenoxy)phenyl]-N-methyl-1,1,1-trifluoromethanesulfonamide (Compound 70) (226 mg, 98%) as a colorless oil. ¹H NMR (400 MHz, CDCl₃) δ 7.54 (d, J=2.5 Hz, 1H); 7.34 (m, 2H); 7.10 (m, 2H); 6.58 (d, J=2.2 Hz, 1H); 3.50 (s, 3H). El-MS 434 m/z (M^{+.}).

The following N-alkyl-N-[(2-phenoxy)phenyl]-1,1,1-trifluoromethanesulfonamide compounds, listed in Table 1a, above, were prepared using similar preparative methods: Compounds 76-78, 86, and 87.

Additional data for some of the compounds of Example 3, supra, is provided in Table 10, below.

TABLE 10

| Compd | |
|---|---|
| # | ¹H n.m.r. (400MHz, CDCl₃) & Mass spectrum |
| 76 | 7.54, d, J=2.4Hz, 1H; 7.35-7.28, m, 2H; 7.14-7.06, m, 2H; |
| | 6.58, d, J=2.2Hz, 1H; 3.93, br q, J=7.1Hz, |
| | 2H; 1.25, t, J=7.1Hz, 3H. |
| | HRMS(EI): calc. for C₁₅H₁₁O₃NCl₃F₃S, 446.9472. Found |
| | 446.9472. |
| 77 | 7.35, d, J=8.5Hz, 1H; 7.31-7.16, m, 4H; 7.06, dd, J=8.5 and |
| | 2.2Hz, 1H, 6.67, d, J=1.0Hz, 1H; 3.49, s, 3H. HRMS(EI): calc. |
| | for C₁₄H₁₀O₃NClF₄S, 383.0001. Found 382.9999. |
| 86 | 7.52, d, J=2.4Hz, 1H; 7.32-7.04, m, 4H; 6.63, d, J=2.1Hz, 1H; |
| | 4.57, sept, J=6.7Hz, 1H; 1.36, d, J=6.7Hz, 3H; 1.30, d, J=6.7Hz, |
| | 3H. HRMS(EI): calc. for C₁₆H₁₃O₃NCl₃F₃S, 460.9634. Found |
| | 460.9640. |
| 87 | 7.29-7.15, m, 5H; 7.06, dd, J=8.5 and 2.3Hz, 1H; 6.71-6.66, m, |
| | 1H; 4.57, sept, J=6.7Hz, 1H; 1.33, d, J=6.7Hz, 3H; 1.30, d, |
| | J=6.7Hz, 3H. HRMS(EI): calc. for C₁₆H₁₄O₃NClF₄S, 411.0314. |
| | Found 411.0307. |

### EXAMPLE 4

The following compounds were prepared according to the reaction scheme illustrated in FIG. 1

Preparation of N-[4-Chloro-2-(2,4-dichlorophenoxy)phenyl]-N-ethoxymethyl 1,1,1-trifluoromethanesulfonamide (Compound 71)

A mixture of N-[4-chloro-2-(2,4-dichlorophenoxy)phenyl]-1,1,1-trifluoromethane sulfonamide (241 mg, 0.573 mmol), chloromethyl ethyl ether (163 mg, 1.72 mmol) and potassium carbonate (238 mg, 1.72 mmol) and acetone (10 mL) was refluxed for 4h. The mixture was cooled and partitioned between conc. NH₃(aq.) and ether. The combined organic phase was washed with brine, dried and evaporated in vacuo, yielding a colorless oil. The crude product was chromatographed through a plug of silica, eluting with 1:1 dichloromethane/petroleum spirit to give N-[4-chloro-2-(2,4-dichlorophenoxy)phenyl]-N-ethoxymethyl-1,1,1-trifluoromethanesulfonamide (Compound 71)(244 mg, 89%) as a colorless oil. ¹H NMR (400 MHz, CDCl₃) δ 7.54 (d, J=2.3 Hz, 1H); 7.32 (m, 2H); 7.10 (m, 2H); 6.59 (d, J=2.21 Hz, 1H); 5.23 (s, 2H); 3.74 (brq, J=7.1 Hz, 2H); 1.21 (t, J=7.1 Hz, 3H). El-MS 419 m/z [M-(CH₂OEt)]⁻

The following N-alkoxyalkyl-N-[(2-phenoxy)phenyl]-1,1,1-trifluoromethanesulfonamide compounds, listed in Table 1a, infra, were prepared using similar preparative methods: Compounds 79, 80 and 84.

Additional data for some of the compounds of Example 4, supra, is provided by Table 11, below.

TABLE 11

| Compd | |
|---|---|
| # | ¹H n.m.r. (400MHz, CDCl₃) and Mass Spectrum |
| 79 | 7.35, d, J=8.5Hz, 1H; 7.31-7.14, m, 4H; 7.08, dd, J=8.5 and |
| | 2.2Hz, 1H; 6.69-6.65, m, 1H; 5.17, s, |
| | 2H; 3.51, s, 3H. HRMS(EI): |
| | calc. for C₁₅H₁₂O₄NClF₄S, 413.0112. Found 413.0107. |
| 80 | 7.33, d, J=8.5Hz, 1H; 7.30-7.14, m, 4H; 7.08, dd, J=8.5 and |
| | 2.2Hz, 1H; 6.67, m, 1H; 5.21, s, 2H; 3.74, brq, |
| | J=6.9Hz, 2H; 1.22, t, J=7.0Hz, |
| | 3H. HRMS(EI): calc. for C₁₆H₁₄O₄NClF₄S, 427.0263. |
| | Found 427.0252. |
| 84 | 7.54, d, J=2.4Hz, 1H; 7.39-7.29, m, 2H; 7.14-7.05, m, 2H; |
| | 6.59, d, J=2.2Hz, 1H; 5.19, s, 2H; 3.51, s, 3H. HRMS(EI): |
| | calc. for C₁₅H₁₁O₄NCl₃F₃S, 462.9421. Found 462.9417. |

### EXAMPLE 5

The following compounds were prepared according to the reaction scheme illustrated in FIG. 1

Preparation of N-[4-Chloro-2-(2,4-dichlorophenoxy)phenyl]-N-(trimethylacetyl)oxymethyl-1,1,1-trifluoromethanesulfonamide (Compound 72)

A mixture of N-[4-chloro-2-(2,4-dichlorophenoxy)phenyl]-1,1,1-trifluoromethane sulfonamide (279 mg, 0.663 mmol), pivalic acid chloromethyl ester (300 mg, 1.99 mmol) and potassium carbonate (275 mg, 1.99 mmol) and acetone (10 mL) was refluxed for 2h (no reaction observed). Sodium iodide (20mg, 0.133 mmol) was added and reflux continued for a further 2h. The mixture was cooled and partitioned between the concentrated aqueous NH₃ solution and dichloromethane. The combined organic phase was washed with brine, dried and evaporated in vacuo to yield a colorless oil. The crude product was chromatographed through a plug of SiO₂, eluting with 1:1 dichloromethane/petroleum spirit to give N-[4-chloro-2-(2,4-dichlorophenoxy)phenyl]-N-(trimethylacetyl)oxymethyl-1,1,1-trifluoromethanesulfonamide (Compound 72) (268 mg, 76%) as a colorless oil. ¹H NMR (400 MHz, CDCl₃) δ 7.55 (d, J=2.6 Hz, 1H); 7.32 (m, 2H); 7.14 (d, J=8.8 Hz, 1H); 7.08 (dd, J=8.7, 2.2Hz, 1H); 6.60 (d, J=2.2 Hz, 1H); 5.75 (brs, 2H); 5.75 (brs, 2H); 5.75 (brs, 2H); 1.21 (s, 9H). ES−MS 534 m/z (M^{+.})

Preparation of N-[4-chloro-2-(2,4-dichlorophenoxy)phenyl]-N-(butyryl)oxymethyl-1,1,1-trifluoromethanesulfonamide (Compound 73)

A mixture of N-[4-chloro-2-(2,4-dichlorophenoxy)phenyl]-1,1,1-trifluoromethane sulfonamide (316 mg, 0.750 mmol), n-butanoic acid chloromethyl ester (205 mg, 0.750 mmol), potassium carbonate (311 mg, 1.50 mmol), sodium iodide (22mg, 0.150 mmol) and acetone (10 mL) was stirred at room temperature for 16h (no reaction observed) and then refluxed for 3h, after which the reaction was complete, as determined by thin-layer chromatography. The mixture was filtered and evaporated in vacuo and the residue partitioned between 1:1 concentrated NH_{3(aq.)}/brine and dichloromethane. The organic phase was dried and evaporated in vacuo. The crude product was chromatographed through a plug of SiO₂, eluting with a gradient of 1:4 to 1:1 dichloromethane in petroleum spirit. The major fraction gave N-[4-chloro-2-(2,4-dichlorophenoxy)phenyl]-N-(butyryl)oxymethyl-1,1,1-trifluoromethanesulfonamide (Compound 73) as a pale yellow oil. ¹H NMR (400 MHz, CDCl₃) δ 7.55 (d, J=2.4 Hz, 1H); 7.34 (m, 2H); 7.13 (d, J=8.7Hz, 1H); 7.08 (dd J=8.3, 2.2 Hz, 1H,); 6.59 (d, J=2.2 Hz, 1H); 5.76 (brs, 2H); 2.33 (t, J=7.5 Hz, 2H); 1.63 (m, 2H); 0.93 (m, 3H). ES−MS 541 m/z (M+Na)⁺

The following N-alkylcarbonyloxyalkyl-N-[(2-phenoxy)phenyl]-1,1,1-trifluoromethanesulfonamide compounds, listed in Table 1a, above, were prepared using similar preparative methods: Compounds 88 and 89.

Additional data for some of the compounds of Example 5, supra, is provided by Table 12, below.

TABLE 12

| Compd | |
|---|---|
| # | ¹H n.m.r. (400MHz, CDCl₃) and Mass Spectrum |
| 88 | 7.33-7.18, m, 5H; 7.06, dd, J=8.5 and 2.2Hz, 1H; 6.71-6.66, m, |
| | 1H; 5.74, s, 2H; 1.20, s, 9H. HRMS(EI): calc. for |
| | C₁₉H₁₈O₅NClF₄S, 483.0525. Found 483.0520. |
| 89 | 7.35-7.18, m, 5H; 7.06, dd, J=8.5 and 2.2Hz, 1H; 6.70-6.67, m, |
| | 1H; 5.74, s, 2H; 2.33, t, J=7.4Hz, 2H; 1.63, sext, J=7.4Hz, 2H; |
| | 0.93, t, J=7.4Hz, 3H. HRMS(EI): calc. for C₁₈H₁₆O₅NClF₄S, |
| | 469.0368. Found 469.0368. |

### EXAMPLE 6

Preparation of N-(3-methyl-2-butenyl)-N-[4-chloro-2-(2,4-dichlorophenoxy)phenyl]-1,1,1-trifluoromethanesulfonamide (Compound 75)

A mixture of N-[4-chloro-2-(2,4-dichlorophenoxy)phenyl]-1,1,1-trifluoromethane sulfonamide (273 mg, 0.649 mmol), 4-bromo-2-methyl-2-butene (150 uL, 1.30 mmol), potassium carbonate (180 mg, 1.30 mmol), sodium iodide (20 mg, 0.133 mmol) and acetone (5 mL) was stirred and refluxed for 18h under an inert atmosphere, after which time the reaction was complete, as determined by thin-layer chromatography. The mixture was filtered, then absorbed onto SiO₂ and chromatographed using a gradient elution of petroleum spirit to 1:1 petroleum spirit:dichloromethane. The relevant fractions were combined and evaporated in vacuo to give N-(3-methyl-2-butenyl)-N-[4-chloro-2-(2,4-dichlorophenoxy)phenyl]-1 1,1-trifluoromethanesulfonamide (Compound 75) (291 mg, 92%) as a pale yellow oil. ¹H NMR (400 MHz, CDCl₃) δ 7.54 (d, J=2.4Hz, 1H); 7.31 (dd, J=8.7, 2.4 Hz, 1H); 7.22 (d, J=8.5 Hz, 1H); 7.09 (d, J=8.7 Hz, 1H); 7.05 (dd, J=8.5, 2.2 Hz, 1H); 6.57 (d, J=2.2 Hz, 1H); 5.32-5.22 (br m, 1H); 4.50 (br m, 2H); 1.69 (s, 3H); 1.46 (s, 3H). HRMS(EI): calc. for C₁₈H₁₅O₃NCl₃F₃S, 486.9785. Found 486.9770.

The following N-alkenyl-N-[(2-phenoxy)phenyl]-1,1,1-trifluoromethanesulfonamide compound, listed in Table 1a, infra, was prepared using similar preparative methods: Compound 82.

Additional data for Compound 82 of Example 6, supra, is provided in Table 13, below.

TABLE 13

| Compd | |
|---|---|
| # | ¹H n.m.r. (400MHz, CDCl₃) |
| 82 | 7.31-7.15, m, 5H; 7.02, dd, J=8.5 and 2.2Hz, 1H; 6.63, m, 1H; |
| | 5.31-5.20, br m, 1H; 4.52-4.32, br m, 2H; 1.68, s, 3H; 1.45, s, |
| | 3H. |

### EXAMPLE 7

Preparation of N-[4-chloro-2-(2,4-dichlorophenoxy)phenyl]-N-(2-propynyl)-1,1,1-trifluoromethanesulfonamide (Compound 83)

A mixture of N-[4-chloro-2-(2,4-dichlorophenoxy)phenyl]-1,1,1-trifluoromethane sulfonamide (253 mg, 0.601 mmol), propargyl chloride (217 uL, 3.01 mmol), potassium carbonate (166 mg, 1.20 mmol), sodium iodide (40mg, 0.266 mmol) and DMF (dried over 4Å sieves) (5mL) was stirred at 70° C. for 18h under an inert atmosphere, after which time the reaction was complete, as determined by thin-layer chromatography. The mixture was poured into water and extracted with diethyl ether (×3). The combined organic extracts were washed with water (×3) and brine (×1) then dried and concentrated. The crude material was absorbed onto SiO₂ and chromatographed using a gradient elution of petroleum spirit to 1:1 petroleum spirit:dichloromethane. The relevant fractions were combined and evaporated in vacuo to give N-[4-chloro-2-(2,4-dichlorophenoxy) phenyl]-N-(2-propynyl)-1,1,1-trifluoromethanesulfonamide (Compound 83) (110 mg, 40%) as a pale yellow oil. ¹H NMR (400 MHz, CDCl₃) δ 7.55 (d, J=2.4 Hz, 1H); 7.45 (d, J=8.5 Hz, 1H); 7.33 (dd, J=8.7, 2.5 Hz, 1H); 7.15-7.08 (m, 2H); 6.59 (d, J=2.2 Hz, 1H); 4.64 (br s, 2H); 2.34 (t, J=2.4 Hz, 1H). HRMS(El): calc. for C₁₆H₉O₃NCl₃F₃S, 456.9315. Found 456.9308. Found 456.9308.

The following N-alkynyl-N-[(2-phenoxy)phenyl]-1,1,1-trifluoromethane sulfonamide compound, listed in Table 1a, infra, was prepared using similar preparative methods: Compound 85.

Additional data for Compound 85 of Example 7, supra, is provided in Table 14, below.

TABLE 14

| Compd | |
|---|---|
| # | ¹H n.m.r. (400MHz, CDCl₃) and Mass Spectrum |
| 85 | 7.43, d, J=8.5Hz, 1H; 7.32-7.16, m, 4H; 7.09, dd, J=8.5 and |
| | 2.2Hz, 1H; 6.71-6.66, m, 1H; 4.62, br s, 2H; 2.38, t, J=2.4Hz, |
| | 1H. HRMS(EI): calc. for C₁₆H₁₀O₃NClF₄S, 407.0006. |
| | Found 407.0000. |

### EXAMPLE 8

Preparation of N-benzyl-N-[4-chloro-2-(2,4-dichlorophenoxy)phenyl]-1,1,1-trifluoromethanesulfonamide (Compound 92)

A mixture of N-[4-chloro-2-(2,4-dichlorophenoxy)phenyl]-1,1,1-trifluoromethane sulfonamide (269 mg, 0.640 mmol), benzyl bromide (152 uL, 1.28 mmol), potassium carbonate (265 mg, 1.92 mmol), sodium iodide (19 mg, 0.128 mmol) and acetone (10 mL) was stirred at room temperature for 18h under an inert atmosphere, after which time the reaction was complete, as determined by thin-layer chromatography. The mixture was filtered, and absorbed onto SiO₂ and chromatographed using a gradient elution of petroleum spirit to 7:3 petroleum spirit:ethyl acetate. The relevant fractions were combined and evaporated in vacuo to give N-benzyl-N-[4-chloro-2-(2,4-dichlorophenoxy)phenyl]-1,1,1-trifluoromethanesulfonamide (Compound 92) (275 mg, 84%) as a colorless glassy solid. ¹H NMR (400 MHz, CDCl₃) δ 7.56 (d, J=2.5 Hz, 1H); 7.36-7.20 (m, 6H); 7.01 (d, J=8. 7Hz, 1H); 6.94-6.84 (m, 2H 2.0 Hz, 1H); 5.00 (br s, 2H).

### EXAMPLE 9

N-[2-(Biphenyl-2-yloxy)-4-chlorophenyl]-1,1,1-trifluoromethanesulfonamide (Compound 74)

a) A mixture of 2,4-dichloronitrobenzene, 2-phenylphenol, potassium carbonate and xylenes was heated to reflux for 18h, then cooled, filtered and evaporated in vacuo. The crude product was flash chromatographed through silica (20 g SiO₂, 1:3 to 3:1 CH₂Cl₂ in hexanes solvent gradient) to give 2-(5-Chloro-2-nitro-phenoxy)-biphenyl as a yellow oil. ¹H NMR (400 MHz, CDCl₃) δ 7.79 (d, J=8.8 Hz, 1H); 7.53-7.48 (m, 3H); 7.44-7.23 (m, 5H); 7.15 (dd, J=8.0, 1.1 Hz, 1H); 6.96 (dd, J=8.8, 2.2 Hz, 1H); 6.68 (d, J=1.9 Hz, 1H).

b) A mixture of 2-(5-chloro-2-nitrophenoxy)biphenyl (53 mg, 0.163 mg), iron powder (45 mg, 0.814 mmol), ammonium chloride (4 mg, 0.0814 mmol), ethanol (4 mL) and water (2 mL) was refluxed for 30 min, then filtered hot. The resulting filtrate partitioned between ethyl acetate and water. The organic phase was separated and washed with brine, dried and evaporated to give 2-(biphenyl-2-yloxy)-4-chlorophenylamine (46 mg, 95%) as a pale yellow oil which was used in the next step without further purification. ¹H NMR (400 MHz, CDCl₃) δ 7.53 (brd J=6.8 Hz, 2H); 7.45 (dd, J=7.4, 1.6 Hz, 1H); 7.38 (brt, J=7.5 Hz, 2H); 7.34-7.21 (m, 3H); 7.01 (dd, J=8.1, 1.0 Hz, 1H); 6.82 (m, 2H); 6.69 (d, J=2.3 Hz, 1H).

c) A solution of trifluoromethanesulfonic anhydride 53 mg, 0.187 mmol) in dry dichloromethane (5 mL) was added to a solution of 2-(biphenyl-2-oxy)-4-chlorophenylamine (46 mg) in dry dichloromethane (5 mL) at 0° C., and the mixture allowed warm to room temperature over 1h. The mixture was washed successively with water then brine, dried, and evaporated to yield a pale brown oil. Flash chromatography on silica (1:1 dichloromethane/petroleum spirit) yielded N-[2-(biphenyl-2-oxy)-4-chlorophenyl]-1,1,1-trifluoromethanesulfonamide (Compound 74) (36 mg, 54%) as a pale brown oil. ¹H NMR (200 MHz, CDCl₃) δ 7.49 (dd, J=7.4, 2.0 Hz, 1H); 7.29-7.45 (m, 8H); 6.69 (d, J=2.2Hz, 1H); 6.93 (brs, 1H); 6.96 (dd, J=8.5, 2.3 Hz, 1H); 7.09 (dd, J=8.1, 1.4 Hz, 1H). El−MS 427 m/z (M^{+.}).

### EXAMPLE 10

The following compounds were prepared according to the reaction scheme illustrated in FIG. 2.

N-Ethoxymethyl-N-[3-(2,4-dichlorophenoxy)phenyl]-1,1,1-trifluoromethanesulfonamide (Compound m7)

a) A mixture of 3-nitro-1-bromobenzene (437 mg, 2.16 mmol), 2,4-dichlorophenol (423 mg, 2.60 mmol), potassium carbonate (598 mg, 4.33 mmol), CuCl (13 mg, 0.433 mmol) and DMF (2 mL) was heated in a Biotage Initiator microwave reactor at 200° C. for 1h. The mixture was cooled and partitioned between diethyl ether and water. The combined ether extracts were washed successively with water (×2), 2 M NaOH, and brine, dried and evaporated. The crude product was chromatographed (20 g silica, 3 to 10% dichloromethane in hexanes) to give 3-(2,4-dichlorophenoxy)-nitrobenzene (297 mg, 48%) as a pale yellow oil. ₁H NMR (400 MHz, CDCl₃) δ 7.97 (dd, J=7.9, 2.2 Hz, 1H); 7.70 (t, J=2.3 Hz, 1H); 7.55-7.47 (m, 2H); 7.33-7.24 (m, 2H); 7.06 (d, J=8.8 Hz, 1H).

b) 3-(2,4-dichlorophenoxy)-nitrobenzene (297 mg, 1.05 mmol) was reduced as per Example 9 to yield crude 3-(2,4-dichlorophenoxy)phenylamine (249 mg, 93%) as a pale yellow oil. ¹H NMR (200 MHz, CDCl₃) δ 7.45 (d, J=2.9 Hz, 1H); 7.18 (dd, J=8.8, 2.3 Hz, 1H); 7.10 (d, J=7.8 Hz, 1H); 6.94 (d, J=8.8 Hz, 1H); 6.52 (dd, J=2.3 Hz, 1H); 6.41-6.35 (m, 2H); 4.18 (brs, 2H).

c) Trifluoromethansulfonic anhydride (415 mg, 1.47 mmol) in CH₂Cl₂ (5 mL) was added to a solution of 3-(2,4-dichlorophenoxy)phenylamine (249 mg, 0.98 mmol) in CH₂Cl₂ (5 mL) at 0° C. Chromatography of the crude product (10 g SiO₂, 30 to 50% CH₂Cl₂ in petroleum spirit) yielded N-[3-(2,4-dichlorophenoxy)phenyl]-1,1,1-trifuoromethanesulfonamide (Compound m6) (314 mg, 83%) as a pale brown oil. ¹H NMR (200 MHz, CDCl₃) δ 7.49 (d, J=2.8Hz, 1H); 7.36 (d, J=8.1 Hz, 1H); 7.30-7.22 (m, 1H); 7.04-6.81 (m, 5H). Mass spectrum (El):m/z 385(M^{+.}).

d) A mixture of N-[3-(2,4-dichlorophenoxy)phenyl]-1,1,1-trifluoromethanesulfonamide (241 mg, 0.624 mmol), chloromethyl ethyl ether (177 mg, 1.872 mmol), potassium carbonate (259 mg, 1.872 mmol) and acetone (2 mL) was refluxed for 1h. The mixture then was partitioned between concentrated aqueous ammonia solution and diethyl ether. The combined organic phase was washed successively with water and brine, dried (Na₂SO₄) and evaporated. Filtration through a pad of silica (20% CH₂Cl₂ in petroleum spirit) gave N-ethoxymethyl-N-[3-(2,4-dichlorophenoxy)phenyl]-1,1,1-trifluoromethanesulfonamide (193 mg, 70%) [Compound m7] as a colorless oil. ¹H NMR (200 MHz, CDCl₃) δ 7.50 (d, J=2.3 Hz, 1H); 7.39 (t, J=8.2 Hz, 1H); 7.24 (dd, J=9.1, 2.3 Hz, 1H); 7.12 (m, 1H); 7.14-6.93 (m, 3H); 5.09 (s, 2H); 3.66 (q, J=7.1 Hz, 2H); 1.20 (t, J=7.1 Hz, 3H).

The following N-[3-(phenoxy)phenyl]-1,1,1-trifluoromethanesulfonamide compounds, listed in Table 1c, infra, were prepared using similar preparative methods: Compounds m1, m2, m3, m4 and m5.

Additional data for some of the compounds of Example 10, supra, are provided by Table 15, below.

TABLE 15

| Compd | |
|---|---|
| # | ¹H n.m.r. (400MHz, CDCl₃) and Mass Spectrum |
| m4 | 7.40-7.34(m, 3H); 7.16(m, 1H); 7.08(brd, J=7.7Hz, 1H); |
| | 7.05-7.00(m, 4H); 5.05(s, 2H); 3.45(s, 3H). |
| m3 | 7.36(m, 3H); 7.16(t, J=7.4Hz, 1H); 7.05(m, 4H); 6.99(m, 1H); |
| | 5.08(s, 2H); 3.65(q, J=7.0Hz, 2H); 1.19(t, J=7.0Hz, 3H). |
| | MS(EI): m/z 375(M^{+.}). |
| m5 | 7.40-7.34(m, 3H); 7.17(m, 1H), 7.11-7.06(m, 2H); 7.03(m, |
| | 2H); 6.99(t, J=2.2Hz, 1H); 5.62(s, 2H); 1.16(s, 9H). MS(EI): |
| | m/z 431(M^{+.}). |
| m2 | 7.40-7.33(m, 3H); 7.17(t, J=7.3Hz, 1H); 7.08(brd, J=8.9Hz, |
| | 1H); 7.05-6.99(m, 4H); 3.44(d, J=0.8Hz, 3H). MS(EI): m/z |
| | 331(M^{+.}). |

### EXAMPLE 11

The following compounds were prepared according to the reaction scheme illustrated in FIG. 3.

N-[3-Chloro-4-(2,4-dichlorophenoxy)phenyl]-1,1,1-trifluoromethanesulfonamide (compound p7)

a) A mixture of 3,4-dichloronitrobenzene (829 mg, 4.32 mmol) 2,4-dichlorophenol (774 mg, 4.75 mmol), potassium carbonate (656 mg, 4.75 mmol) and xylenes was refluxed for 3 days. The mixture was cooled and partitioned between 2M aqueous NaOH and ether. The combined organic phase was washed with brine, dried and evaporated. The crude product was purified by flash chromatography (20 g column, 3 to 10% CH₂Cl₂ in hexanes) to yield 2-chloro-4-nitro-1-(2,4-dichlorophenoxy)benzene (669 mg, 49%) as a yellow oil. ¹H NMR (400 MHz, CDCl₃) δ 8.39 (d, J=2.7 Hz, 1H); 8.05 (dd, J=9.1, 2.8 Hz, 1H); 7.54 (d, J=2.5 Hz 1H); 7.32 (dd, J=8.7, 2.5 Hz, 1H); 7.08 (d, J=8.7 Hz, 1H); 6.71 (d, J=9.1 Hz, 1H). ES−MS 316 m/z (M^{+.}).

b) 2-Chloro-4-nitro-1-(2,4-dichlorophenoxy)benzene (669mg, 2.10 mmol) was reduced with iron powder as per Example 9 to yield crude 3-chloro-4-(2,4-dichlorophenoxy)phenylamine (602 mg, 99%) as a pale yellow solid which was used in the next step without further purification. ¹H NMR (400 MHz, CDCl₃) δ 7.42 (d, J=2.5 Hz, 1H); 7.08 (dd, J=8.8, 2.3 Hz, 1H); 6.86 (d, J=8.6 Hz, 1H); 6.78 (d, J=Hz, 1H); 6.60-6.55 (m, 2H), 3.71 (brs, 2H).

c) 3-Chloro-4-(2,4-dichlorophenoxy)phenylamine (602 mg, 2.09 mmol) was reacted with trifluoromethane sulfonic anhydride (706 mg, 421 mmol) as per Example 9. Recrystallization of the crude product from ether/petroleum spirit yielded N-[3-chloro-4-(2,4-dichlorophenoxy)phenyl]-1,1,1-trifluoromethanesulfonamide (Compound p7) (701 mg, 80%) as a colorless solid. ¹H NMR (400 MHz, CDCl₃) δ 7.49 (d, J=2.2Hz, 1H); 7.44 (d, J=3.0Hz, 1H); 7.22 (dd, J=8.8, 2.6 Hz, 1H); 7.14 (dd, J=8.8 Hz, 2.5 Hz, 1H); 7.12 (brs, 1H); 6.87 (d, J=8.8Hz, 1H); 6.81 (d, J=8.8 Hz, 1H). MS(EI): m/z421 (M^{+.}).

The following N-[4-(phenoxy)phenyl]-1,1,1 -trifluoromethanesulfonamide compounds, listed in Table 1e, infra, were prepared using similar preparative methods: Compounds p1, p2, p3, p4, p5, p6, p8 and p9.

Additional data for some of the compounds of Example 11, supra, are provided by Table 16, below.

TABLE 16

| Compd # | ¹H n.m.r. (200MHz, CDCl₃) and Mass Spectrum |
|---|---|
| p4 | 7.40-6.35(m, 2H); 7.28(m, 2H); 7.17(m, 1H); 7.05(m, 2H); |
| | 6.99(m, 2H); 5.04(s, 2H); 3.47(s, 3H). MS(EI): m/z 361(M^{+.}). |
| p3 | 7.40-7.36(m, 2H); 7.27(m, 2H); 7.17(m, 1H); 7.05(m, 2H); |
| | 6.99(m, 2H); 5.08(s, 2H); 3.69(q, J=7.0Hz, 2H); 1.22(t, J=7.0Hz, |
| | 3H). MS(EI): m/z 375(M^{+.}). |
| p5 | 7.38(m, 2H); 7.30(m, 2H); 7.18(m, 1H); 7.05(d, J=8.5Hz, 2H); |
| | 6.98(m, 2H); 5.62(s, 2H); 1.22(s, 9H). MS(EI): m/z 431(M^{+.}). |
| p6 | 7.63(d, J=8.9Hz, 1H); 7.52(d, J=2.6Hz, 1H); 7.29(dd, J=8.9, |
| | 2.6Hz, 1H); 7.25(d, J=3.0Hz, 1H); 7.07-7.02(m, 2H). MS(EI): m/z 453(M^{+.}). |
| p8 | 7.48(d, J=2.5Hz, 1H); 7.21(m, 2H); 7.02(m, 1H); 6.93(d, J=8.4Hz, |
| | 1H); 6.87(d, J=8.4Hz, 1H). MS(EI): m/z 403(M^{+.}). |
| p2 | 7.37(m, 2H); 7.29(m, 2H); 7.17(t, J=7.4Hz, 1H); 7.04(d, J=7.6Hz, |
| | 2H); 6.98(m, 2H) 3.45(s, 3H). MS(EI): m/z 331(M^{+.}). |
| p9 | 7.60(d, J=2.2Hz, 1H); 7.52(d, J=2.5Hz, 1H); 7.39(dd, J=8.8, |
| | 3.0Hz, 1H), 7.29(dd, J=8.8, 2.9Hz, 1H); 7.04(d, J=8.8Hz, |
| | 1H); 6.95(brs, 1H), 6.72(d, J=8.8Hz, 1H). MS(EI): m/z |
| | 453(M^{+.}). |

### EXAMPLE 12

The following compounds were prepared according to the reaction scheme 5 illustrated in FIG. 1.

N-[4-Chloro-2-(4-chlorophenylamino)-phenyl]-1,1,1-trifluoromethanesulphonamide (Compound 91)

a) 4′,5-Dichloro-2-nitrodiphenylamine was prepared using a modification of the procedure of Kottenham et al. [J Org. Chem., 28, 3114-3120 (1963)].

b) Iron powder (494 mg, 8.85 mmol) and ammonium chloride (47 mg, 0.885 mmol) were added to a solution of 4′,5-dichloro-2-nitrodiphenylamine (501 mg, 1.77 mmol) in ethanol (12 mL) and water (6 mL). The mixture was refluxed for 30 min. The hot mixture was filtered and the insoluble materials were washed with ethyl acetate. Additional ethyl acetate and water were added and the aqueous layer separated and extracted with ethyl acetate. The combined organic layers were dried and the solvent evaporated in vacuo to afford 396 mg (88%) of crude 4′,5-dichloro-2-aminodiphenylamine as a dark red oil, which was used in the next step without further purification. ¹H NMR (400 MHz, CDCl₃) δ 7.21-7.15 (m, 2H), 7.07 (d, J=2.3 Hz, 1H); 6.96 (dd, J=8.4, 2.2 Hz, 1H); 6.74 (m, 3H); 5.19 (brs, 1H), 3.71 (brs, 2H). ¹³C NMR (400 MHz, D6-DMSO) δ 144.0, 141.2, 128.7, 128.6, 123.7, 121.9, 121.7, 119.2, 116.5, 116.2.

c) Trifluoromethanesulfonic anhydride (258 uL, 1.53 mmol) in dichloromethane (3 mL) was added dropwise over 30 min, under an inert atmosphere to an ice-cold solution of 4′,5-dichloro-2-aminodiphenylamine (351 mg, 1.39 mmol) in dichloromethane (7 mL). The reaction was allowed to warm to room temperature and stirred overnight. Water (15 mL) was added and the organic layer separated then washed with brine, dried and the solvent evaporated in vacuo. The residue was absorbed onto SiO₂ and chromatographed using a gradient elution of petroleum spirit to 2:3 petroleum spirit:dichloromethane. The relevant fractions were combined and evaporated in vacuo to afford 447 mg (84%) of N-[4-chloro-2-(4-chlorophenylamino)-phenyl]-1,1,1-trifluoromethanesulphonamide as a pale pink oil, which slowly crystallised upon standing. ¹H NMR (400 MHz, CDCl₃) δ 7.85 (d, J=8.7 Hz, 1H); 7.63-7.55 (m, 2H); 7.42-7.33 (m, 3H); 7.14 (d, J=1.5 Hz, 1H). ¹³C NMR δ 139.3, 137.6, 136.5, 132.4, 132.1, 130.3, 128.7, 125.3, 122.6, 118.5 (q, ¹J_{CF} 272.2 Hz, CF₃), 111.0. ¹⁹F NMR δ-61.19 (CF₃).

While the present invention has been described in conjunction with the specific embodiments set forth above, many alternatives, modifications and variations thereof will be apparent to those of ordinary skill in the art. All such alternatives, modifications and variations are intended to fall within the spirit and scope of the present invention.

Numerous references are mentioned herein, all of which are hereby incorporated by reference in their entireties.

We claim:

1. A method of treating for or protecting from a parasite infestation in an animal or a plant, comprising administering to the animal or the plant an effective amount of an N-phenyl-1,1,1-trifluoromethanesulfonamide compound, a pharmaceutically acceptable salt thereof, or a solvate thereof; wherein the N-phenyl-1,1,1-trifluoromethanesulfonamide compound is selected from the group consisting of 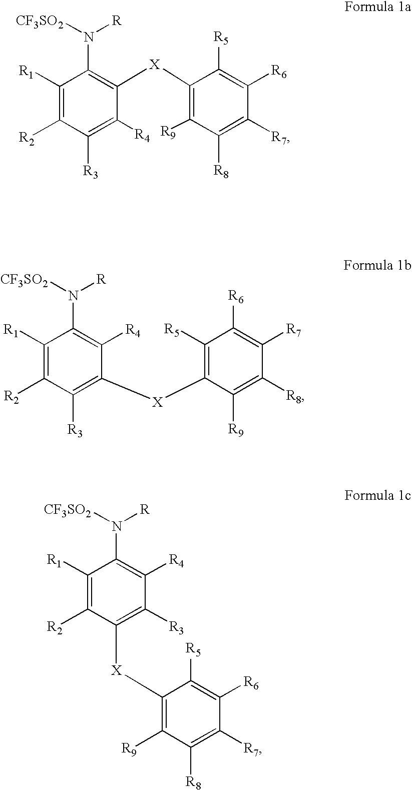
and a combination thereof,
wherein, R is selected from the group consisting of hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; wherein R₁-R₉ are independently selected from the group consisting of hydrogen, cyano, nitro, halo, and an optionally substituted moiety selected from the group consisting of alkyl, cycloalkyl, aryl, heterocyclyl, heteroaryl, alkoxy, cycloalkoxy, aryloxy, heteroaryloxy, heterocyclyloxy, haloalkyl, and haloalkoxy;
wherein X is selected from the group consisting of oxygen, sulfur, sulfinyl, sulfonyl and NR₁₀; and
wherein R₁₀ is H or alkyl.

2. The method of claim 1 wherein R₅ and R₆ together are part of the same fused carbocyclic, heterocyclic, aryl or heteroaryl ring;
and wherein the ring is either substituted or unsubstituted.

3. The method of claim 1 wherein R₆ and R₇ together are part of the same fused carbocyclic, heterocyclic, aryl, or heteroaryl ring;
and wherein the ring is either substituted or unsubstituted.

4. The method of claim 1, wherein R is H, or is selected from the optionally substituted group consisting of alkyl, alkenyl, alkynyl, alkoxyalkyl, and alkycarbonyloxyalkyl;
wherein R₁-R₉ are independently selected from the group consisting of hydrogen, cyano, halo, and an optionally substituted moiety selected from the group consisting of alkyl, aryl, alkoxy, haloalkyl, and haloalkoxy; and
wherein X is oxygen or sulfur.

5. The method of claim 1 that comprises administering to the animal or the plant an effective amount of an N-phenyl-1,1,1-trifluoromethanesulfonamide compound of Formula 1a wherein:
R is H, or is an optionally substituted moiety selected from the group consisting of alkyl, alkenyl, alkynyl, alkoxyalkyl, and alkycarbonyloxyalkyl;
R₁, R₄, R₈ and R₉ are H;
R₂ is H, Cl or CF₃;
R₃is H or Cl;
R₅ is H, F, Cl, Me, Et, isopropyl or tert-butyl;
R₆ is H, F, Cl, CF₃, Me, MeO or CN;
R₇ is H, F, Cl, Me, tert-butyl, MeO, phenoxy or CN; and
X is O or S.

6. The method of claim 5 wherein the N-phenyl-1,1,1-trifluoromethanesulfonamide compound is selected from the group consisting of compound as identified in Tables 1a-d as compound 1 to 92, m1 to m6, p1 to p9, and a combination thereof.

7. The method of claim 1 wherein an additional agent is administered to the plant or animal.

8. The method of claim 7 wherein the additional agent is a parasiticide selected from the group consisting of a cyclodiene, KT-199, an avermectin, a benzimidazole, a salicylanilide, a substituted phenol, a pyrimidine, an imidazothiazole, a praziquantel, an organic phosphate, and a combination thereof.

9. The method of claim 7 wherein the additional agent is an antibiotic.

10. The method of claim 7 wherein the additional agent is an animal nutritional supplement.

11. The method of claim 7 wherein the additional agent is a plant nutritional supplement or fertilizer.

12. The method of claim 7 wherein the additional agent is a herbicide.

13. The method of claim 1 wherein the parasite is selected from the group consisting of an arthropod, a helminth, a cestode, a trematode and a protozoan.

14. The method of claim 1 that is applied to the animal.

15. The method of claim 14 wherein the animal is selected from the group consisting of a mammal, an avian, a reptile, an amphibian, a fish, and a crustacean.

16. The method of claim 1 that is applied to the plant.

17. The method of claim 16 wherein the plant is selected from the group consisting of crops for producing fruits, vegetables, grains, non-grain grasses, flowers, orchids, trees, hedges, and other protective or ornamental plants.

18. An N-phenyl-1,1,1-trifluoromethanesulfonamide compound selected from the group consisting of 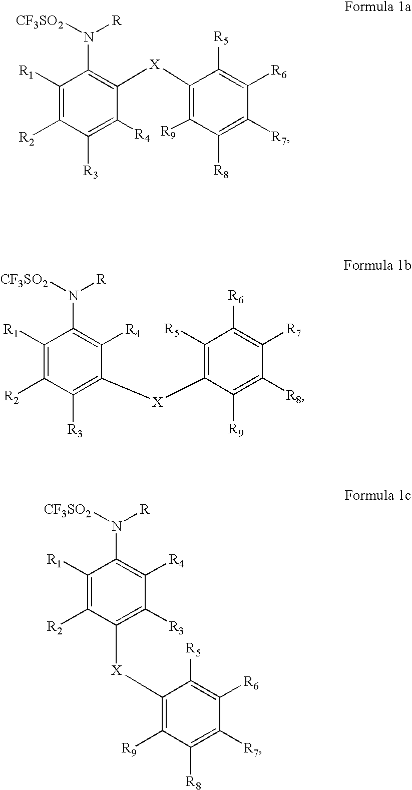
and a combination thereof, a pharmaceutically acceptable salt thereof, or a solvate thereof;
wherein R is selected from the group consisting of alkenyl, alkynyl, arylalkyl, cycloalkylalkyl, heterocyclylalkyl, heteroarylalkyl, with the proviso that (pyridyl)alkyl substituents are excluded, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, aroyl, heterocycloyl, heteroaroyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, arylsulfonyl, heterocyclylsulfonyl and heteroarylsulfonyl; and
wherein R₁-R₉ are independently selected from the group consisting of hydrogen, cyano, nitro, halo, and an optionally substituted moiety selected from the group consisting of alkyl, cycloalkyl, aryl, heterocyclyl, heteroaryl, alkoxy, cycloalkoxy, aryloxy, heteroaryloxy, heterocyclyloxy, haloalkyl, and haloalkoxy;
wherein X is oxygen, sulfur, sulfinyl, sulfonyl or NR₁₀; and
wherein R₁₀ is hydrogen or alkyl.

19. The N-phenyl-1,1,1-trifluoromethanesulfonamide compound of claim 18, that is selected from the group consisting of compounds as identified in Tables 1a-d as compound 1, 2, 4, 5, 9, 12, 14-16, 20, 21, 25, 26, 30, 38, 55, 59, 68, 70-73, 75, 79-85, 88-89, 92, m3-m5, m7 and p3-p5 of Tables 1a-d .

20. A pharmaceutical composition that comprises a therapeutically effective dosage amount of at least one compound according to claim 18, and a pharmaceutically acceptable excipient.

21. The pharmaceutical composition of claim 20 that further comprises an additional active agent.

22. The pharmaceutical composition of claim 21 wherein the additional agent is a parasiticide selected from the group consisting of a cyclodiene, KT-199, an avermectin, a benzimidazole, a salicylanilide, a substituted phenol, a pyrimidine, an imidazothiazole, a praziquantel, an organic phosphate, and a combination thereof.

23. The method of claim 21 wherein the additional agent is an antibiotic.

24. The method of claim 21 wherein the additional agent is an animal nutritional supplement.

25. The method of claim 21 wherein the additional agent is a plant nutritional supplement.

26. The method of claim 21 wherein the additional agent is a herbicide.

27. A parasiticidal composition that comprises a suitable carrier and at least one compound according to claim 18 in a concentration effective to kill or suppress an arthropod, helminth, cestode, trematode or protozoan.

28. A method of killing or inhibiting the growth of a parasite comprising contacting the parasite with an effective amount of an N-phenyl-1,1,1-trifluoromethanesulfonamide compound, a pharmaceutically acceptable salt thereof, or a solvate thereof;
wherein the N-phenyl-1,1,1-trifluoromethanesulfonamide compound is selected from the group consisting of 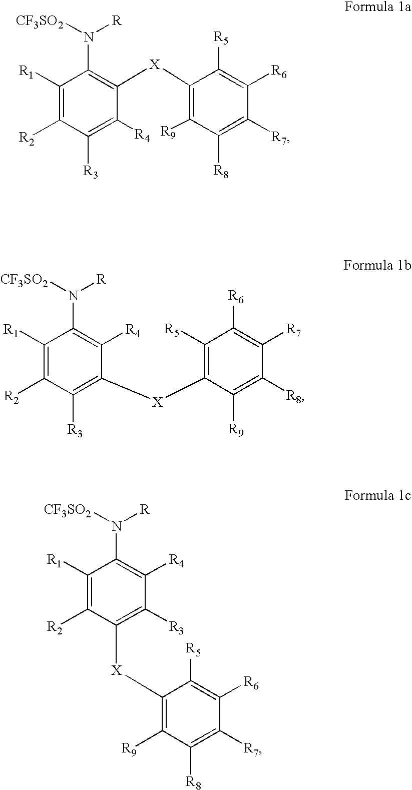
and a combination thereof,
wherein, R is selected from the group consisting of hydrogen, alkyl, alkenyl, alkynyl, arylalkyl, cycloalkylalkyl, heterocyclylalkyl, heteroarylalkyl, hydroxyalkyl, alkoxyalkyl, aryloxyalkyl, cyanoalkyl, alkylcarbonylalkyl, cycloalkylcarbonylalkyl, arylcarbonylalkyl, heterocyclylcarbonylalkyl, heteroarylcarbonylalkyl, alkoxycarbonylalkyl, alkylaminocarbonylalkyl, trialkylsilylalkyl, trialkoxysilylalkyl, dialkoxyphosphonatoalkyl, heterocyclyloxyalkyl, heteroaryloxyalkyl, alkylcarbonyloxyalkyl, arylcarbonyloxyalkyl, heterocyclylcarbonyloxyalkyl, heteroarylcarbonyloxyalkyl, alkoxycarbonyloxyalkyl, aryloxycarbonyloxyalkyl, heterocyclyloxycarbonyloxyalkyl, heteroaryloxycarbonyloxyalkyl, alkylaminocarbonyloxyalkyl, arylaminocarbonyloxyalkyl, heterocyclylaminocarbonyloxyalkyl, heteroarylaminocarbonyloxyalkyl, alkylcarbonylaminoalkyl, arylcarbonylaminoalkyl, heterocyclycarbonylaminoalkyl, heteroarylcarbonylaminoalkyl, alkylsulfonylalkyl, arylsulfonylalkyl, heterocyclylsulfonylalkyl, heteroarylsulfonylalkyl, alkanoyl, aroyl, heterocycloyl, heteroaroyl, alkoxycarbonyl, aryloxycarbonyl, heterocyclyloxycarbonyl, heteroaryloxycarbonyl, N-alkyl carbamoyl, N-aryl carbamoyl, N-heterocyclyl carbamoyl, N-heteroaryl carbamoyl, N-alkyl thiocarbamoyl, N-aryl thiocarbamoyl, N-heterocyclyl thiocarbamoyl, N-heteroaryl thiocarbamoyl, alkylsulfonyl, arylsulfonyl, heterocyclylsulfonyl and heteroarylsulfonyl; and wherein, R₁-R₉ are independently selected from hydrogen, cyano, nitro, halo, and an optionally substituted moiety selected from the group consisting of alkyl, cycloalkyl, aryl, heterocyclyl, heteroaryl, alkoxy, cycloalkoxy, aryloxy, heteroaryloxy, heterocyclyloxy, haloalkyl, and haloalkoxy;
wherein X is selected from the group consisting of oxygen, sulfur, sulfinyl, sulfonyl and NR₁₀; and
wherein R₁₀ is H or alkyl.

29. The method of claim 28 wherein the parasite is selected from the group consisting of an arthropod, a helminth, a cestode, a trematode and a protozoan.
